(19) United States
(12) Patent Application Publication
(10) Pub. No.: US 2026/0342907 A1
(43) Pub. Date: Oct. 29, 2026

(54) METHODS AND SYSTEMS FOR FACILITATING ARTIFICIAL INTELLIGENCE (AI) MEMORY OWNERSHIP AND PORTABILITY

(71) Applicant: AT&T Intellectual Property I, L.P., Atlanta, GA (US)

(72) Inventors: Amit Kumar Sheoran, Raritan, NJ (US); Antoine Diffloth, Sammamish, WA (US); James Poulin, SEATTLE, WA (US); Mun May Tee, SAN FRANCISCO, CA (US); Vimal Patel, Morganville, NJ (US); James Ibezim, Ocean, NJ (US); Chaoxin Qiu, Austin, TX (US); Robert Stokey, JR., Manville, NJ (US); Vijay Gopalakrishnan, Edison, NJ (US); Oliver Spatscheck, Denison, TX (US); Jason Sikes, Carnation, WA (US); Aparna Kulkarni, Bothell, WA (US); Anh Minh Dinh, Brooklyn, NY (US); Austin Thomas, Bothell, WA (US); Senmiao Liu, Skillman, NJ (US); Kelly Baumeister, North Bend, WA (US)

(73) Assignee: AT&T Intellectual Property I, L.P., Atlanta, GA (US)

(21) Appl. No.: 19/193,208

(22) Filed: Apr. 29, 2025

(51) Int. Cl. H04M 3/22; G06F 12/02

(52) U.S. Cl. CPC H04M 3/2281; G06F 12/0223

(57) ABSTRACT

Aspects of the subject disclosure may include, for example, obtaining data that corresponds to one or more interactions of a user with an AI agent, causing the data to be converted into one or more AI memories of the user, after the causing, receiving a request for AI memories of the user, and responding to the request by retrieving the one or more AI memories, wherein the one or more AI memories are stored in a predefined format that enables access thereto by an external system or portability thereof to the external system. Other embodiments are disclosed.

### FIELD OF THE DISCLOSURE

The subject disclosure relates to on demand telecom using artificial intelligence (AI), securing of user-to-AI calls, trigger-based AI screening of user-to-AI calls, AI memory ownership/portability, network-hosted AI, and/or dynamic AI selection.

### BACKGROUND

Since the inception of the modern AI industry, major technology companies have introduced AI assistants to their customers, with the aim of building brand loyalty through promises of convenience and utility. These systems, however, prioritized the interests of the companies over those of consumers. For instance, a customer might be prompted to subscribe to additional services when using an AI assistant for simple tasks. Over time, various enterprises, both large and small, have invested in AI bots to reduce operational costs and enhance customer interactions, particularly in support and marketing sectors. Despite these advancements, consumers and small businesses frequently find themselves excluded due to a lack of financial resources, expertise, or the ability to customize AI solutions to meet their specific needs. The current landscape of consumer and small business AI remains insufficiently democratized. Small businesses have generally been priced out of and technologically excluded from the realm of AI agent solutions. Consumer-focused AI initiatives from major players often aim to enhance their device or service ecosystems, thereby increasing user engagement through convenience and utility. While consumers may benefit somewhat from basic interactions, the underlying objective often remains to deepen customer integration into the enterprise's ecosystem.

Presently, AI agents that provide messaging/call assistance are being implemented in connected cloud services and will soon run directly on user devices. However, these services are designed to act only after a call reaches a user device, and thus are unable to proactively address issues such as fraud detection or nuisance prevention.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2 is a block diagram illustrating an example, non-limiting embodiment of a virtualized communications network in accordance with various aspects described herein.

FIG. 3 is a block diagram of an example, non-limiting embodiment of a computing environment in accordance with various aspects described herein.

FIG. 4 is a block diagram of an example, non-limiting embodiment of a mobile network platform in accordance with various aspects described herein.

FIG. 5 is a block diagram of an example, non-limiting embodiment of a communication device in accordance with various aspects described herein.

FIG. 6 is a diagram of an example AI architecture, which may be used to facilitate training or pre-training of one or more AI models, including, for instance, large language models (LLMs), in accordance with various aspects described herein.

FIG. 7 is a diagram of an example transformer model, a portion or an entirety of which may serve as a functional building block of one or more LLMs, in accordance with various aspects described herein.

FIG. 8A is a block diagram illustrating an example, non-limiting embodiment of a network system functioning within, or operatively overlaid upon, the communications network of FIG. 1, in accordance with various aspects described herein.

FIG. 8B illustrates example user AI memories in accordance with various aspects described herein.

FIG. 8C illustrates an example implementation of a memory AI in which user feedback, user-related events, user-and-AI-related interactions, etc. can be stored as memories and retrieved by an AI agent, such as to use as context in queries/commands to an AI model.

FIGS. 9A and 9B show an example call flow for registering an AI identity with an AI repository function (RF) and invoking of the registered AI identity by AI consumers.

FIG. 9C shows an example call flow for dynamic AI identity selection.

FIGS. 10A and 10B show an example call flow for registering a memory AI identity with an AI RF and accessing of user memories associated therewith.

FIG. 11A is a high-level block diagram of an example system architecture for facilitating eSIM rotations in which temporary phone numbers can be assigned to user devices as needed.

FIGS. 11B and 11C show an example call flow for dynamic eSIM allocation and relinquishment.

FIG. 12A is a high-level block diagram of an example architecture in which AI can be invoked to assist with voice/media services.

FIGS. 12B and 12C show an example call flow for invoking AI services for a call made by a caller to a callee.

FIG. 12D is a block diagram illustrating an example implementation that involves the use of multiple instances of various functional components of the architecture of FIG. 12A for redundancy.

FIGS. 12E and 12F show an example call flow relating to communications between a voice platform and a service logic of the architecture of FIG. 12A.

FIG. 12G shows an example call flow for integrating AI services with RCS/SMS messaging.

FIG. 12H is a block diagram illustrating an example AI agent service implementation.

FIG. 12I illustrates an example voice call QoS-based algorithm that facilitates graceful handling of call drops.

FIG. 12J is a high-level block diagram of another example architecture in which AI can be invoked to assist with voice/media services.

FIG. 13 illustrates an example authentication implementation in which a detection system is integrated with or communicatively coupled to telecommunications network components, user device systems, and/or AI system(s) to facilitate the authentication(s).

FIG. 14 shows an example call flow for network-assisted caller-ID spoofing detection.

FIG. 15 shows an example call flow for network-assisted caller-ID spoofing detection with Voice Over Wi-Fi (VoWi-Fi).

FIG. 16 shows an example call flow for SIM app-assisted caller-ID spoofing detection.

FIG. 17 shows an example call flow for network and SIM app assisted caller-ID spoofing detection.

FIG. 18 shows an example flow that illustrates a fallback to active authentication methods in a case where passive authentication fails or is insufficient.

FIGS. 19A to 19E each depicts an illustrative embodiment of a respective method in accordance with various aspects described herein.

### DETAILED DESCRIPTION

Exemplary embodiments described herein relate to architectures, frameworks, systems, methods, and techniques for facilitating the deployment, utilization, and/or training of AI agents or assistants in a telecommunications network environment (i.e., “network AI” or “network-hosted AI”) to perform tasks for consumers, such as individual users or small businesses. Various embodiments encompass a range of functionalities, including, but not limited to, the configuration, training, and control of AI agents (including the invoking of AI agents to perform call handling or processing on a user's behalf or alongside a user during a call), the association of AI agents with phone numbers, the securing of user-to-AI calls, the detection/mitigation of fraudulent calls, the interactions between different AI agents, and the underlying control/data signaling relating to the use of AI agents. Certain embodiments provide for a new paradigm that decouples from the use of phone numbers to serve as identity, and allows for on-demand telecommunications services via AI where phone numbers can be flexibly and dynamically assigned as needed. Additional embodiments provide for example standardizations for logging user memories in relation to their AI usage, allowing for user AI memory ownership and portability such that users have control over their AI-related data and can transfer it as needed, even between different service providers.

Integrating AI agents into a telecommunications network, as described herein, transforms the network into an AI-enriched platform that allows for the integration of native and third-party AI capabilities into voice calls. This integration allows the network to act proactively, addressing issues upstream before a call reaches a user device, independent of device state or availability.

The AI agents can serve as voice-/text based and personalized solutions for managing daily tasks for consumers and small enterprises, leveraging the existing infrastructure around voice-/text-based communications. For example, the AI agents can handle a variety of tasks, such as screening nuisance calls, navigating interactive voice response (IVR) menus, scheduling appointments, interacting with directory services, etc. Users can create secure AI agents that cater to their specific needs, learn their preferences, and communicate with a personalized voice and personality, making them accessible even to vision-impaired users. Small enterprises can similarly utilize voice-based AI agents to enhance their digital presence and streamline customer interactions through phone-based systems, such as those via toll free numbers (800, 888, etc.) and IVR platforms. This manifests into a “Web of AIs” in which AI agents can interoperate to achieve greater outcomes for users while supporting multi-modal use cases. In the context of call handling, the AI agents may provide three stages of AI services—pre-call, in-call, and post-call. In the pre-call stage, the AI agent service may retrieve user preferences, call history, and persona information to prepare for personalized and context-aware interactions. During the in-call stage, the AI agent service may perform speech-to-text transcription, update prompts using personalization data, generate responses via an LLM service, convert text to speech, and manage call flow, caller identity, and call intent classification while facilitating synthetic voice detection for security purposes. In the post-call stage, the AI agent service may update the call session store with call details and send call statistics to an event audit log to support future personalization, performance analysis, and system optimization.

Embodiments described herein allow for scalability in which numerous AI agents can coordinate in a network of interconnected AI systems. By lowering the financial and technical barriers, AI agents can be trained on existing digital assets and automate high-value functions, such as answering questions, placing orders, and so on.

Various mechanisms are described herein that facilitate AI interoperability where AI agents can work together to reconcile their agendas while prioritizing personal and data privacy. For example, scheduling a meeting between two individuals can be fully automated by AI agents without exposing unrelated data and only exposing the bare minimum of calendar data. Adding in AI agents of small enterprises, which have access to food and drink offerings, for instance, can further ensure that specific user preferences, such as dietary requirements of a consumer, are met without compromising personal information. Certain embodiments provide connectivity features that allow external (i.e., non-network) AI agents to subscribe to or integrate into the network.

Unlike in traditional systems, where user devices may not always be reachable, network AI, as described herein, allows for continuous availability. AI agents can be anchored to existing or temporary phone numbers such that users can interact with them directly by calling or texting their own number or by calling a phone number or texting a short code number that is associated with their AI agent. The network-embedded AI agents may offer call-related functionalities such as call screening, warm hand-offs, and decision audits (e.g., detecting fraud by inferring call intent, by performing keyword matching, or the like), and can monitor and provide assistance during calls, provide summaries and transcriptions of screened calls, and handle call drops gracefully by notifying the other party that the user is experiencing connectivity issues. The AI agents can also support calendar integration and schedule automation, such as in the context of call scheduling, bookings, etc.

Users can converse with their AI agents via calls or texts, and leverage conversational memory to maintain context and continuity and personalize the AI assistant experience. The AI agents can also send text- and voice-based reminders to users to ensure that they stay informed and organized. In sum, the AI agents can be customized to align with the user's preferences and needs, encompassing the agent's knowledge, identity, and assistant processes (e.g., call screening, appointment scheduling, order purchasing, etc.) based on user inputs, feedback, etc.

While various embodiments are described herein in the context of voice calls, such as, for instance, Voice over Long Term Evolution (VoLTE) or Voice over New Radio (NR), the principles and functionalities can also be applied to other forms of communication, including video calls, messaging, data sessions, and any application traversing the network.

Moreover, AI agents can be trained to operate across multiple modalities during a call, encompassing voice, video, text, and images. These agents can also be equipped to detect and interpret additional modalities such as emotion, body language, and/or gestures. This capability allows AI agents to facilitate decision-making and perform tasks with a deeper understanding of the context and nuances of the interaction.

Embodiments described herein prioritize user data privacy and give users control over the use of their own data. Users can choose to opt-in to utilize AI agents and their various AI-based services as desired. The network acts as a steward of user data, ensuring that personal data utilized by AI agents remains under the ownership and management of the user. This empowers users to maintain control over their AI-related data. Various embodiments support user AI memory and portability, which provide users with the ability to manage and port/transfer their AI-related memories to other provider systems as desired or to consolidate memories from multiple providers into a single service. Furthermore, one or more embodiments enable AI identities, user configured rules, dynamic policies, and/or user memories to be ported along with their AI identifier/MSISDN from one network carrier to another.

Some or all of the embodiments described herein can be combined in whole or in part with the embodiments described in co-pending U.S. patent application Ser. No. 19/054,063 filed on Feb. 14, 2025 and entitled “QUALITY OF SERVICE REQUIREMENTS IMPLEMENTATION FOR ARTIFICIAL INTELLIGENCE/MACHINE LEARNING (AI/ML) DATA TRAFFIC IN A RADIO ACCESS NETWORK,” which is incorporated herein by reference in its entirety. For instance, embodiments of this co-pending U.S. application can be combined in whole or in part with embodiments of the subject disclosure. As an example, one or more features and/or embodiments described in this co-pending application can be used in conjunction with (or as a substitute for) one or more features and/or embodiments described herein, and vice versa. For instance, one or more techniques described in this co-pending application involving the configuring of and/or the use of the artificial intelligence/machine learning plane (AMP) (e.g., relating to the mapping of AI/ML data to an AI/ML radio bearer based on quality of service (QoS) requirements in an AI/ML Data Adaptation Protocol (AMAP) layer) can be utilized to facilitate the deployment, utilization, and/or training of AI agents or assistants in a telecommunications network environment and/or to facilitate user-AI agent interactions or AI-agent-to-AI-agent interactions therein.

Some or all of the embodiments described herein can be combined in whole or in part with the embodiments described in co-pending U.S. patent application Ser. No. 19/054,057 filed on Feb. 14, 2025 and entitled “AMP: A NEW AI/ML PLANE FOR AI/ML DATA TRAFFIC,” which is incorporated herein by reference in its entirety. For instance, embodiments of this co-pending U.S. application can be combined in whole or in part with embodiments of the subject disclosure. As an example, one or more features and/or embodiments described in this co-pending application can be used in conjunction with (or as a substitute for) one or more features and/or embodiments described herein, and vice versa. For instance, one or more techniques described in this co-pending application involving the configuring of and/or the use of the AMP (e.g., relating to the communicating of AI/ML data or relating to lifecycle management of AI/ML data models) can be utilized to facilitate the deployment, utilization, and/or training of AI agents or assistants in a telecommunications network environment and/or to facilitate user-AI agent interactions or AI-agent-to-AI-agent interactions therein.

Some or all of the embodiments described herein can be combined in whole or in part with the embodiments described in co-pending U.S. patent application Ser. No. 19/054,061 filed on Feb. 14, 2025 and entitled “ENHANCED ARTIFICIAL INTELLIGENCE/MACHINE LEARNING (AI/ML) MODEL MONITORING FRAMEWORK FOR MOBILE COMMUNICATION NETWORKS,” which is incorporated herein by reference in its entirety. For instance, embodiments of this co-pending U.S. application can be combined in whole or in part with embodiments of the subject disclosure. As an example, one or more features and/or embodiments described in this co-pending application can be used in conjunction with (or as a substitute for) one or more features and/or embodiments described herein, and vice versa. For instance, one or more techniques described in this co-pending application involving the configuring of and/or the use of the AMP (e.g., relating to the monitoring of metrics of one or more AI/ML models running on user equipment (UEs)) can be utilized to facilitate the deployment, utilization, and/or training of AI agents or assistants in a telecommunications network environment and/or to facilitate user-AI agent interactions or AI-agent-to-AI-agent interactions therein.

Some or all of the embodiments described herein can be combined in whole or in part with the embodiments described in co-pending U.S. patent application Ser. No. 19/054,087 filed on Feb. 14, 2025 and entitled “ARTIFICIAL INTELLIGENCE/MACHINE LEARNING PLANE (AMP) WITH MULTIPLE TERMINATION POINTS IN A MOBILITY NETWORK,” which is incorporated herein by reference in its entirety. For instance, embodiments of this co-pending U.S. application can be combined in whole or in part with embodiments of the subject disclosure. As an example, one or more features and/or embodiments described in this co-pending application can be used in conjunction with (or as a substitute for) one or more features and/or embodiments described herein, and vice versa. For instance, one or more techniques described in this co-pending application involving the configuring of and/or the use of the AMP (e.g., relating to the General Packet Radio Service (GPRS) Tunneling Protocol for AI/ML (GTP-AM) or relating to the Network Data Analytics Function (NWDAF)) can be utilized to facilitate the deployment, utilization, and/or training of AI agents or assistants in a telecommunications network environment and/or to facilitate user-AI agent interactions or AI-agent-to-AI-agent interactions therein.

Some or all of the embodiments described herein can be combined in whole or in part with the embodiments described in co-pending U.S. patent application Ser. No. 19/054,049 filed on Feb. 14, 2025 and entitled “SHARING ARTIFICIAL INTELLIGENCE AND MACHINE LEARNING MODEL ADDITIONAL CONDITIONS ON AN AI/ML PLANE (AMP) IN A MOBILITY NETWORK,” which is incorporated herein by reference in its entirety. For instance, embodiments of this co-pending U.S. application can be combined in whole or in part with embodiments of the subject disclosure. As an example, one or more features and/or embodiments described in this co-pending application can be used in conjunction with (or as a substitute for) one or more features and/or embodiments described herein, and vice versa. For instance, one or more techniques described in this co-pending application involving the configuring of and/or the use of the AMP (e.g., relating to the collecting of information about network/UE configurations not typically used in AI/ML model training, and sharing such info across network layers to improve AI/ML training) can be utilized to facilitate the deployment, utilization, and/or training of AI agents or assistants in a telecommunications network environment and/or to facilitate user-AI agent interactions or AI-agent-to-AI-agent interactions therein.

Some or all of the embodiments described herein can be combined in whole or in part with the embodiments described in co-pending U.S. patent application Ser. No. 19/054,068 filed on Feb. 14, 2025 and entitled “A LOGICAL CHANNEL FOR AN AI/ML PLANE,” which is incorporated herein by reference in its entirety. For instance, embodiments of this co-pending U.S. application can be combined in whole or in part with embodiments of the subject disclosure. As an example, one or more features and/or embodiments described in this co-pending application can be used in conjunction with (or as a substitute for) one or more features and/or embodiments described herein, and vice versa. For instance, one or more techniques described in this co-pending application involving the configuring of and/or the use of the AMP (e.g., relating to the logical channel for carrying AI/ML-related data) can be utilized to facilitate the deployment, utilization, and/or training of AI agents or assistants in a telecommunications network environment and/or to facilitate user-AI agent interactions or AI-agent-to-AI-agent interactions therein.

Some or all of the embodiments described herein can be combined in whole or in part with the embodiments described in co-pending U.S. patent application Ser. No. 19/054,199 filed on Feb. 14, 2025 and entitled “A LOGICAL CHANNEL FOR AN AI/ML PLANE,” which is incorporated herein by reference in its entirety. For instance, embodiments of this co-pending U.S. application can be combined in whole or in part with embodiments of the subject disclosure. As an example, one or more features and/or embodiments described in this co-pending application can be used in conjunction with (or as a substitute for) one or more features and/or embodiments described herein, and vice versa. For instance, one or more techniques described in this co-pending application involving the configuring of and/or the use of the AMP (e.g., relating to the AI/ML radio bearer (AMRB) or relating to the configuring of or the use of the logical channel that carries AI/ML-related data) can be utilized to facilitate the deployment, utilization, and/or training of AI agents or assistants in a telecommunications network environment and/or to facilitate user-AI agent interactions or AI-agent-to-AI-agent interactions therein.

Some or all of the embodiments described herein can be combined in whole or in part with the embodiments described in co-pending U.S. patent application Ser. No. 18/974,970 filed on Dec. 10, 2024 and entitled “APPARATUSES AND METHODS FOR FACILITATING AI-ASSISTED VOICE AND MEDIA SERVICES,” which is incorporated herein by reference in its entirety. For instance, embodiments of this co-pending U.S. application can be combined in whole or in part with embodiments of the subject disclosure. As an example, one or more features and/or embodiments described in this co-pending application can be used in conjunction with (or as a substitute for) one or more features and/or embodiments described herein, and vice versa. For instance, one or more techniques described in this co-pending application involving the embedding/invoking of AI agent(s) (e.g., based on user preferences) can be utilized to facilitate the deployment, utilization, and/or training of AI agents or assistants in a telecommunications network environment and/or to facilitate user-AI agent interactions or AI-agent-to-AI-agent interactions therein.

Some or all of the embodiments described herein can be combined in whole or in part with the embodiments described in U.S. patent application Ser. No. 12/328,569 filed on Dec. 4, 2008 and entitled “APPARATUSES AND METHODS FOR FACILITATING AI-ASSISTED VOICE AND MEDIA SERVICES,” now U.S. Pat. No. 8,156,054, each of which is incorporated herein by reference in its entirety. For instance, embodiments of this U.S. application/patent can be combined in whole or in part with embodiments of the subject disclosure. As an example, one or more features and/or embodiments described in this this U.S. application/patent can be used in conjunction with (or as a substitute for) one or more features and/or embodiments described herein, and vice versa. For instance, one or more techniques described in this this U.S. application/patent involving the synthesis engine (e.g., relating to the measuring of a user's mood and the notification of such measurement to a party that seeks to interact with the user) can be utilized to facilitate the deployment, utilization, and/or training of AI agents or assistants in a telecommunications network environment and/or to facilitate user-AI agent interactions or AI-agent-to-AI-agent interactions therein.

Some or all of the embodiments described herein can be combined in whole or in part with the embodiments described in U.S. patent application Ser. No. 12/412,725 filed on Mar. 27, 2009 and entitled “SYSTEMS AND METHODS FOR PRESENTING INTERMEDIARIES,” now U.S. Pat. No. 9,489,039, each of which is incorporated herein by reference in its entirety. For instance, embodiments of this U.S. application/patent can be combined in whole or in part with embodiments of the subject disclosure. As an example, one or more features and/or embodiments described in this this U.S. application/patent can be used in conjunction with (or as a substitute for) one or more features and/or embodiments described herein, and vice versa. For instance, one or more techniques described in this this U.S. application/patent involving the presenting of an intermediary to a party that seeks to interact with an individual can be utilized to facilitate the deployment, utilization, and/or training of AI agents or assistants in a telecommunications network environment and/or to facilitate user-AI agent interactions or AI-agent-to-AI-agent interactions therein.

Telecommunications network providers typically use a Mobile Station International Subscriber Directory Number (MSISDN)—i.e., a telephone number—as the primary identity for a user or their associated device. A unique International Mobile Subscriber Identity (IMSI) for the user device is associated with the MSISDN in a network database (DB), and is also stored in a subscriber identity module (SIM) or electronic SIM (eSIM) of the device. The network uses the MSISDN to route voice calls/short message service (SMS) messages for the device, and uses the IMSI to uniquely identify the device on the network to facilitate the routing. The MSISDN generally does not change during the lifetime of a provider-subscriber relationship.

In various embodiments, the user's MSISDN or phone number may be used as the highest-level abstraction or identifier (“AI identifier”) that is associated with a user, where the user's devices (e.g., phone, home IoT management device, car, etc.) may be associated with respective AI identities that are linked or bound to that MSISDN/phone number/AI identifier. In certain embodiments, the AI identifier may be an e-mail address, a handle, a uniform resource locator (URL), or another unique value that is designated or assigned by the user, a network operator, or an affiliate thereof. It is conceivable that, as AI technology evolves, the reliance on a phone number as the primary identity for a user or user device may become inflexible or impractical. Thus, using an e-mail address, handle, etc. as the AI identifier of a user and allowing respective AI identities to be created and used for individual devices of the user revolutionizes the existing paradigm as MSISDNs/phone numbers can be decoupled from being used as identities for those devices. This obviates the need to permanently assign a phone number to the user or their device, and, as described in more detail herein, enables on-demand telecom services, where the devices can be dynamically associated with one or more (temporary or virtual) phone numbers as needed.

In one or more embodiments, network connectivity for the user device can be managed by an AI-based system, referred to herein as a device AI or an on-device AI, that is executing on the device. The device AI can monitor for and intelligently assess available connectivity options for the user device, such as cellular networks or Wi-Fi, and can engage with cellular networks to dynamically obtain MSISDN(s)/IMSI(s) if needed. Where the device AI does not detect an available Wi-Fi connection, but detects an available cellular network, the device AI can obtain a temporary phone number from the network's eSIM infrastructure. As part of engaging with the network, the device AI can register the user device with a central repository function of the network such that the AI identity of the device is associated, or mapped, with the assigned phone number. Where the device AI later detects the availability of an alternative connection, such as a Wi-Fi connection, the device AI can coordinate with the network to release or relinquish the eSIM or phone number. Adopting an AI-centric identity for a user device as described herein provides for a more adaptable and efficient telecommunications experience, as phone calls, data communications, etc. can be routed for the device using its associated AI identity.

In the current landscape of AI systems, such as those provided by various technology companies that offer virtual assistants and AI-driven services, a user's “memories” or “AI memories” are stored separately across different platforms. Such memories may be or may include data about the user (e.g., name, date of birth, address, occupation, etc.), user preferences, past interactions with AI (e.g., via prior user queries/prompts/responses), and/or contextual information that the AI has learned about the user over time. Because of the separation, the user's interactions with AI are encompassed in isolated islands of knowledge that are not shared or standardized. Each AI system retains distinct information about the user, and so has only a fragmented understanding of the user's information, preferences, and interactions. There is no consensus on the specific metadata to store for these memories, which limits the user's ability to manage their data comprehensively. For instance, while a user might delete a sentence about themselves from one AI, they cannot tag it as sensitive or set an expiration date to manage their memories effectively.

As AI technology continues to evolve, the need for a unified approach to managing user memories will become increasingly apparent. Exemplary embodiments described herein propose a solution that standardizes metadata associated with a user's interactions with different AI systems across AI service providers. The solution provides attributes, such as sensitivity, expiration, and context, for memories, which enables users to control and manage use of their memories. Context allows for control of how/when a memory is relevant or can be used—e.g., a memory may be used only when discussing car repairs, while another memory may be used in any conversation, regardless of context. In various embodiments, users may be permitted to manage their memories by requesting the deletion of, or specifying usage limitations for, individual AI memories. Users can thus set privacy and data preferences and expect that they be fully respected by every telecom/AI service provider. Access controls can also be set by the user to facilitate AI system access to the user's memories.

Standardizing the schema for user AI memories allows for the ability to transfer or port their AI memories between platforms, such as from one telecom/AI service provider to another, or even consolidate their AI memories across platforms. This offers users with greater control over their AI-related data, essentially giving users “ownership” of their AI. It will be appreciated that this control enables users to willfully segregate their data among different service providers or AI identities. For example, a user may choose to use one provider for personal matters and another for work-related matters, or may maintain separate AI identities (associated with different user memories) within a single provider to manage different aspects of their life. This flexibility ensures that users can organize and manage their AI memories in a way that best suits their needs, whether through consolidation for a holistic view or segregation for privacy and contextual relevance. While AI identities and memory AI, along with example uses thereof, may be described herein with particular emphasis on individual users, it should be understood and appreciated that these concepts may also extend to organizations, such as corporations or similar entities. For instance, AI identities and memory AI may be utilized by corporations to manage multiple AI identities acting on their behalf, such as customer care agents or other operational AI systems. These AI identities may deposit memories into a centralized memory AI owned and managed by the corporation, enabling the organization to maintain a unified repository of contextual and operational data. This approach allows corporations to leverage AI identities and memory AI for enhanced collaboration, streamlined operations, and improved decision-making across various departments and functions.

Integrating AI services into a telecommunications provider's network can significantly enhance user experience by allowing users to have AI assist them in relation to calls. This assistance can include call handling or processing, providing real-time information, or even managing call interactions. When a call is initiated, the network can insert an AI agent to perform these tasks. For instance, the AI agent can screen incoming calls, identify potential spam, or provide the user with relevant information during the call.

It is conceivable that users may wish to call or text into the network to interact with their AI assistant, such as to set call handling/processing preferences, set AI call joining preferences, review summaries of voice messages, review summaries relating to handled/processed calls, provide feedback regarding handled/processed calls, and so on. However, the integration of AI services into telecommunications networks introduces potential security risks, particularly concerning the spoofing of calls to AI services or management interfaces. Spoofing occurs when a malicious actor impersonates a legitimate user in an attempt to interact with the AI agent under false pretenses. This risk is heightened by the limitations of current caller identification solutions, such as caller ID, which can be easily manipulated. Existing verification mechanisms such as Secure Telephone Identity Revisited (STIR) and Signature-based Handling of Asserted Information Using TOKENs (SHAKEN) are designed to authenticate caller identity, but face challenges, especially when users are roaming.

Caller ID spoofing involves an attacker falsifying their telephone number or Caller Name ID during an outbound call. Current solutions often rely on candidate lists based on signaling signatures to identify spoofed calls. However, these methods do not account for the temporal and spatial aspects of a UE's eligibility to make a voice call. For instance, spammers may inject calls into the network using MSISDNs that are associated with IoT devices, connected cars, or broadband devices, which are not intended for voice calls. Additionally, detecting whether devices are currently registered to make voice calls poses a challenge. A SIM card used in a smartphone one week and then in a tablet the next should raise suspicion if a voice call is made via the SIM. Furthermore, discrepancies in call origination locations, such as a call appearing to originate from a different geographic region than the device's actual location, further complicate spoofing detection. These challenges underscore the need for more robust authentication measures to secure user-to-AI interactions.

In exemplary embodiments, a detection system may be integrated into the telecommunications network to assess the temporal and/or spatial aspects of a UE to verify whether a caller UE that is making a call to a user's AI is indeed the user's own UE. The detection system may be configured to handle the call by performing passive authentication or validation of the caller UE. If the passive authentication fails, the detection system may resort to using active authentication as a fallback. This advantageously reduces the possibility of a spoofed caller UE gaining access to a user's AI by impersonating the user's own UE.

In various embodiments, the passive authentication may involve validating whether the caller UE is registered to make a voice call. For example, in the case of a Voice over LTE (VoLTE) or Voice over New Radio (VoNR) call, the detection system may check if the caller UE has created an appropriate Quality of Service Class Identifier (QCI) 5 bearer and/or has completed an appropriate, successful Session Initiation Protocol (SIP) REGISTER message. Similar checks may be performed for other voice technologies, such as 2G, 3G, etc. In one or more embodiments, the detection system may validate whether the caller UE has performed the appropriate radio signaling, such as by creating a an appropriate QCI 1 bearer, to initiate a voice call. This advantageously considers both cellular connectivity and Wi-Fi connectivity.

In various embodiments, the passive authentication may additionally, or alternatively, involve validating whether the call from the caller UE is being admitted into the network by the expected ingress point.

In one or more embodiments, the detection system may validate if geolocation information, such as, for instance, information in accordance with that specified in Section 5.4 of Request For Comments (RFC) 7315, July 2014 (which is incorporated by reference herein in its entirety) or the like, that is added/provided by the caller UE in an INVITE is consistent with a determined physical location of the caller UE.

In one or more embodiments, the detection system may validate if the call was processed by a network function, such as a Call Session Control Function (CSCF) instance, that is expected to process requests from the caller UE. For instance, the network may typically allocate an instance that is proximate to (e.g., within a threshold distance from) a UE to process user traffic, and this mapping can be established during the SIP REGISTER message exchange.

In one or more embodiments, the detection system may validate whether the movement of the caller UE is consistent with what is physically possible. For instance, if the caller UE is determined to be located in New York, it would generally not be possible for that same caller UE to be connected to a network in Los Angeles within two minutes. The detection system may check for handoffs between cell sites that are not in close proximity to one another (i.e., not within a threshold distance from one another), and may utilize the handoff information to validate the caller UE. The detection system may additionally, or alternatively, assess elevation to determine whether the caller UE is moving faster than a car (ground level) or faster than a plane (cruising altitude), and may utilize this assessment to validate the caller UE.

The information used by the detection system to perform validation can be obtained or collected from different elements or systems depending on the specific implementation of the detection system. As an example, the information can be obtained from network elements, such as a Mobility Management Entity (MME) of an Evolved Packet Core (EPC) or a similar system of another type of core network and/or the CSCF of an IP Multimedia Subsystem (IMS) that are involved in signaling, e.g., as defined in 3^{rd} Generation Partnership Project (3GPP) TS 23.401, such as Version 18.8.0 thereof, which is incorporated by reference herein in its entirety. As another example, the information may additionally, or alternatively, be obtained from a Universal Subscriber Identity Module (USIM) application (e.g., as defined in 3GPP 31.111, such as Version 18.5.1 thereof, and/or ETSI TS 102 223V17.0.0, each of which is incorporated by reference herein in its entirety). The USIM application may be installed on the SIM card and may use standard interfaces to collect information from the UE, such as SIP registration status, Radio Access Technology (RAT) change, and/or cell selection.

In certain embodiments, in addition to or as an alternative to facilitating the passive and/or active authentications described above for validating a call that is made to a user's AI, the detection system may facilitate a different type of (e.g., active authentication) that leverages AI—i.e., AI-based screening. In exemplary embodiments, the detection system may be configured to perform trigger-based AI screening (e.g., for voice and/or messaging). Traditionally, determining call spoofing relied on signaling data to make inferences. A significant advantage of using AI prescreening techniques described herein is that AI can utilize network-provided information to modify how a user-to-AI call is screened.

In exemplary embodiments, the central repository function, acting as an AI identity registration system, may be configured to dynamically select an AI identity in response to a request from an AI consumer during an AI discovery process. While the AI consumer might request a specific AI identity type, such as a personal AI identity of a user, the function may determine which AI identity to provide to the AI consumer based on one or more criteria, such as time of day, consumer AI identity/history, and/or the like. For example, the function may choose a family AI identity of the user if the request is made during weekends, and a work AI identity of the user if the request is made during typical working hours, despite the AI consumer requesting a different type of AI identity. Dynamic AI selection enhances user experience and protects user data by providing types of AI identities that are appropriate for the AI consumer or user. Only the AI services that are appropriate for the selected AI identity type would then be orchestrated, for instance, thereby tailoring the AI assistance based on the appropriate needs, preferences, and/or user memories that are associated with that AI identity type.

One or more aspects of the subject disclosure include a device, comprising a processing system including a processor, and a memory that stores executable instructions that, when executed by the processing system, facilitate performance of operations. The operations can include based on an attachment of a user equipment (UE) to a telecommunications network, causing the telecommunications network to bind phone number-related information to an artificial intelligence (AI) identity corresponding to the UE, resulting in a binding that enables the UE to request for an allocation of a phone number for the UE. Further, the operations can include based on the allocation of the phone number for the UE, associating the AI identity with data relating to the phone number, thereby facilitating on demand telecommunications services for the UE via the AI identity.

One or more aspects of the subject disclosure include a non-transitory machine-readable medium, comprising executable instructions that, when executed by a processing system including a processor, facilitate performance of operations. The operations can include based on an attachment of a user equipment (UE) to a network, causing the network to bind phone number-related information to an artificial intelligence (AI) identity corresponding to the UE, resulting in a binding that enables the UE to trigger an allocation of a phone number for the UE. Further, the operations can include based on the allocation of the phone number for the UE, associating the AI identity with information relating to the phone number, thereby facilitating on demand telecommunications services for the UE via the AI identity.

One or more aspects of the subject disclosure include a method. The method can comprise receiving, by a processing system including a processor, a command to register an artificial intelligence (AI) identity for a user equipment (UE), wherein the command includes profile data that identifies a type for the AI identity. Further, the method can include based on the command, causing, by the processing system, the AI identity to be registered in association with a phone number that corresponds to a user of the UE, thereby enabling the AI identity to be used to facilitate AI-related services for the user in relation to the phone number.

One or more aspects of the subject disclosure include a device, comprising a processing system including a processor, and a memory that stores executable instructions that, when executed by the processing system, facilitate performance of operations. The operations can include obtaining network-related data or device-related data associated with a user equipment (UE), wherein the UE is associated with a network-hosted artificial intelligence (AI) assistant that provides AI services for a user of the UE. Further, the operations can include detecting an attempt from an endpoint to access the network-hosted AI assistant. Further, the operations can include validating the attempt based on the network-related data or the device-related data.

One or more aspects of the subject disclosure include a non-transitory machine-readable medium, comprising executable instructions that, when executed by a processing system including a processor, facilitate performance of operations. The operations can include obtaining network-related data or device-related data associated with a user equipment (UE), wherein the UE is associated with a network-hosted artificial intelligence (AI) assistant that provides AI services for a user of the UE. Further, the operations can include detecting a call invite from an endpoint that is directed to the network-hosted AI assistant. Further, the operations can include performing passive authentication of the call invite by determining whether one or more information elements in the call invite match one or more corresponding information elements in the network-related data or the device-related data.

One or more aspects of the subject disclosure include a method. The method can comprise obtaining, by a processing system including a processor, network-related data or device-related data associated with a user equipment (UE), wherein the UE is associated with a network-hosted artificial intelligence (AI) assistant that provides AI services for a user of the UE. Further, the method can include detecting, by the processing system, an attempt from an endpoint to access the network-hosted AI assistant. Further, the method can include performing, by the processing system, AI-based screening of the attempt based on the network-related data or the device-related data.

One or more aspects of the subject disclosure include a device, comprising a processing system including a processor, and a memory that stores executable instructions that, when executed by the processing system, facilitate performance of operations. The operations can include obtaining data that corresponds to one or more interactions of a user with an artificial intelligence (AI) agent. Further, the operations can include causing the data to be converted into one or more AI memories of the user. Further, the operations can include after the causing, receiving a request for AI memories of the user. Further, the operations can include responding to the request by retrieving the one or more AI memories, wherein the one or more AI memories are stored in a predefined format that enables access thereto by an external system or portability thereof to the external system.

One or more aspects of the subject disclosure include a non-transitory machine-readable medium, comprising executable instructions that, when executed by a processing system including a processor, facilitate performance of operations. The operations can include causing a memory artificial intelligence (AI) identity for a user to be registered with an AI repository function, resulting in a registration, wherein the memory AI identity corresponds to a memory AI system that stores or facilitates storage of AI memories of the user. Further, the operations can include after the registration, obtaining, from an AI agent, a request to access the memory AI identity for purposes of storing data that corresponds to one or more AI-related actions associated with the user. Further, the operations can include based on the request, causing information for accessing the memory AI identity to be provided to the AI agent, thereby enabling the AI agent to provide the data for storage in the memory AI system as one or more AI memories of the user.

One or more aspects of the subject disclosure include a method. The method can comprise causing, by a processing system including a processor, a memory artificial intelligence (AI) identity for a user to be registered with an AI repository function, resulting in a registration, wherein the memory AI identity corresponds to a memory AI system that stores or facilitates storage of AI memories of the user. Further, the method can include after the registration, obtaining, by the processing system and from an AI agent, a request to access the memory AI identity for purposes of retrieving one or more of the AI memories of the user. Further, the method can include based on the request, causing information for accessing the memory AI identity to be provided to the AI agent, thereby enabling the AI agent to request retrieval of the one or more of the AI memories of the user.

One or more aspects of the subject disclosure include a system, comprising at least one processor, and a memory that stores executable instructions that, when executed by the at least one processor, facilitate performance of operations. The operations can include receiving a request relating to a call from a caller directed to a callee. Further, the operations can include determining, based on call preferences, call policies, or user intent associated with the callee, whether to forward the call for artificial intelligence (AI)-based handling or processing. Further, the operations can include based on a determination to forward the call for AI-based handling or processing, causing an AI agent to facilitate the handling or processing of the call, wherein the handling or processing involves obtaining first media packets from the caller, converting the first media packets into large language model (LLM) inputs, providing the LLM inputs to an LLM for processing and output generation, converting LLM-generated outputs into second media packets, and causing the second media packets to be provided to the caller.

One or more aspects of the subject disclosure include a non-transitory machine-readable medium, comprising executable instructions that, when executed by a processing system including a processor, facilitate performance of operations. The operations can include receiving a request relating to a call from a caller directed to a callee. Further, the operations can include determining, based on device information associated with a user device of the callee, that the call is to be subjected to artificial intelligence (AI)-based handling or processing. Further, the operations can include based on the determining, causing an AI agent to facilitate the handling or processing of the call, wherein the handling or processing involves obtaining first media packets from the caller, converting the first media packets into AI model inputs, providing the AI model inputs to an AI model for processing and output generation, converting AI model-generated outputs into second media packets, and causing the second media packets to be provided to the caller.

One or more aspects of the subject disclosure include a method. The method can comprise receiving, by a processing system, a request relating to a call from a caller directed to a callee. Further, the method can include determining, by the processing system and based on call preferences, call policies, or user intent associated with the callee, whether to subject the call to artificial intelligence (AI)-based handling or processing. Further, the method can include based on a determination to subject the call to AI-based handling or processing, controlling, by the processing system, an AI agent to facilitate the handling or processing of the call, wherein the handling or processing involves obtaining first media packets from the caller, converting the first media packets into large language model (LLM) inputs, providing the LLM inputs to an LLM for processing and output generation, conversion of LLM-generated outputs into second media packets, causing the second media packets to be provided to the caller, and wherein the handling or processing further involves repeating of one or more of the obtaining, the converting, the providing, the conversion, and the causing.

One or more aspects of the subject disclosure include a device, comprising a processing system including a processor, and a memory that stores executable instructions that, when executed by the processing system, facilitate performance of operations. The operations can include receiving, from a first user device, a first command to register a first artificial intelligence (AI) identity for a user and, from a second user device, a second command to register a second AI identity for the user, wherein the first command includes first profile data that identifies a first type for the first AI identity, and wherein the second command includes second profile data that identifies a second type for the second AI identity. Further, the operations can include based on the first and second commands, causing the first profile data and the second profile data to be included in a mapping corresponding to the user. Further, the operations can include after the causing, obtaining, from an AI system, a request to access the first AI identity. Further, the operations can include responsive to the obtaining, providing information for accessing the second AI identity to the AI system, wherein the providing is based on a determination that the second AI identity is to be accessed by the AI system, and wherein the determination is based on one or more criteria being satisfied, thereby enabling dynamic AI identity selection and access.

One or more aspects of the subject disclosure include a non-transitory machine-readable medium, comprising executable instructions that, when executed by a processing system including a processor, facilitate performance of operations. The operations can include receiving, from a first user device, a first command to register a first artificial intelligence (AI) identity for a user and, from a second user device, a second command to register a second AI identity for the user, wherein the first command includes first profile data that identifies a first type for the first AI identity, and wherein the second command includes second profile data that identifies a second type for the second AI identity. Further, the operations can include based on the first and second commands, causing the first profile data and the second profile data to be included in a mapping corresponding to the user. Further, the operations can include after the causing, obtaining, from an AI system, a request to access the first AI identity. Further, the operations can include responsive to the obtaining, providing information for accessing the first AI identity to the AI system, wherein the providing is based on a determination that the second AI identity is not to be accessed by the AI system, and wherein the determination is based on one or more criteria being satisfied, thereby enabling dynamic AI identity selection and access.

One or more aspects of the subject disclosure include a method. The method can comprise receiving, by a processing system including a processor and from a first user device, a first command to register a first artificial intelligence (AI) identity for a user and, from a second user device, a second command to register a second AI identity for the user, wherein the first command includes first profile data that identifies a first type for the first AI identity and first access information for the first AI identity, and wherein the second command includes second profile data that identifies a second type for the second AI identity and second access information for the second AI identity. Further, the method can include based on the first and second commands, causing the first profile data and the second profile data to be included in a mapping corresponding to the user. Further, the method can include after the causing, obtaining, from an AI system, a request to access the first AI identity. Further, the method can include responsive to the obtaining, providing the second access information to the AI system, wherein the providing is based on a determination that the second AI identity is to be accessed by the AI system, and wherein the determination is based on one or more criteria being satisfied, thereby enabling dynamic AI identity selection and access.

Other embodiments are described in the subject disclosure.

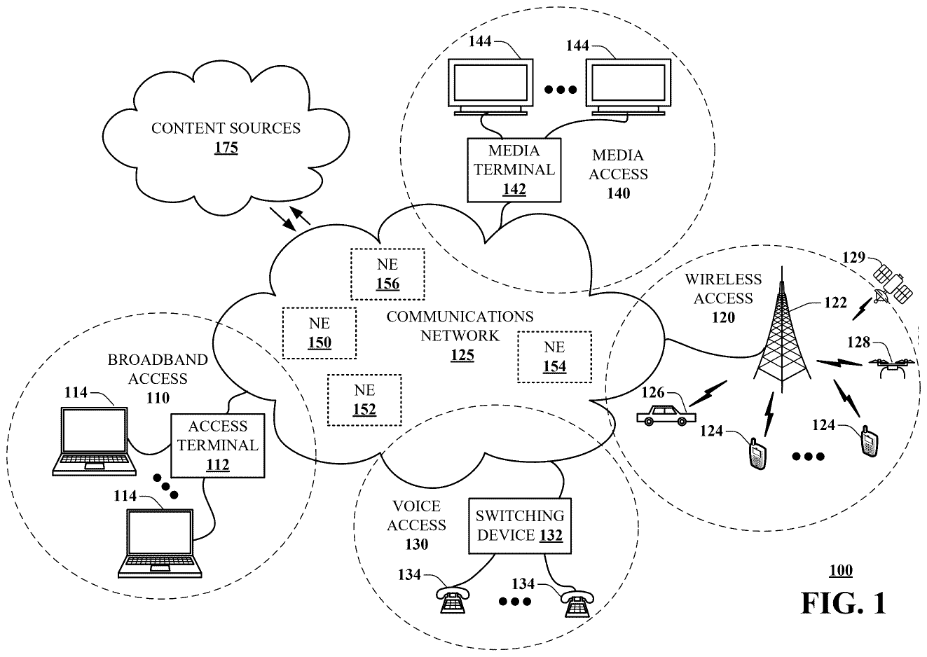

Referring now to FIG. 1, a block diagram is shown illustrating an example, non-limiting embodiment of a system 100 in accordance with various aspects described herein. For example, system 100 can facilitate, in whole or in part, on demand telecom using AI, securing of user-to-AI calls, trigger-based AI screening of user-to-AI calls, AI memory ownership/portability, network-hosted AI, and/or dynamic AI selection. In particular, a communications network 125 is presented for providing broadband access 110 to a plurality of data terminals 114 via access terminal 112, wireless access 120 to a plurality of mobile devices 124, vehicle 126, and uncrewed aerial vehicle (UAV) 128 via base station or access point 122 (and/or via satellite(s) 129), voice access 130 to a plurality of telephony devices 134, via switching device 132 and/or media access 140 to a plurality of audio/video display devices 144 via media terminal 142. In addition, communications network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or another communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices. In various embodiments, the satellite(s) 129 can be configured for bi-directional communication with one or more access points, with one or more base stations, and/or with one or more mobile devices (e.g., direct-to-cell). In various embodiments, the satellite(s) 129 can include one or more Low Earth Orbit (LEO) satellites or one or more Geostationary Orbit (GEO) satellites.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

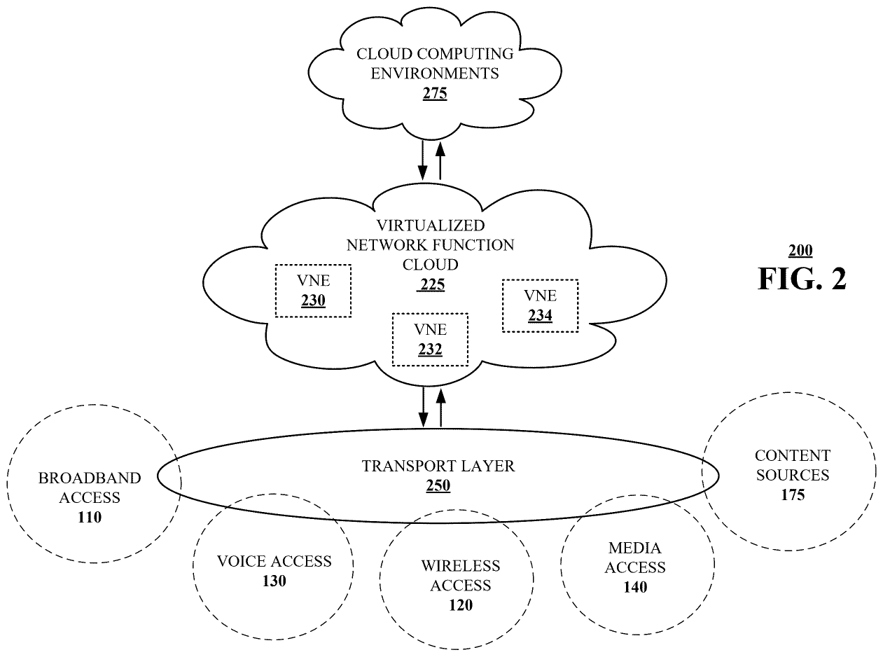

Referring now to FIG. 2, a block diagram 200 is shown illustrating an example, non-limiting embodiment of a virtualized communications network in accordance with various aspects described herein. In particular, a virtualized communications network is presented that can be used to implement some or all of the subsystems and functions and/or methods described herein. For example, virtualized communications network 200 can facilitate, in whole or in part, on demand telecom using AI, securing of user-to-AI calls, trigger-based AI screening of user-to-AI calls, AI memory ownership/portability, network-hosted AI, and/or dynamic AI selection.

In particular, a cloud networking architecture is shown that leverages cloud technologies and supports rapid innovation and scalability via a transport layer 250, a virtualized network function cloud 225 and/or one or more cloud computing environments 275. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communications network employs virtual network elements (VNEs) 230, 232, 234, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 230 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 250 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 230, 232 or 234. These network elements can be included in transport layer 250.

The virtualized network function cloud 225 interfaces with the transport layer 250 to provide the VNEs 230, 232, 234, etc. to provide specific NFVs. In particular, the virtualized network function cloud 225 leverages cloud operations, applications, and architectures to support networking workloads. The virtualized network elements 230, 232 and 234 can employ network function software that provides either a one-for-one mapping of traditional network element function or alternately some combination of network functions designed for cloud computing. For example, VNEs 230, 232 and 234 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward substantial amounts of traffic, their workload can be distributed across a number of servers-each of which adds a portion of the capability, and which creates an overall elastic function with higher availability than its former monolithic version. These virtual network elements 230, 232, 234, etc. can be instantiated and managed using an orchestration approach similar to those used in cloud compute services.

The cloud computing environments 275 can interface with the virtualized network function cloud 225 via APIs that expose functional capabilities of the VNEs 230, 232, 234, etc. to provide the flexible and expanded capabilities to the virtualized network function cloud 225. In particular, network workloads may have applications distributed across the virtualized network function cloud 225 and cloud computing environment 275 and in the commercial cloud, or might simply orchestrate workloads supported entirely in NFV infrastructure from these third party locations.

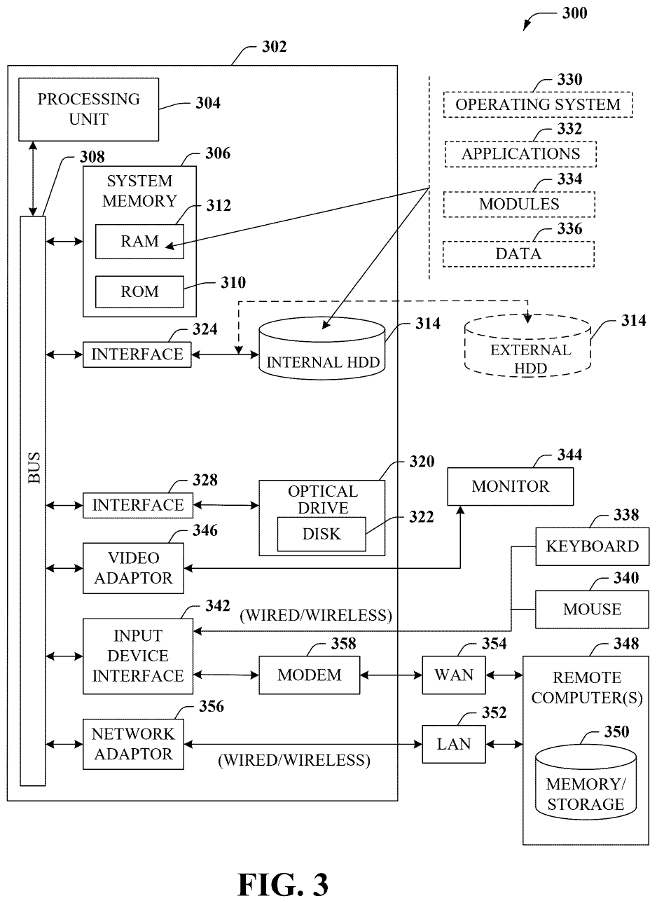

Turning now to FIG. 3, there is illustrated a block diagram of a computing environment in accordance with various aspects described herein. In order to provide additional context for various embodiments of the embodiments described herein, FIG. 3 and the following discussion are intended to provide a brief, general description of a suitable computing environment 300 in which the various embodiments of the subject disclosure can be implemented. In particular, computing environment 300 can be used in the implementation of network elements 150, 152, 154, 156, access terminal 112, base station or access point 122, switching device 132, media terminal 142, and/or VNEs 230, 232, 234, etc. Each of these devices can be implemented via computer-executable instructions that can run on one or more computers, and/or in combination with other program modules and/or as a combination of hardware and software. For example, computing environment 300 can facilitate, in whole or in part, on demand telecom using AI, securing of user-to-AI calls, trigger-based AI screening of user-to-AI calls, AI memory ownership/portability, network-hosted AI, and/or dynamic AI selection.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 3, the example environment can comprise a computer 302, the computer 302 comprising a processing unit 304, a system memory 306 and a system bus 308. The system bus 308 couples system components including, but not limited to, the system memory 306 to the processing unit 304. The processing unit 304 can be any of various commercially available processors. Dual microprocessors and other multiprocessor architectures can also be employed as the processing unit 304.

The system bus 308 can be any of several types of bus structure that can further interconnect to a memory bus (with or without a memory controller), a peripheral bus, and a local bus using any of a variety of commercially available bus architectures. The system memory 306 comprises ROM 310 and RAM 312. A basic input/output system (BIOS) can be stored in a non-volatile memory such as ROM, erasable programmable read only memory (EPROM), EEPROM, which BIOS contains the basic routines that help to transfer information between elements within the computer 302, such as during startup. The RAM 312 can also comprise a high-speed RAM such as static RAM for caching data.

The computer 302 further comprises an internal hard disk drive (HDD) 314 (e.g., EIDE, SATA), which internal HDD 314 can also be configured for external use in a suitable chassis (not shown), and an optical disk drive 320, (e.g., reading a CD-ROM disk 322 or, to read from or write to other high capacity optical media such as the DVD). The HDD 314, and optical disk drive 320 can be connected to the system bus 308 by a hard disk drive interface 324 and an optical drive interface 328, respectively. The hard disk drive interface 324 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 302, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 312, comprising an operating system 330, one or more application programs 332, other program modules 334 and program data 336. All or portions of the operating system, applications, modules, and/or data can also be cached in the RAM 312. The systems and methods described herein can be implemented utilizing various commercially available operating systems or combinations of operating systems.

A user can enter commands and information into the computer 302 through one or more wired/wireless input devices, e.g., a keyboard 338 and a pointing device, such as a mouse 340. Other input devices (not shown) can comprise a microphone, an infrared (IR) remote control, a joystick, a game pad, a stylus pen, touch screen or the like. These and other input devices are often connected to the processing unit 304 through an input device interface 342 that can be coupled to the system bus 308, but can be connected by other interfaces, such as a parallel port, an IEEE 1393 serial port, a game port, a universal serial bus (USB) port, an IR interface, etc.

A monitor 344 or other type of display device can be also connected to the system bus 308 via an interface, such as a video adapter 346. It will also be appreciated that in alternative embodiments, a monitor 344 can also be any display device (e.g., another computer having a display, a smart phone, a tablet computer, etc.) for receiving display information associated with computer 302 via any communication means, including via the Internet and cloud-based networks. In addition to the monitor 344, a computer typically comprises other peripheral output devices (not shown), such as speakers, printers, etc.

The computer 302 can operate in a networked environment using logical connections via wired and/or wireless communications to one or more remote computers, such as a remote computer(s) 348. The remote computer(s) 348 can be a workstation, a server computer, a router, a personal computer, portable computer, microprocessor-based entertainment appliance, a peer device or other common network node, and typically comprises many or all of the elements described relative to the computer 302, although, for purposes of brevity, only a remote memory/storage device 350 is illustrated. The logical connections depicted comprise wired/wireless connectivity to a local area network (LAN) 352 and/or larger networks, e.g., a wide area network (WAN) 354. Such LAN and WAN networking environments are commonplace in offices and companies, and facilitate enterprise-wide computer networks, such as intranets, all of which can connect to a global communications network, e.g., the Internet.

When used in a LAN networking environment, the computer 302 can be connected to the LAN 352 through a wired and/or wireless communications network interface or adapter 356. The adapter 356 can facilitate wired or wireless communication to the LAN 352, which can also comprise a wireless AP disposed thereon for communicating with the adapter 356.

When used in a WAN networking environment, the computer 302 can comprise a modem 358 or can be connected to a communications server on the WAN 354 or has other means for establishing communications over the WAN 354, such as by way of the Internet. The modem 358, which can be internal or external and a wired or wireless device, can be connected to the system bus 308 via the input device interface 342. In a networked environment, program modules depicted relative to the computer 302 or portions thereof, can be stored in the remote memory/storage device 350. It will be appreciated that the network connections shown are example and other means of establishing a communications link between the computers can be used.

The computer 302 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

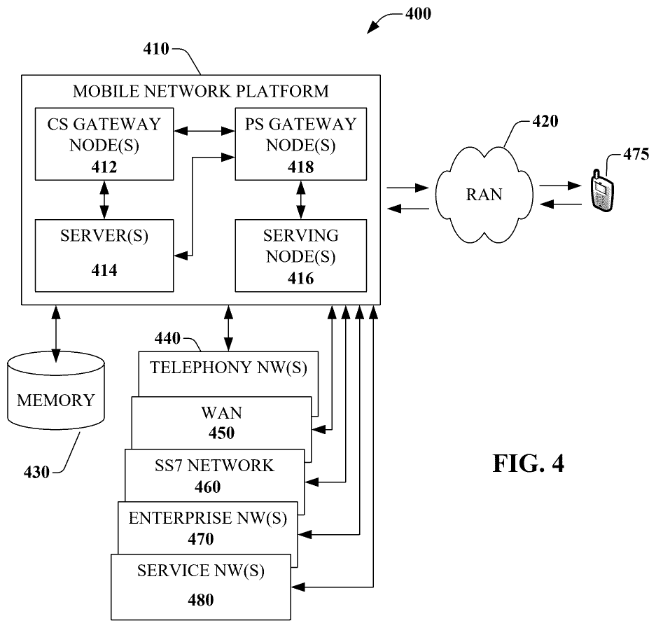

Turning now to FIG. 4, an embodiment 400 of a mobile network platform 410 is shown that is an example of network elements 150, 152, 154, 156, and/or VNEs 230, 232, 234, etc. For example, platform 410 can facilitate, in whole or in part, on demand telecom using AI, securing of user-to-AI calls, trigger-based AI screening of user-to-AI calls, AI memory ownership/portability, network-hosted AI, and/or dynamic AI selection. In one or more embodiments, the mobile network platform 410 can generate and receive signals transmitted and received by base stations or access points such as base station or access point 122. Generally, mobile network platform 410 can comprise components, e.g., nodes, gateways, interfaces, servers, or disparate platforms, which facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 410 can be included in telecommunications carrier networks, and can be considered carrier-side components as discussed elsewhere herein. Mobile network platform 410 comprises CS gateway node(s) 412 which can interface CS traffic received from legacy networks like telephony network(s) 440 (e.g., public switched telephone network (PSTN), or public land mobile network (PLMN)) or a signaling system #7 (SS7) network 460. CS gateway node(s) 412 can authorize and authenticate traffic (e.g., voice) arising from such networks. Additionally, CS gateway node(s) 412 can access mobility, or roaming, data generated through SS7 network 460; for instance, mobility data stored in a visited location register (VLR), which can reside in memory 430. Moreover, CS gateway node(s) 412 interfaces CS-based traffic and signaling and PS gateway node(s) 418. As an example, in a 3GPP UMTS network, CS gateway node(s) 412 can be realized at least in part in gateway GPRS support node(s) (GGSN). It should be appreciated that functionality and specific operation of CS gateway node(s) 412, PS gateway node(s) 418, and serving node(s) 416, is provided and dictated by radio technology(ies) utilized by mobile network platform 410 for telecommunication over a radio access network 420 with other devices, such as a radiotelephone 475.

In addition to receiving and processing CS-switched traffic and signaling, PS gateway node(s) 418 can authorize and authenticate PS-based data sessions with served mobile devices. Data sessions can comprise traffic, or content(s), exchanged with networks external to the mobile network platform 410, like wide area network(s) (WANs) 450, enterprise network(s) 470, and service network(s) 480, which can be embodied in local area network(s) (LANs), can also be interfaced with mobile network platform 410 through PS gateway node(s) 418. It is to be noted that WANs 450 and enterprise network(s) 470 can embody, at least in part, a service network(s) like IP multimedia subsystem (IMS). Based on radio technology layer(s) available in technology resource(s) or radio access network 420, PS gateway node(s) 418 can generate packet data protocol contexts when a data session is established; other data structures that facilitate routing of packetized data also can be generated. To that end, in an aspect, PS gateway node(s) 418 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 400, mobile network platform 410 also comprises serving node(s) 416 that, based upon available radio technology layer(s) within technology resource(s) in the radio access network 420, convey the various packetized flows of data streams received through PS gateway node(s) 418. It is to be noted that for technology resource(s) that rely primarily on CS communication, server node(s) can deliver traffic without reliance on PS gateway node(s) 418; for example, server node(s) can embody at least in part a mobile switching center. As an example, in a 3GPP UMTS network, serving node(s) 416 can be embodied in serving GPRS support node(s) (SGSN).

For radio technologies that exploit packetized communication, server(s) 414 in mobile network platform 410 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 410. Data streams (e.g., content(s) that are part of a voice call or data session) can be conveyed to PS gateway node(s) 418 for authorization/authentication and initiation of a data session, and to serving node(s) 416 for communication thereafter. In addition to application server, server(s) 414 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 410 to ensure network's operation and data integrity in addition to authorization and authentication procedures that CS gateway node(s) 412 and PS gateway node(s) 418 can enact. Moreover, provisioning server(s) can provision services from external network(s) like networks operated by a disparate service provider; for instance, WAN 450 or Global Positioning System (GPS) network(s) (not shown). Provisioning server(s) can also provision coverage through networks associated to mobile network platform 410 (e.g., deployed and operated by the same service provider), such as distributed antenna networks that enhance wireless service coverage by providing more network coverage.

It is to be noted that server(s) 414 can comprise one or more processors configured to confer at least in part the functionality of mobile network platform 410. To that end, the one or more processors can execute code instructions stored in memory 430, for example. It should be appreciated that server(s) 414 can comprise a content manager, which operates in substantially the same manner as described hereinbefore.

In example embodiment 400, memory 430 can store information related to operation of mobile network platform 410. Other operational information can comprise provisioning information of mobile devices served through mobile network platform 410, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 430 can also store information from at least one of telephony network(s) 440, WAN 450, SS7 network 460, or enterprise network(s) 470. In an aspect, memory 430 can be, for example, accessed as part of a data store component or as a remotely connected memory store.

In order to provide a context for the various aspects of the disclosed subject matter, FIG. 4, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

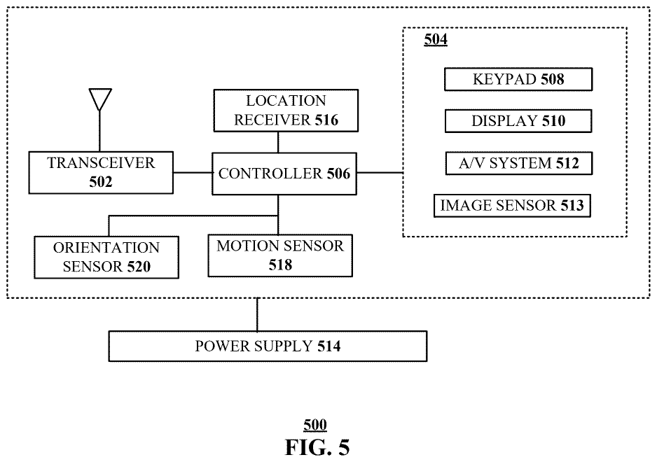

Turning now to FIG. 5, an illustrative embodiment of a communication device 500 is shown. The communication device 500 can serve as an illustrative embodiment of devices such as data terminals 114, mobile devices 124, vehicle 126, display devices 144 or other client devices (e.g., user devices or UEs) for communication via communications network 125. For example, computing device 500 can facilitate, in whole or in part, on demand telecom using AI, securing of user-to-AI calls, trigger-based AI screening of user-to-AI calls, AI memory ownership/portability, network-hosted AI, and/or dynamic AI selection.

The communication device 500 can comprise a wireline and/or wireless transceiver 502 (herein transceiver 502), a user interface (UI) 504, a power supply 514, a location receiver 516, a motion sensor 518, an orientation sensor 520, and a controller 506 for managing operations thereof. The transceiver 502 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 502 can also be adapted to support circuit-switched wireline access technologies (such as PSTN), packet-switched wireline access technologies (such as TCP/IP, VoIP, etc.), and combinations thereof.

The UI 504 can include a depressible or touch-sensitive keypad 508 with a navigation mechanism such as a roller ball, a joystick, a mouse, or a navigation disk for manipulating operations of the communication device 500. The keypad 508 can be an integral part of a housing assembly of the communication device 500 or an independent device operably coupled thereto by a tethered wireline interface (such as a USB cable) or a wireless interface supporting for example Bluetooth®. The keypad 508 can represent a numeric keypad commonly used by phones, and/or a QWERTY keypad with alphanumeric keys. The UI 504 can further include a display 510 such as monochrome or color LCD (Liquid Crystal Display), OLED (Organic Light Emitting Diode) or other suitable display technology for conveying images to an end user of the communication device 500. In an embodiment where the display 510 is touch-sensitive, a portion or all of the keypad 508 can be presented by way of the display 510 with navigation features.

The display 510 can use touch screen technology to also serve as a user interface for detecting user input. As a touch screen display, the communication device 500 can be adapted to present a user interface having graphical user interface (GUI) elements that can be selected by a user with a touch of a finger. The display 510 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 510 can be an integral part of the housing assembly of the communication device 500 or an independent device communicatively coupled thereto by a tethered wireline interface (such as a cable) or a wireless interface.

The UI 504 can also include an audio system 512 that utilizes audio technology for conveying low volume audio (such as audio heard in proximity of a human ear) and high volume audio (such as speakerphone for hands free operation). The audio system 512 can further include a microphone for receiving audible signals of an end user. The audio system 512 can also be used for voice recognition applications. The UI 504 can further include an image sensor 513 such as a charged coupled device (CCD) camera for capturing still or moving images.

The power supply 514 can utilize common power management technologies such as replaceable and rechargeable batteries, supply regulation technologies, and/or charging system technologies for supplying energy to the components of the communication device 500 to facilitate long-range or short-range portable communications. Alternatively, or in combination, the charging system can utilize external power sources such as DC power supplied over a physical interface such as a USB port or other suitable tethering technologies.

The location receiver 516 can utilize location technology such as a global positioning system (GPS) receiver capable of assisted GPS for identifying a location of the communication device 500 based on signals generated by a constellation of GPS satellites, which can be used for facilitating location services such as navigation. The motion sensor 518 can utilize motion sensing technology such as an accelerometer, a gyroscope, or other suitable motion sensing technology to detect motion of the communication device 500 in three-dimensional space. The orientation sensor 520 can utilize orientation sensing technology such as a magnetometer to detect the orientation of the communication device 500 (north, south, west, and east, as well as combined orientations in degrees, minutes, or other suitable orientation metrics).

The communication device 500 can use the transceiver 502 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 506 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 500.

Other components not shown in FIG. 5 can be used in one or more embodiments of the subject disclosure. For instance, the communication device 500 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on. As another example, the communication device 500 can be equipped to support embedded (eSIM) functionality in which one or more digital SIMs can be embedded in the device's hardware so as to allow for cellular network use without the need for a physical SIM card.

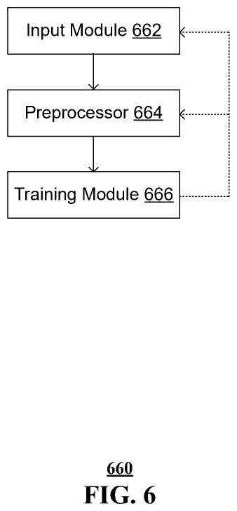

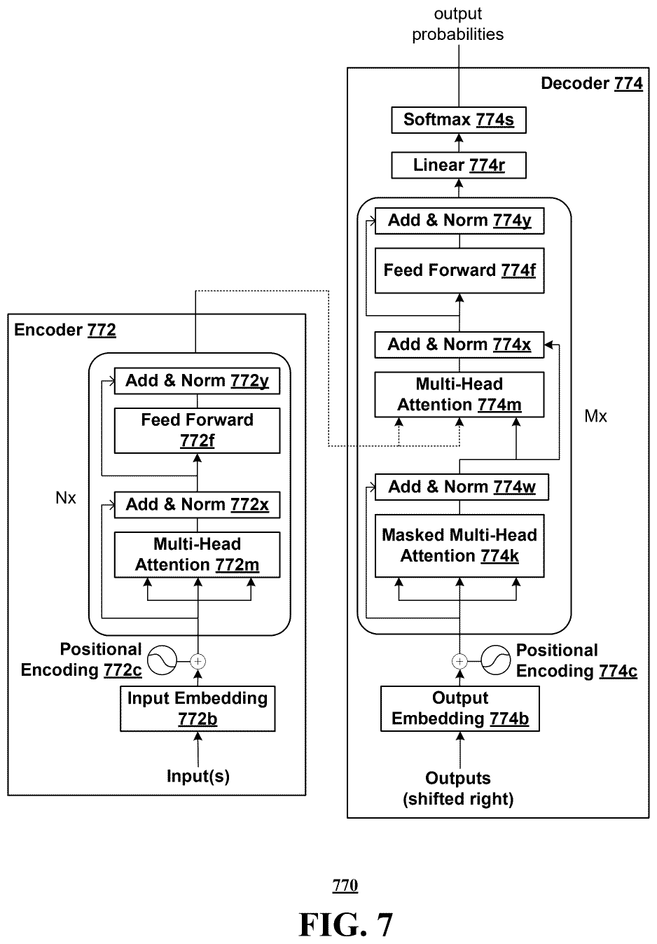

Referring to FIG. 6, an example AI architecture 660 may be used to facilitate training and/or pre-training of AI models. For instance, the AI architecture 660 may be used to facilitate training and/or pre-training of AI model(s) described herein, which may be or may include an LLM that is based on the transformer model 770 illustrated in FIG. 7 and described in more detail below. The AI architecture 660 may include an input module 662, a preprocessor 664, and a training module 666. Some or all of these modules, which may be referred to as programs, processors, or agents, may be realized based on execution of instructions or data by one or more processors of a computing (or ML) system, such as the computing system 300 of FIG. 3 described above.

The input module 662 may allow for input of (e.g., user-provided) data, such as datasets, parameters (e.g., weights, biases, and/or the like), etc., that can be used to train models and/or obtain predictions from models. In some cases, datasets may be labeled and may include inputs (e.g., observed or measured values) and known output data. Labeled datasets may facilitate supervised (or guided) learning.

Although not shown, the AI architecture 660 may include a library of ML models or algorithms, such as, for instance, one or more classifiers (e.g., a naïve Bayes classifier or the like), one or more support vector machines, one or more artificial neural networks (e.g., transformer neural networks, convolutional neural networks, and/or the like), one or more learned decision trees, and so on. Each of the ML algorithms may be associated with various parameters.

The preprocessor 664 may be equipped with one or more preprocessing algorithms that are configured to prepare input datasets for processing by the training module 666. Such preprocessing may include discretization (where values are binned or converted into nominal values), component analysis, data estimation, feature selection, feature extraction (e.g., dimensionality reduction, data removal, statistical analysis, threshold-based filtering, etc.), data interpolation, and/or the like.

The training module 666 may be configured to train and evaluate ML models. As an example, the training module 666 may be configured to perform unsupervised learning and/or supervised learning based in input datasets. In exemplary embodiments, the training module 666 may be capable of training and/or evaluating the performance of multiple models in parallel. In one or more implementations, the training module 666 may, despite operating on multiple ML models in parallel, train and evaluate the various ML models individually. In some implementations, the training module 666 may be capable of combining the procedure outcomes of multiple models to derive an aggregate outcome. Model evaluation or validation may involve a comparison of model outputs to known outputs or an analysis of model outputs relative to desired metrics.

In exemplary embodiments, certain processing techniques may be employed to generate usable data sets for feeding into the AI architecture 660 to train deep learning neural network model(s) to output predictions. Although not shown, the AI architecture 660 may include additional functional modules, such as those for gathering performance results and presenting (e.g., displaying) data regarding the results. While various components, modules, etc. may have been illustrated in FIG. 6 as separate components, modules, etc., it will be appreciated that multiple components, modules, etc. may be implemented as a single component, module, etc., or a single component, module, etc. may be implemented as multiple components, modules, etc. Additionally, functions described as being performed by one component, module, etc. may be performed by multiple components, modules, etc., or functions described as being performed by multiple components, modules, etc. may be performed by a single component, module, etc.

Referring to FIG. 7, an example transformer model 770 (a portion or an entirety of which may serve as a functional building block of one or more LLMs) may include an encoder 772 and a decoder 774. The encoder 772 may include an input embedding block 772b, a positional encoder 772c, and a series of (i.e., multiple (Nx)) identical layers that each has a multi-head attention block 772m and a feed forward block 772f. An input (e.g., text, such as a query or a prompt) may be converted into individual tokens (e.g., words, characters, etc.) that are fed into the input embedding block 772b. The input embedding block 772b may convert the tokens into continuous vectors, where each token is mapped to a high-dimensional space by way of a learned embedding matrix. The embedding matrix may be implemented in a lookup table or the like, where token indexes are associated with different vectors of a fixed size. The positional encoder 772c may derive fixed positional encodings or learned positional encodings to help capture positional information of tokens. Fixed positioning encodings may be generated using sinusoidal functions, where the different frequencies of sine/cosine functions correspond to unique positional encodings for the different positions in a given sequence. Learned positional encodings may be learned during training based on initially randomly chosen values that are optimized as part of the training process. In any case, the positional encodings may be combined with the input embeddings from the input embedding block 772b on an element-by-element basis, resulting in a processed input that may be fed into the series of layers. The processed input may be fed into the multi-head attention block 772m in the first layer. An addition (or residual connection) and normalization block 772x may operate on the processed input and the output of that multi-head attention block 772m. The output of the addition and normalization block 772x may be passed to the feed forward block 772f in that layer. An addition and normalization block 772y may operate on the output of the addition and normalization block 772x and the output of the feed forward block 772f. In essence, the multi-head attention block 772m of a given layer may enable the feed forward block 772f in that layer to model long term dependencies. Multi-head attention allows the model to simultaneously attend to different parts of the input sequence and weigh their importance based on the input sequence's internal relationships. This attention mechanism may be combined with the input sequence's representations to produce a new set of weighted representations. Iterating the identical layers allows the model to learn complex patterns and relationships in the data.

The decoder 774 may include an output embedding block 774b, a positional encoder 774c, and a series of (i.e., multiple (Mx)) identical layers that each has a masked multi-head attention block 774k, a multi head attention block 774m, and a feed forward block 774f. An output (shifted right) may be converted into individual tokens that are fed into the output embedding block 774b. The output embedding block 774b may convert the tokens into continuous vectors. The positional encoder 774c may derive fixed positional encodings or learned positional encodings to help capture positional information of tokens. The processed output may be fed into the masked multi-head attention block 774k in the first layer. An addition and normalization block 774w may operate on the processed output and the output of that masked multi-head attention block 774k. The output of the addition and normalization block 774w may be passed to the multi-head attention block 774m in that layer. Output(s) from the encoder 772 may also be fed into the multi-head attention block 774m. An addition and normalization block 774x may operate on the output of the addition and normalization block 774w and the output of multi-head attention block 774m. The output of the addition and normalization block 774x may be passed to the a feed forward block 774f in that layer. An addition and normalization block 774y may operate on the output of the addition and normalization block 774x and the output of the feed forward block 774f. The output of the addition and normalization block 774y may may be passed to a linear layer 774r, which may transform that output into a higher-dimensional space. The output of the linear layer 774r may be fed into a softmax layer 774s, which may be a non-linear activation function that normalizes the output to a probability distribution to ensure that all values are non-negative and add up to 1. Iterating the identical layers allows the model to learn complex patterns and relationships in the data.

Various types of transformer-based LLMs may be constructed by “stacking” the identical layers of the encoder 772 and/or the decoder 774 in particular arrangements and in combination with additional refinements/components. A given LLM constructed as such may then be trained or pre trained (e.g., using the AI architecture 660 of FIG. 6, a similar AI architecture, a different AI architecture or a combination of some or all of these AI architectures) on a corpus of information and/or finetuned or instruction tuned to analyze/generate data (e.g., text, audio, and/or images).

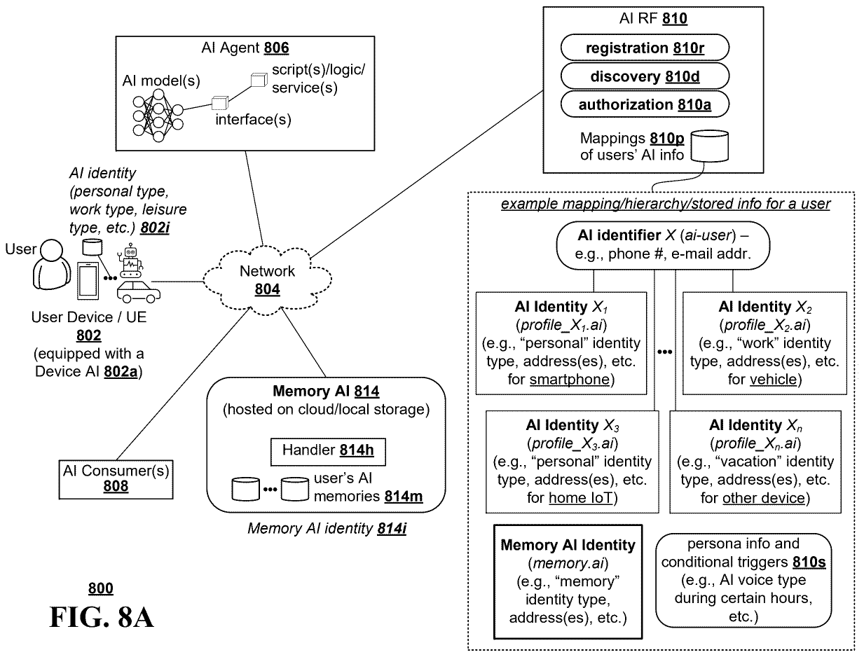

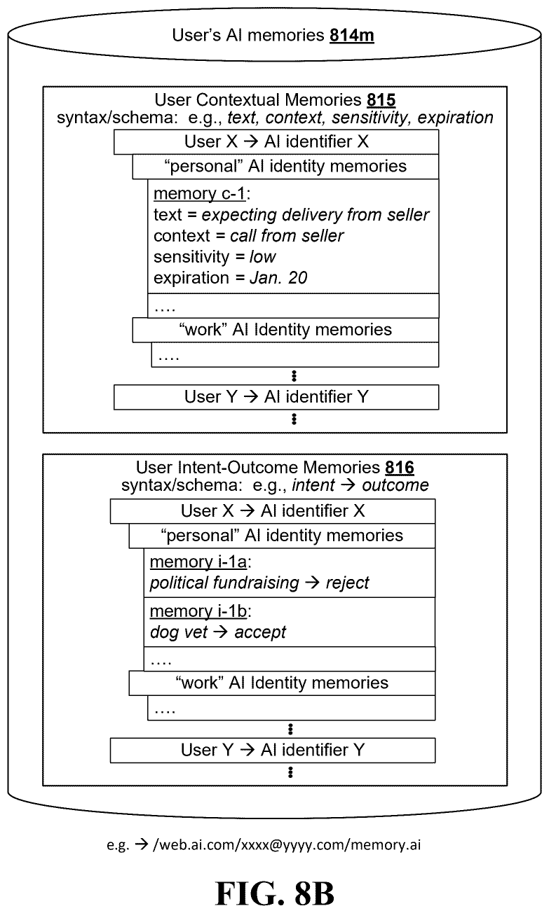

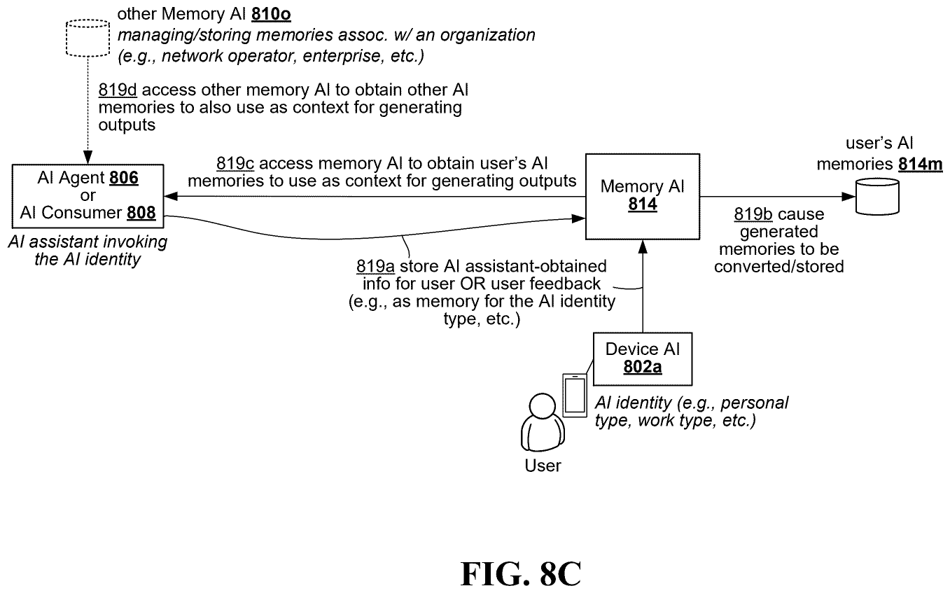

FIG. 8A is a block diagram illustrating an example, non-limiting embodiment of a network system 800 functioning within, or operatively overlaid upon, the communications network of FIG. 1, in accordance with various aspects described herein. The system 800 may include a user device 802, a network 804, an AI agent 806, an AI repository function (AI RF) 810, and a memory AI 814. One or more of the network 804, the AI RF 810, and the AI agent 806 may be included in or associated with a network operator's network/AI infrastructure, such as that, or similar to that, described above with respect to one or more of FIGS. 1, 2, and 4.

The user device 802 may include communication and/or computing devices, which may include a mobile phone (e.g., a smart phone, a radiotelephone, etc.), a desktop computer, a laptop computer, a tablet computer, a handheld computer, a display device, a gaming device, a wearable communication device (e.g., a smart wristwatch, a pair of smart eyeglasses, augmented reality (AR)-/virtual reality (VR)-/mixed reality (MR)-related gear(e.g., a pair of glasses or googles, a headset, a hat, glove(s), a mask, a jacket, a sock or shoe, a pair of pants or shorts, headphones, and/or the like), etc.), a similar type of device, or a combination of some or all of these devices. The user device 802 can be equipped with one or more transmitter (Tx) devices and/or one or more receiver (Rx) devices configured to communicate with, and utilize network resources of, the network system 800.

In various embodiments, the user device 802 may be equipped with a device AI 802a that acts as a bridge between the user and one or more of the AI agent 806, the AI RF 810, and the memory AI 814. The device AI 802a may be a user-friendly application that allows the user to configure and manage their AI use. The device AI 802a may provide an intuitive interface for interacting with and defining preferences/settings relating to an AI assistant. In certain embodiments, the device AI 802a may incorporate specialized hardware, such as an AI processor or a neural processing unit (NPU), that is designed to perform AI computations—e.g., machine learning (ML) inference, image recognition, natural language processing, or the like. The hardware may be configured to perform parallel processing, enabling the execution of complex algorithms. The device AI 802a may include software components, such as AI frameworks/libraries, that facilitate the development and execution of AI models directly on the user device 802.

The network 804 may include one or more networks. The network(s) may include one or more access networks, one or more core networks, a circuit switched network or PSTN, one or more IMS cores, and/or the like, some or all of which may be communicatively coupled to one another over wireless or wired networks.

The access network may include a wireless RAN, a Wi-Fi network, and/or a wireline network, and may include network resources, such as one or more physical access resources and/or one or more virtual access resources. Physical access resources can include access points (APs) or base station(s) (e.g., one or more eNodeBs, one or more gNodeBs, or the like), one or more satellites, one or more Gigabyte Passive Optical Networks (GPONs) or related components (e.g., Optical Line Terminal(s) (OLT), Optical Network Unit(s) (ONU), etc.), and/or the like. An AP or base station may employ any suitable radio access technology (RAT), such as 4G/LTE, 5G, 6G, or any higher generation RAT. One or more edge computing devices (e.g., multi-access edge computing (MEC) devices or the like) may also be included in or associated with the access network. Virtual access resources can include a voice service system (e.g., a hardware and/or software implementation of voice-related functions), a video service system (e.g., a hardware and/or software implementation of video-related functions, such as coder-decoder or compression-decompression (CODEC) components or the like), a security service system (e.g., a hardware and/or software implementation of security-related functions), and/or the like. In one or more embodiments, the access network may include any number/types of physical/virtual access resources and various types of heterogeneous cell configurations with various quantities of cells and/or types of cells. In certain embodiments, the access network may be implemented as a virtual RAN, where radio/wireline functions are implemented as general-purpose applications/apps that operate in virtualized environments and interact with physical resources either directly or via full/partial hardware emulation. Virtualized software radio applications can be delivered as a service and managed through a cloud controller.

The core network may include network devices and/or systems that provide a variety of functions. In certain embodiments, the core network may be implemented in a cloud architecture. Examples of functions provided by, or included, in a core network include an access mobility function (AMF) configured to facilitate mobility management in a control plane of the network system (including, for instance, providing UE mobility information associated with one or more access networks (e.g., RANs) and/or UEs to the core network), a user plane function (UPF) configured to provide access to a data network, such as a packet data network (PDN), in a user (or data) plane of the network system, a Unified Data Management (UDM) function, a Session Management Function (SMF), a policy control function (PCF), and/or the like. The core network may be in communication with one or more other networks (e.g., one or more content delivery networks (CDNs), such as the CDN/Internet), one or more services, and/or one or more other devices. In one or more embodiments, the core network may include one or more devices implementing other functions, such as a master user database server device for network access management, a PDN gateway server device for facilitating access to a PDN, and/or the like. The core network may include various physical/virtual resources, including server devices, virtual environments, databases, and so on.

The IMS core may manage voice and multimedia sessions over IP, and may communicate with the core network and the base station to facilitate calls, such as VoLTE/VoNR calls, or other IP-based services.

The AI agent 806 may include one or more control systems or scripts that interface with and utilize various AI models to provide a range of AI services. The AI agent 806 may be responsible for understanding multimodal inputs, such as speech, text, images, etc. and generating appropriate responses for the interface that is used by users. The AI agent 806 may maintain and utilize specific contexts for users, and may run protective models to identify synthetic voices and scams.

Generally speaking, the AI agent 806 may utilize a centralized AI model and core logic, and may utilize a user's preferences/settings, a user's AI memories, and other data to personalize the AI agent 802's interactions with the user or with other AI identities. This personalization may be achieved by passing some or all of the preferences/settings and/or AI memories (e.g., in the form of embeddings or vector representations) as context to the AI model to modify the behavior of the AI model.

In one or more embodiments, the AI agent 806 may be configured to perform specific tasks or provide particular services, such as answering queries or managing communications. For example, the AI agent 806 may function as a virtual assistant that schedules appointments, answers queries, and manages calls for a user, and may leverage one or more types of AI models to interact with users and/or other systems. The AI model(s) may be trained via an AI architecture (e.g., the AI architecture 660 described above with respect to FIG. 6). In certain embodiments, the AI model(s) may include one or more LLMs, one or more transformer-based models, one or more auto-regressive models, one or more of another type of generative AI model, or a combination of some or all of these models. As an example, the AI model(s) may include one or more LLMs that are based on the transformer model 770 described above with respect to FIG. 7.

While only one AI agent 806 is shown in FIG. 8A, a network operator's AI infrastructure may include numerous (e.g., distributed or distinct instances of) AI agents 806.

The AI RF 810 may be an in-network component, that is configured to facilitate AI identity registration, access to AI identity information, and overall user device management with respect to AI identities. The AI RF 810 may store mappings 810p of AI identifiers and AI identity profile data, including addressing parameters (e.g., URLs or IP addresses, such as IPv4 addresses, IPv6 addresses, etc.) for reaching or accessing the AI identities.

The memory AI 814 may be a compute node (e.g., compute storage or providing in-storage computing) that manages and stores or host users'AI memories 814m, such as in a cloud environment or locally on a user's mobile device or other computing device—e.g., a server or desktop computer. A handler 814h may manage (e.g., create, update, delete, etc.) the user AI memories therein, including facilitating external access to those memories. Various functionalities of and interactions between various of the AI RF 810, the device AI 802a, and the memory AI 814 are described in more detail below.

As briefly discussed above, a unique AI identifier may be used to identify a given user or user device. This AI identifier may be a MSISDN or phone number or a form of digital handle or unique string. As an example, the user's e-mail address may be used as the AI identifier. As another example, a username, a URL, or a unique alphanumeric code can serve as the AI identifier. In certain implementations, a user's AI identifier may be stored locally on the user device 802, and may be used for various purposes, such as for AI identity registrations/updates, user or user device authentications, user interactions with AI consumers, such as the AI agent 806, and/or the like. Token(s) may be generated from the AI identifier based on successful device-logon to the network (e.g., the AI RF 810), and may be used to facilitate communications for the user device 802 over the network.

Each of a user's devices may be associated with (or have stored therein) a respective AI identity. For instance, a user's smartphone may be associated with an AI identity, the user's home IoT management device may be associated with another AI identity, the user's vehicle may be associated with yet another AI identity, and so on. An AI identity, as defined by its type (e.g., personal, work, leisure, etc.) may, in some senses, portray itself as the user's AI assistant. In a case where the user's AI identifier is a phone number or is associated with an assigned phone number, the various AI identities of the user may be bound to that phone number. It is thus to be understood and appreciated that an AI identity is distinct or independent from a phone number. As an example use case, a home IoT management device that monitors the status of home equipment may be associated with an AI identity, and may interact with an AI identity that is associated with a particular equipment's manufacturer customer service system. In various embodiments, an organization may be associated with one or more AI identities, in which case, the AI identities may be stored in cloud environment(s) or local systems/servers of the organization. In essence, AI identities of various users, organizations, etc. may be capable of operating independently or collaboratively, and may discover and interact with one another to fulfill specific tasks for those users, organizations, etc. Notably, none of these interactions necessarily rely on a phone number, underscoring the flexibility and adaptability of AI identities in facilitating communications and functionality.

An AI identity may be applied to or assumed by the AI agent 806 to represent/service the user according to a type of the AI identity (described in more detail below). In various embodiments, an AI identity may be associated with preferences/settings, which may include or encompass one or more AI personas of the user. An AI persona may define the manner in which the AI assistant is to communicate with the user or with others. For instance, an AI persona may define a preferred communication style (e.g., formal or casual), language preferences, etc., including timing triggers for when those settings should apply (see 810s). Other preferences/settings may include preferred response times, preferred types of notifications, and/or any particular AI functionalities that the user wishes to prioritize or define.

In certain implementations, identifying information for a given AI identity may be stored locally on the user device 802 (see 802i), and may be used for various purposes, such as AI identity registrations/updates, user or user device authentications, user interactions with AI consumers, such as the AI agent 806, and/or the like.

In exemplary embodiments, the AI RF 810 may store the mappings 810p in a manner that facilitates lookups, retrievals, and/or updates of the information. In one or more embodiments, a mapping may have a hierarchical structure, where an AI domain (e.g., ai-domain) may represent a domain in the network provider's AI infrastructure, the AI identifier (e.g., ai-user) may correspond to a user, AI identities may correspond to the user's various devices, and AI profiles may define the corresponding AI identities (e.g., ai-identity[AIProfile]).

The following is an example schema of a portion of an AI profile (also referred to herein as AIProfile) for defining an AI identity. Some of the data in the AI profile may be inputted or provided by the user by way of the device AI 802a of the user device 802.

### AIProfile

type: object
required:
   InstanceId
   type
   status
   IPV4address
   IPV6address
   URL
optional:
   enterprise identifier

In this example, the AI Profile may generally be of an object type that is composed of various parameters or attributes.

The InstanceId parameter may be a unique identifier for the AI identity. Each AI identity may be associated with a (e.g., unique) ID, thus allowing for the creation of distinct AI identities for a given user.

The type parameter may serve as a broad categorization that specifies the role or function of the corresponding AI identity. For instance, a user may have multiple AI identities, each with a distinct type, such as “personal” (e.g., personal.ai) for a personal assistant, “work” (e.g., work.ai) for a professional assistant, or “memory” (e.g., memory.ai) for managing/storing the user's AI-related memories. This categorization allows the AI RF 810 to distinguish between the AI identities that should be called upon or returned when an AI identity discovery/access request is made. By defining the AI profile type, systems can effectively query and locate the appropriate AI identity based on the desired function or role.

The status attribute may indicate the operational status of the AI identity, such as active or inactive, which can allow systems, such as the AI RF 810 or AI consumers, to determine whether the AI identity is available to be used or engaged.

The AI profile may specify addressing parameters for reaching or accessing the AI identity. These addressing parameters may include an IPv4 address, an IPv6 address, and/or a URL, which may provide the necessary routing information that allows other systems or services (e.g., AI consumers) over the Internet or a private network to interact with the AI identity, such as to obtain authorization/access to information regarding the AI identity.

The Enterprise Identifier, which may be an optional component of the AI profile, may serve to associate the AI identity with a specific organization or enterprise. This association may provide additional context for the operation and management of the AI identity that aligns its use/functionality with the enterprise's specific requirements and/or policies. By linking the AI identity to an enterprise, the behavior of the AI agent 806 that assumes/invokes that AI identity can be tailored to generate outputs that meet organizational standards and objectives. For example, the AI agent 806 may, based on a given Enterprise Identifier, adhere to the corresponding enterprise's data privacy policies, by ensuring that interactions and data handling comply with internal guidelines and/or regulatory requirements. In certain embodiments, an enterprise's requirements/policies may override preferences or tendencies that are associated with the user.

It is to be understood and appreciated that the foregoing AI profile parameters are merely illustrative and can vary in number and/or type. Users may configure some parameters, while others may be set by the network operator or other systems. In various embodiments, users can use their device AI 802a to access the AI RF 810 to update or modify the AI profile of an AI identity.

The AI RF 810 may be configured to provide various functions in the form of services (e.g., which may be accessible via APIs or other access methods), including a registration service 810r that allows users or AI producers to register AI identities, a discovery service 810d that allows users or AI consumer(s) 808 to discover the AI identities of other users or of AI producers, and an authorization service 810a that facilitates the provision of authentication tokens (e.g., Open Authorization (OAuth) tokens) to AI consumer(s) 808 for use in obtaining access to user AI identities. The AI consumer(s) 808 may include external AI systems, such as, LLMs or conversational AI platforms that are designed to understand and generate text, audio, images, videos, etc. for various applications. In at least one aspect, the AI consumer(s) 808 may include one or more user devices.

In various embodiments, the AI RF 810 may (e.g., via the discovery service 810d and/or the authorization service 810a) facilitate the execution of AI identity-related service queries from the AI consumer(s) 808. Such service queries may involve, for instance, service personalization (e.g., an AI identity X1 of a subscriber X might be used to personalize the services or interactions that are provided by the AI consumer 808 for subscriber X, customize a user interface, tailor content recommendations, or adjust service settings for the subscriber X).

In one or more embodiments, the memory AI 814 may be configured to facilitate the storage of and access to user AI memories by user devices, such as the user device 802, or by other systems, such as the AI consumer(s) 808. In certain embodiments, one or more functions of the memory AI 814 may be implemented or included in the AI RF 810.

In various embodiments, the memory AI 814 may be associated with its own AI identity—i.e., a memory AI identity (see 814i) that is a special type of AI profile that manages memories. The memory AI 814 may obtain data relating to a user's interactions with the AI agent 806 (e.g., feedback on the AI agent 806's actions or decisions), user-related events (e.g., information regarding meals that the user has recently eaten, meetings that the user recently attended, etc.), and/or the like, and may convert the data into one or more AI memories 814m for the user. The AI memories 814m may be stored and accessed and retrieved, such as to serve as context for the AI agent 806 for generating personalized outputs for the user or to be transferred/ported to external host systems or AI platforms as desired. In various embodiments, the memory AI 814 may index, correlate, derive/create new memories and store original and/or inferred memories. The memory AI 814 may return selected memories to an AI consumer, which the AI consumer can use as part of inputs to an LLM to perform specific tasks (e.g., setting up a lunch appointment for the user, etc.). What is actually stored as memories by the memory AI 814 may be dictated based on predefined rules. For instance, the memory AI 814 may not store each and every item of user feedback, user-related event, etc. as a memory. Rules on what is saved or stored may be defined by the user or a system administrator, may be based on the content of memories that have already been saved, etc.

In one or more embodiments, the memory AI 814 may be configured to facilitate the execution of user AI memories-related service queries from the AI consumer(s) 808. Such service queries may involve, but are not limited to, personalized interaction (e.g., the AI consumer 808 might utilize the context/preferences stored in the form of AI memories for a user X's AI identity X1 to engage in personalized interactions with user X, such as to provide tailored advice, reminders, or information), task execution (e.g., the AI consumer 808 might utilize the context/preferences stored in the form of AI memories for user X's AI identity X1 to execute specific tasks or workflows for user X, such as to schedule appointments, send messages, or manage to-do lists), contextual decision-making (e.g., the AI consumer 808 might utilize the context/preferences stored in the form of AI memories for a user X's AI identity X1 to make context-aware decisions on behalf of user X, such as to filter emails, prioritize notifications, or manage call handling or processing), and data retrieval and analysis (e.g., the AI consumer 808 might utilize the context/preferences stored in the form of AI memories for a user X's AI identity X1 to retrieve and analyze specific data or insights that are relevant to user X, such as to provide summaries of content, provide reports, or provide recommendations or suggestions).

FIG. 8B illustrates example user AI memories. FIG. 8C illustrates an example implementation of the memory AI 814 in which user feedback, user-related events, user-and-AI-related interactions, etc. can be stored as memories and retrieved by an AI agent, such as to use as context in queries/commands to an AI model.

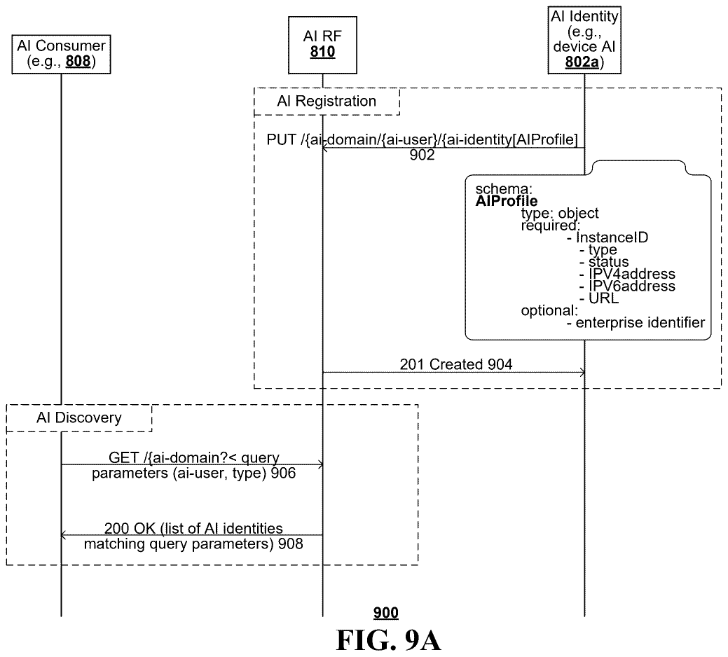

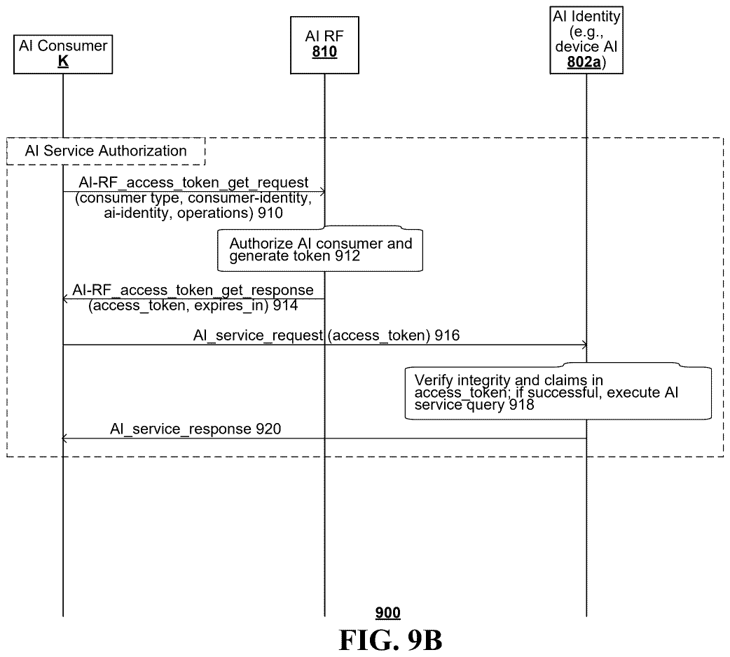

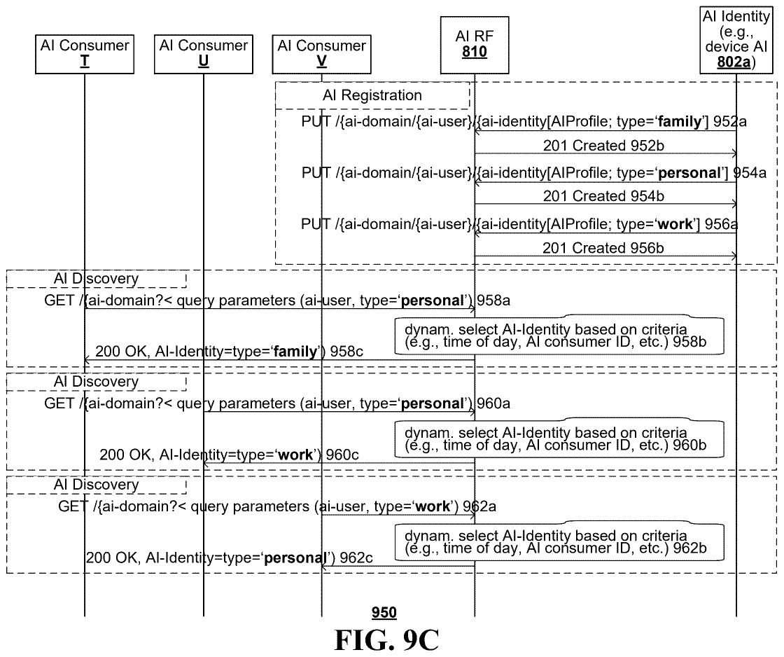

Referring to FIG. 8B, the AI memories 814m may include users'contextual memories 815 and/or users'intent-outcome memories 816. The intent-outcome memories 816 may be dynamically generated/updated. The memory AI 814 may (e.g., via the handler 814h) manage the storing of and access to the various AI memories 814m based on particular AI identity types. For instance, the memory AI 814 may store AI memories 814m relating to a user's personal.ai or personal AI identity separately from AI memories 814m relating to the user's other types of AI identities, and may allow access to the AI memories 814m relating to the user's personal.ai or personal AI identity (e.g., only) to an AI agent 806 or AI consumer 808 that assumes or invokes one of the user's personal AI identities. As another example, the memory AI 814 may store AI memories 814m relating to a user's work.ai or work AI identity separately from AI memories 814m relating to the user's other types of AI identities, and may allow access to the AI memories 814m relating to the user's work.ai or work AI identity (e.g., only) to an AI agent 806 or AI consumer 808 that assumes or invokes one of the user's work type AI identities. In certain embodiments, the memory AI 814 may be linked to a primary AI user (e.g., as shown in the PUT command in step 902 of FIG. 9A), allowing certain AI identities of the user or external AI identities to read and write memories. These memories may be indexed within the memory AI 814's internal storage to facilitate efficient retrieval and management. The memory AI 814 may be an AI identity that manages and organizes users'memories, by indexing and correlating these memories to answer questions such as “What is this person's favorite color?” or “Where do they like to travel?” This information may be inferred based on past actions and records stored by various AI agents for various AI identities. For example, booking a vacation to Paris multiple times might indicate that Paris is the user's favorite vacation destination. This inferred result can be shared with other AI consumers to facilitate collaborative tasks. For instance, if User X wants to plan a day trip with User Y, User X's AI may query User Y's memory AI (or User Y's personal AI may query User Y's memory AI) to determine a suitable destination for the trip. Based on the stored memories, the AI might recommend Paris as a destination or, alternatively, suggest a hiking trip if the user had already recently visited Paris. This capability allows the memory AI 814 to facilitate the generating of context-aware and personalized recommendations that enhance user experiences. It is to be understood and appreciated that, by way of the memory AI 814 being an independent AI identity, user memories, such as memories relating to favorite colors, favorite places, favorite cuisines, past dining experiences (e.g., which restaurant the user visited, when, and with whom), and so on, including any other general preferences, may be stored independently of specific AI identities. These memories may be utilized by various AI identities for different tasks, such as scheduling lunch or dinner appointments based on user preferences (e.g., avoiding the same restaurant or cuisine two days in a row). To aid a given AI identity in providing assistance to a user, the memory AI 814 (and/or an AI agent) may utilize or correlate multiple memories to facilitate the generating of recommendations (such as in the vacation booking/restaurant reservation examples above). In various embodiments, the memory AI 814 may (e.g., in conjunction with the AI RF 810) determine whether/when access to these independent memories is allowed and who (e.g., which AI identity of the user, which AI identity of a given AI consumer, which AI consumer, etc.) is permitted to read or write specific types of memories, such as those related to food preferences, etc., which can ensure secure and context-aware memory management. In some embodiments, a user's work-related memories may be stored in a separate instance of the memory AI 814 that is hosted by an organization, such as a workplace or corporation. For example, a user's work AI identity (e.g., associated with their work phone) may store work-related memories in the organization's memory AI 814. In this scenario, multiple employees may store their work-related memories in the organization's memory AI 814, enabling collaborative use of shared information. The organization may implement access controls to manage how these memories are shared. For instance, the organization may allow an employee's work AI identity to access a subset of work-related memories belonging to other employees (e.g., employees B, C, and D) while restricting access to certain types of memories or sensitive information. This approach enables the organization to facilitate collaboration and information sharing while maintaining security and privacy for specific types of data within the organizational memory AI 814.

In one or more embodiments, the contextual memories 815 and intent-outcome memories 816 may be derived or obtained based on user feedback, such as the user's responses or commands that are provided via the device AI of the user device responsive to outputs that are generated by an AI agent (e.g., the AI agent 806). For instance, the memory AI 814 may receive user feedback relating to a user's use of/interaction with an AI agent or AI consumer, may cause one or more contextual memories 815 and/or one or more intent-outcome memories 816 to be derived or obtained based on the user feedback (e.g., by utilizing one or more LLMs or other AI models) or based on AI assistant-obtained information for the user, and may cause the generated memories to be converted/stored as the AI memories 814m. See, e.g., reference numbers 819a and 819b in FIG. 8C. In some embodiments, the user feedback or AI assistant-obtained information may be processed by LLM(s) to convert it into a structured format. The LLM(s) can analyze the feedback type or information type, whether it is textual, audio, or another format, and transform it into a particular syntax. For example, if a user provides feedback such as “I prefer a more formal tone,” the LLM(s) might categorize this as “tone preference: formal.” Similarly, if the feedback is “I didn't find the response helpful,” then the LLM may interpret this as “feedback type: dissatisfaction, context: response usefulness.”

Consider the case of a customer service interaction, where an AI agent might suggest potential solutions to a problem and then prompt the user for feedback on which solution the user prefers, any preferred timing information relating to the interaction, etc. The user's feedback can be used to generate a contextual memory 815 that records the user's selection(s). This contextual memory 815 can then be later retrieved to tailor future interactions for the user. See, e.g., reference number 819c of FIG. 8C.

In exemplary embodiments, the contextual memories 815 may be organized using standardized metadata within a memory schema. For instance, the memory schema may include elements such as text, context, sensitivity, and/or expiration. As an example, a contextual memory 815 may be structured as follows: text/type=“I'm expecting a delivery from a seller,” context=“call from the seller,” sensitivity (e.g., for call screening purposes)=“low,” expiration=“Jan 20.” Sensitivity/expiration settings may be explicitly provided by the user or inferred based on user history.

In the context of a call screening session, for instance, an AI agent might engage with an inbound caller for a user while providing a live transcript of the conversation for display on the user's device. During or after the call, the AI agent may inform the user on a determined intent of the caller—e.g., a political fundraising call, and may prompt the user for instructions on how to handle the call, such as to reject the call, connect the call to the user device, etc. The user's feedback can be used to generate an intent-outcome memory 816 that records the user's instructions. This intent-outcome memory 816 can then be later retrieved to guide future call screenings for the user. See, e.g., reference number 819c of FIG. 8C.

In exemplary embodiments, the intent-outcome memories 816 may be organized using a standardized syntax. For instance, the memory schema may include elements such as intent and outcome. As an example, an intent-outcome memory 816 might be structured as follows: intent=“Political fundraising,” outcome=“reject.”

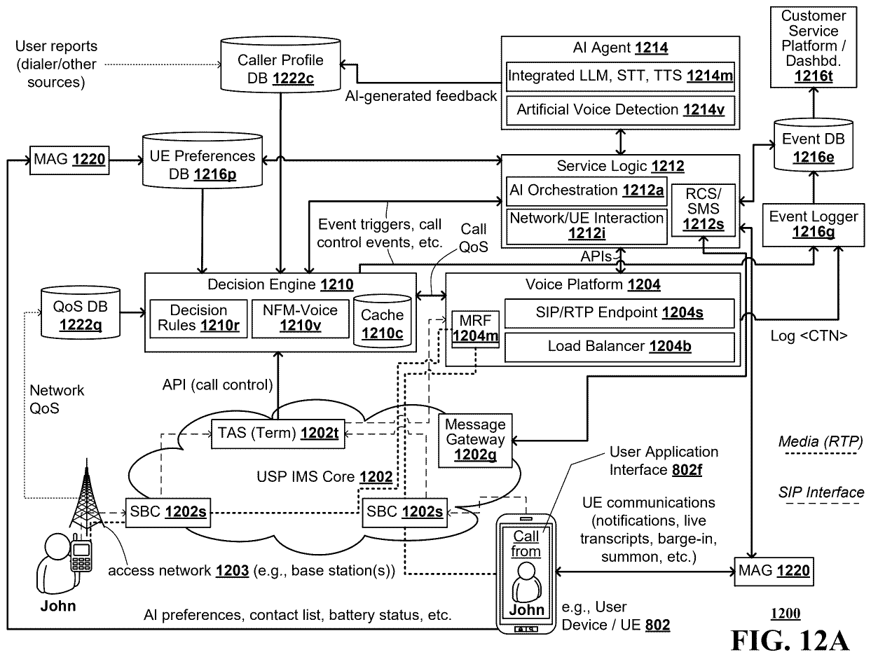

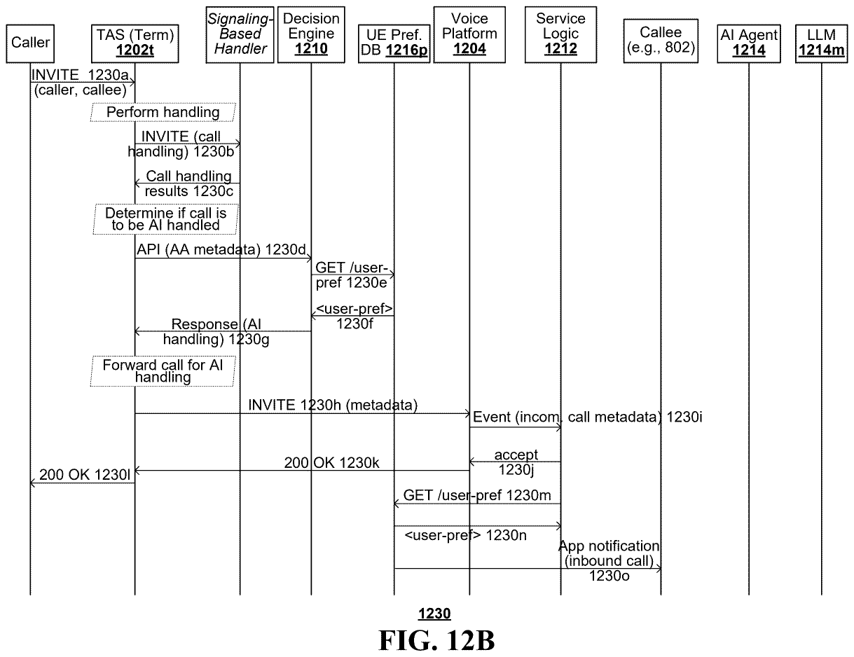

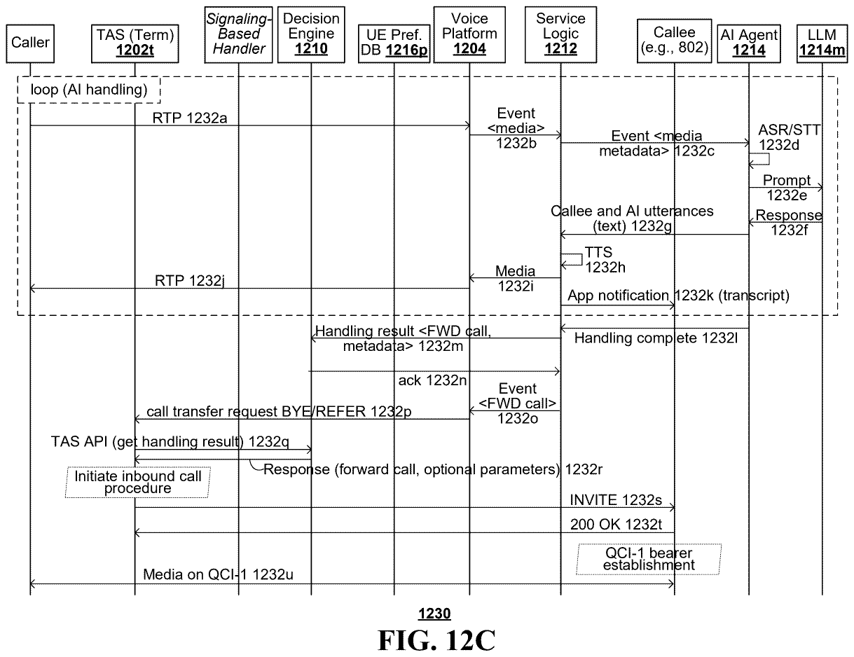

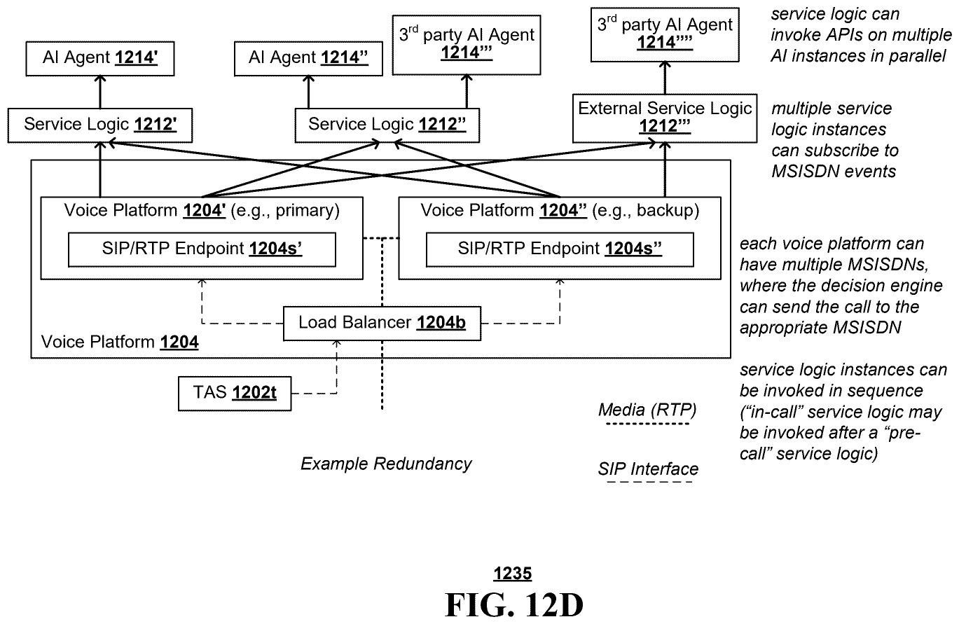

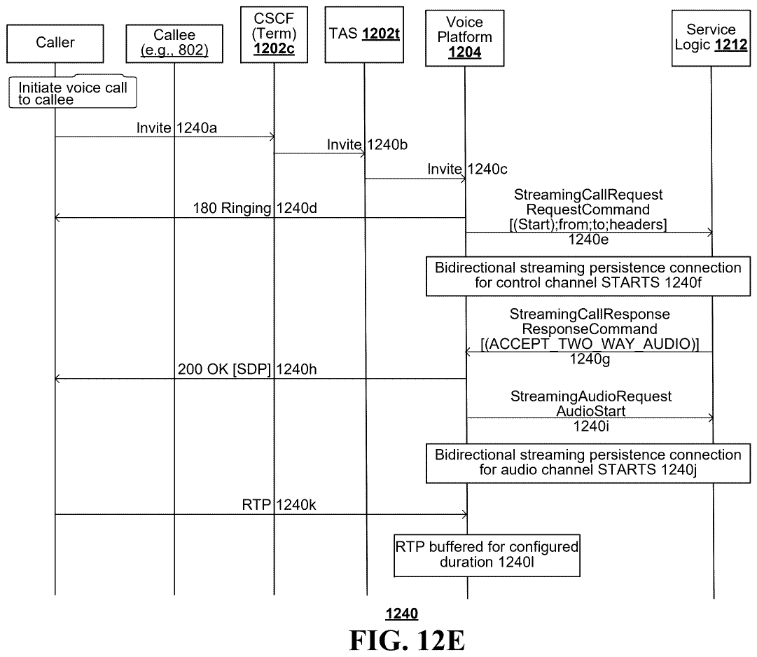

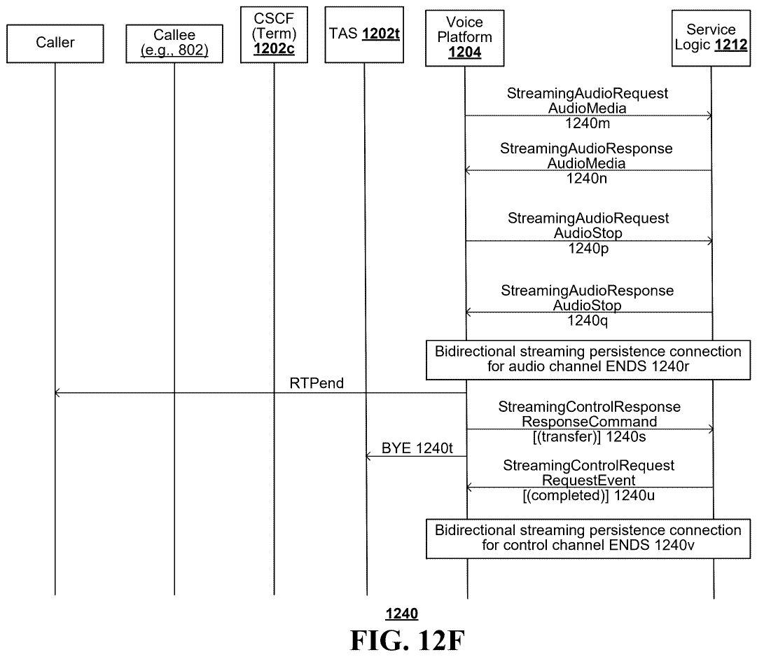

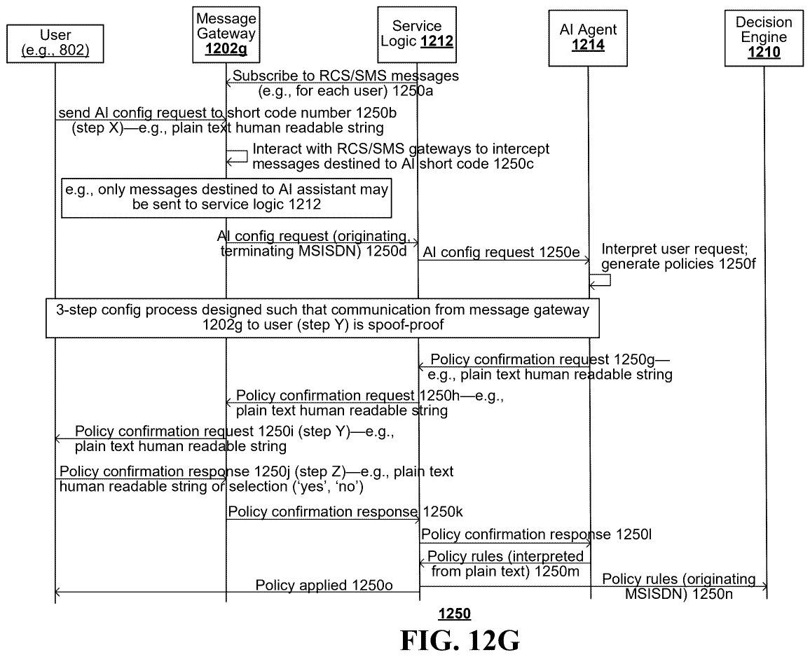

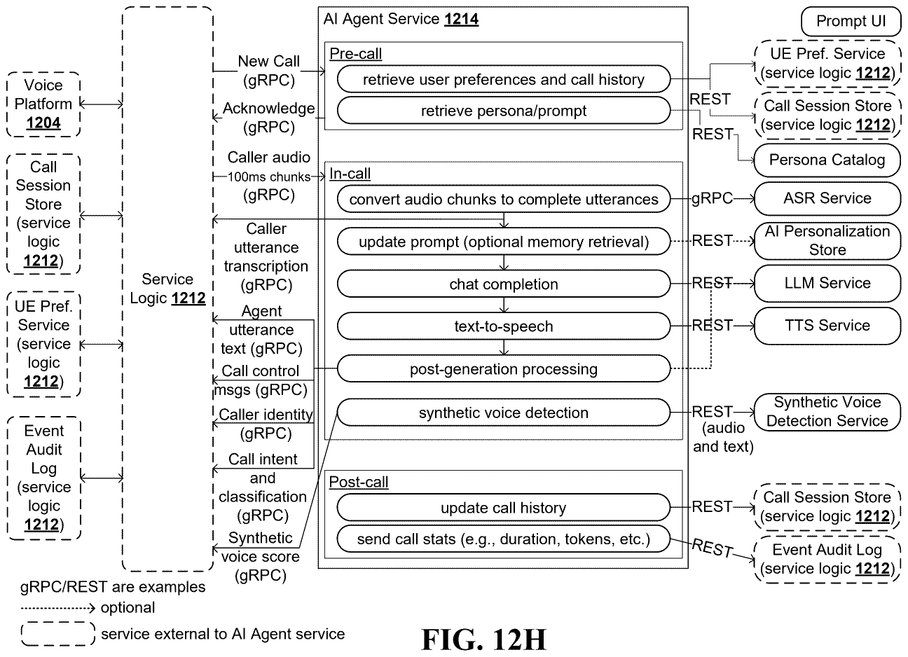

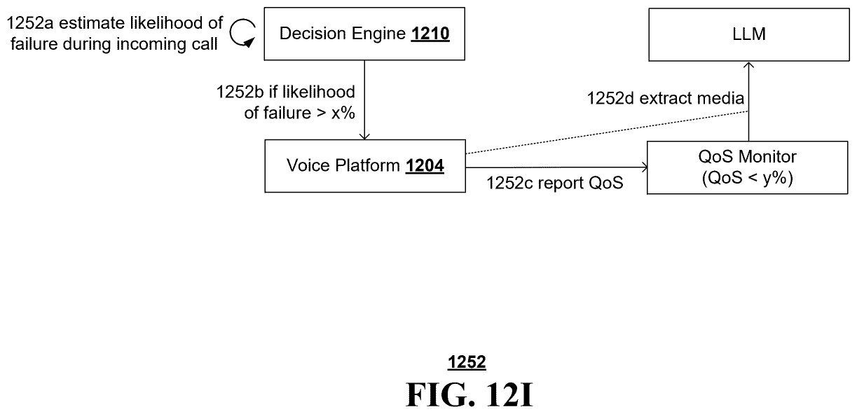

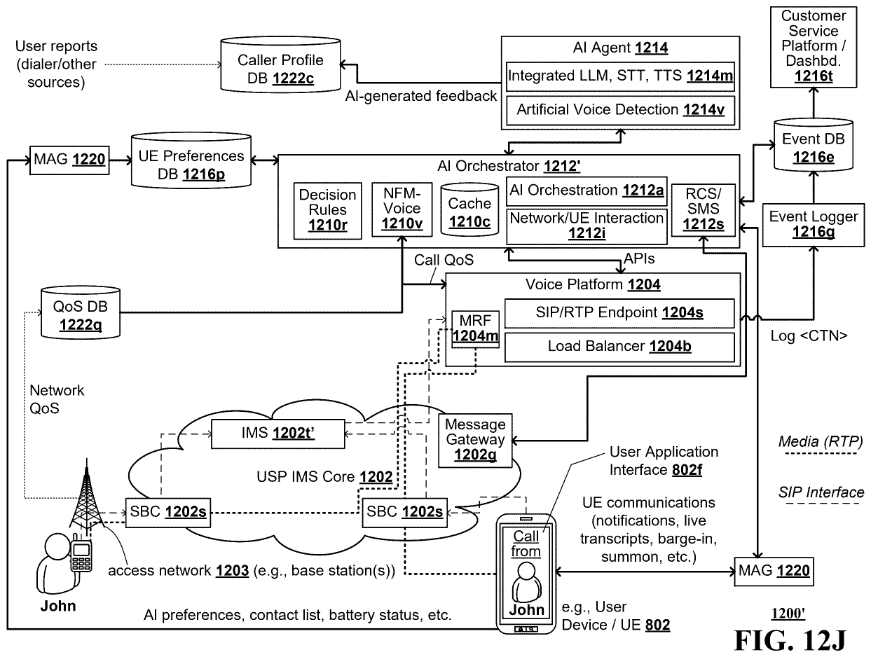

In certain embodiments, intent-outcome memories 816 may be presented to one or more functional components of a telecommunications network that has an embedded AI to facilitate call routing/handling. For instance, intent-outcome memories 816 may be provided to one or more systems/components of the high level architecture 1200 of FIG. 12A (described in more detail below), which such systems/components may utilize to make various determinations, such as whether to screen a caller, whether to route a call directly to the user (rather than performing AI screening thereof), etc.

In one or more embodiments, the contextual memories 815 and/or the intent-outcome memories 816 may be stored in any suitable format. For example, some or all of the contextual memories 815 and/or the intent-outcome memories 816 may be stored in a JavaScript Object Notation (JSON) format or the like to facilitate integration with or use by various systems.

In certain alternative embodiments, the contextual memories 815 and/or the intent-outcome memories 816 may be, or may include, vector embeddings. In these embodiments, a vector embedding service or an AI agent, such as the AI agent 806, may convert determined text-based memories into vector embeddings—e.g., using one or more embedding components similar to those described above with respect to FIG. 7. Storing AI memories in the form of vector embeddings can render the memories machine independent and thus less susceptible to misinterpretation, which could be particularly important if the memories are to be transferred or ported from one AI service provider to another.

In some embodiments, settings or preferences specific to an organization, such as a network operator or enterprise, may be stored as memories similar to that described above. For instance, these memories may be stored in a memory AI 810o, and can be accessed and utilized as context in queries or commands by AI agents/consumers. In this way, the AI agents/consumers can tailor responses based not only on particular user context(s) but also organizational contexts or policies. As an example, consider a scenario where a user's preference for an AI agent/consumer to provide periodic real-time video updates during a call is stored in the memory AI 814 as a user AI memory 814m, but where an organization's (e.g., a network operator's) policy that real-time video updates provided during a call be of limited durations is stored in the memory AI 810o. In such a case, the AI agent/consumer can generate a query or command to an AI model that includes or integrates both the user and the organization's memories—e.g., to provide real-time video updates, but to limit each such update to the organization's desired duration. See, e.g., reference number 819d of FIG. 8C. In various embodiments, the organization's memories may be associated (e.g., in a mapping 810p in the AI RF 810) with an identifier, such as the enterprise identifier described above, and can also be included or referenced in an AI profile of an AI identity of the user. In these embodiments, the memory AI 814 may access, retrieve, and utilize the organization's memories based on a recognition of the enterprise identifier in the AI profile of the AI identity.

In one or more embodiments, some or all of the functionality of the memory AI 814 (and/or other AI service functionalities described herein, such as those relating to the AI RF 810 or network-hosted AI assistant(s)) may be implemented in a policy AI agent. In certain embodiments, the policy AI agent may have exclusive/sole access to user AI memories and may be configured to derive or obtain such memories based on user feedback. Each AI agent or AI consumer that seeks to update/use a user's AI memories may be required to coordinate with the policy AI agent to effect memory updates/retrievals. Having such a policy AI agent handle user AI memory generation and usage allows for more consistent or standardized AI responses from AI agents or AI consumers.

In various embodiments, the policy AI agent may be implemented in a network operator's infrastructure, such as in one or more of a UDM component, a User Data Repository (UDR), a PCF, or an Unstructured Data Storage Function (UDSF). Implementing or integrating the policy AI agent in the USDF in particular allows user AI memories to be indexable by phone number for ease of access and management. Such integration might involve the use of an API that exposes the Network Exposure Function (NEF) to facilitate access to the USDF. In some embodiments, the policy AI agent may be configured to differentiate between public and private AI interactions, such as distinguishing between public AI services and private user-specific LLMs, and can function as a mechanism in the network architecture that controls transfers of user AI-related data between public and private AI systems/models.

FIGS. 9A and 9B show an example call flow 900 for registering an AI identity with the AI RF 810 and invoking of the registered AI identity by AI consumers.

Referring to FIG. 9A, at 902, the device AI 802a may submit a registration request to the AI RF 810 with information regarding an AI identity to be registered in the AI RF 810. The AI identity may be associated with the user device 802 and may be defined by an AI profile that is stored in a secure memory in the user device 802.

In one or more embodiments, the AI RF 810 may store the submitted information in a data structure (see, e.g., the mappings 810p of FIG. 8A). The data structure may include one or more databases, arrays, linked lists, tables, trees, and/or the like. The mapping may include an AI identifier (e.g., phone number, e-mail address, handle, etc.) that is associated with the user, and the submitted AI profile information for the AI identity. Although not shown, information regarding multiple AI profiles corresponding to multiple AI identities may be submitted to the AI RF 810 for registration. These may be submitted over time or simultaneously, substantially simultaneously, or sequentially.

At 904, the AI RF 810 may respond to the submission with a registration success message.

At 906, an AI consumer (e.g., the AI consumer 808) may submit a query to the AI RF 810 for the user's registered AI identities. The AI consumer may be an external AI system that seeks to interact with the user's AI identity, such as to schedule a meeting with the user. In some scenarios, the AI consumer may be a network-hosted AI agent, such as the AI agent 806 or the like, that is to perform AI services for the user and that thus needs to “invoke” the appropriate AI identity.

In one or more embodiments, the AI RF 810 may, based on the received query, access the data structure and retrieve a list of AI identities that are associated with the user. At 908, the AI RF 810 may respond to the query with the retrieved list of AI identities.

Referring to FIG. 9B, at 910, an AI consumer K, which may be the same AI consumer (e.g., the AI consumer 808) or another AI consumer, may send an access request to the AI RF 810 for a particular AI identity of the user.

At 912, the AI RF 810 may authorize the AI consumer K, and may generate an access token therefor that the AI consumer K can utilize for authentication with the device AI 802a. In some embodiments, the AI RF 810 may authorize the AI consumer K by triggering the user's device AI 802a to prompt the user for confirmation (e.g., via the user interface of the device AI 802a) that the AI consumer K is permitted to access the user's AI identity.

At 914, the AI RF 810 may respond to the AI consumer K with the access token. For instance, continuing the prior example, in a case where the user confirms that the AI consumer K is permitted to access the user's AI identity, the AI RF 810 may generate an access token that can be used by the AI consumer K to access the AI identity, and may provide the access token to the AI consumer K. The AI RF 810 and the device AI 802a may utilize any suitable form of token verification, such as, for example, shared secret keys (for decrypting and verifying the token's contents), public key cryptography (where the AI RF 810 uses a private key to sign the token, and the device AI 802a may use a corresponding public key to verify the signature), and/or the like.

At 916, the AI consumer K may send a service request, that includes the access token, to the device AI 802a.

At 918, the device AI 802a may verify the integrity and claims in the access token.

In a case where the verification is successful, the service request may be facilitated (920). For instance, in a case where the AI consumer K is an AI agent for the user, the AI consumer K may then invoke the AI identity to provide AI-based assistance for the user. As another example, in a case where the AI consumer K is a 3^{rd} party AI identity of a different user who wishes to schedule a lunch date with the user, the AI consumer K may engage in communications using the AI identity, such as to select a restaurant, select food items, set a time, etc. based on calendar data, user memories, or other information associated with the AI identity.

In this way, the AI RF 810 may function as a central repository that stores and manages AI identity information, enabling other network components or AI consumers to query for and obtain access data for reaching AI identities, which may be stored in the user device 802 (or in a cloud environment, such as in the case of an organization that may be associated with multiple AI identities).

In exemplary embodiments, the AI RF 810 may be configured to dynamically select an AI identity when requested by AI consumers during AI identity discovery. While an AI consumer may request a specific type of AI identity of a user, such as the user's personal AI identity, the AI RF 810 may choose the AI identity to return to the AI consumer based on one or more criteria. The criteria may be configured by the user (e.g., based on user preferences) or determined by the AI RF 810 based on default rules.

In one or more embodiments, the criteria for selecting an AI identity may involve the time of day. For instance, during weekends, the AI RF 810 may select a family AI identity of the user rather than a work AI identity of the user. As another example, during typical working hours (e.g., 9 AM to 5 PM), the AI RF 810 may opt for a work AI identity of the user rather than a requested personal AI identity of the user. In some embodiments, the criteria may additionally, or alternatively, involve the AI identity or type of AI identity of the AI consumer itself. As an example, if the AI consumer is known by the AI RF 810 to be associated with a family-oriented social media platform, the AI RF 810 may select a family AI identity of the user rather than a requested work AI identity of the user. In various embodiments, the criteria may additionally, or alternatively, involve the history of the AI consumer. For example, if the AI consumer has a negative history with work-related interactions (e.g., previous incidents where the AI consumer mishandled work-related data, which historical data indicates that the AI consumer has been flagged for inappropriate access), the AI RF 810 may restrict the AI consumer from accessing a work AI identity of the user and may allow the AI consumer to access only a personal AI identity of the user.

FIG. 9C shows an example call flow 950 for dynamic AI identity selection. The call flow 950 may involve the AI RF 810, the device AI 802a, and AI consumers T/U/V.

At 952a, the device AI 802a may submit a registration request to the AI RF 810 with information regarding an AI identity of a first type—e.g., here, a family type—to be registered in the AI RF 810. As described above, a given AI identity type may be associated with certain AI memories of the user. Here, the user's family AI identity may, for instance, be associated with the user's AI memories relating to the user's significant other, children, or other family members. The AI RF 810 may, based on the registration request, register the family AI identity for the user, and may, at 952b, respond to the submission with a registration success message.

At 954a, the device AI 802a may submit another registration request to the AI RF 810 with information regarding an AI identity of a second type—e.g., here, a personal type—to be registered in the AI RF 810. Here, the user's personal AI identity may, for instance, be associated with the user's AI memories relating to the user's hobbies. The AI RF 810 may, based on the registration request, register the personal AI identity for the user, and may, at 954b, respond to the submission with a registration success message.

At 956a, the device AI 802a may submit another registration request to the AI RF 810 with information regarding an AI identity of a third type—e.g., here, a work type—to be registered in the AI RF 810. here, the user's work AI identity may, for instance, be associated with the user's AI memories relating to work tasks or projects. The AI RF 810 may, based on the registration request, register the work AI identity for the user, and may, at 956b, respond to the submission with a registration success message.

The registration requests and registration actions may be similar to those described above with respect to FIG. 9A. While three AI identity types are used in this example, it is to be understood and appreciated that two or more (e.g., four, five, etc.) AI identity types may be created and registered for a user.

At 958a, the AI consumer T may submit a query to the AI RF 810 for the user's registered personal AI identity. The AI consumer T may submit the query based on a request from the user (e.g., the device AI) to interact with or utilize the AI-related functionalities of the AI consumer T. At 958b, the AI RF 810 may, based on the query, perform dynamic selection of an AI identity of the user based on one or more criteria, such as time of day, AI consumer data, and/or the like. Here, the AI RF 810 may determine to select the family AI identity of the user (rather than the requested personal AI identity of the user), and may, at 958c, provide information regarding the family AI identity of the user to the AI consumer T.

At 960c, the AI consumer U may submit a query to the AI RF 810 for the user's registered personal AI identity. The AI consumer U may submit the query based on a request from the user (e.g., the device AI) to interact or utilize the AI-related functionalities of the AI consumer U. At 960b, the AI RF 810 may, based on the query, perform dynamic selection of an AI identity of the user based on one or more criteria, such as time of day, AI consumer data, and/or the like. Here, the AI RF 810 may determine to select the work AI identity of the user (rather than the requested personal AI identity of the user), and may, at 960c, provide information regarding the work AI identity of the user to the AI consumer U.

At 962c, the AI consumer V may submit a query to the AI RF 810 for the user's registered work AI identity. The AI consumer V may submit the query based on a request from the user (e.g., the device AI 802a) to interact or utilize the AI-related functionalities of the AI consumer V. At 962b, the AI RF 810 may, based on the query, perform dynamic selection of an AI identity of the user based on one or more criteria, such as time of day, AI consumer data, and/or the like. Here, the AI RF 810 may determine to select the personal AI identity of the user (rather than the requested work AI identity of the user), and may, at 962c, provide information regarding the personal AI identity of the user to the AI consumer V.

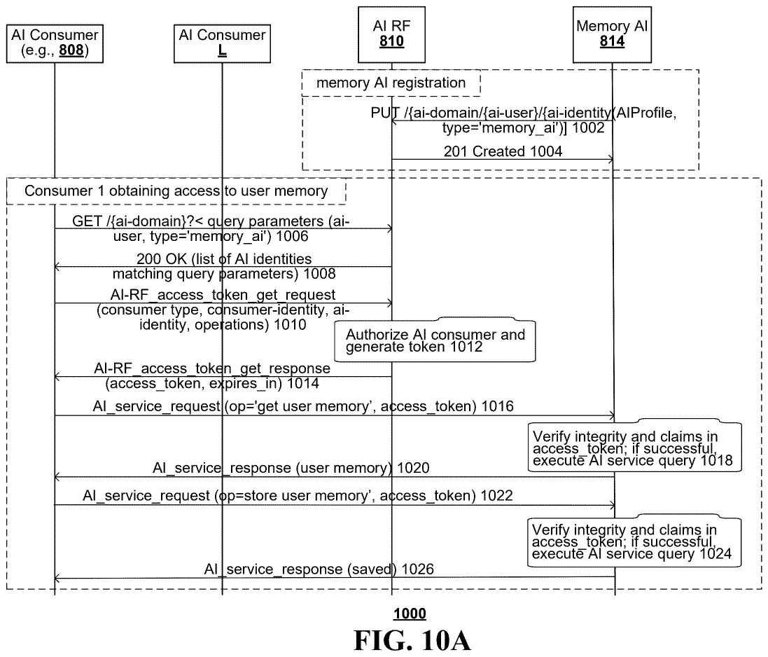

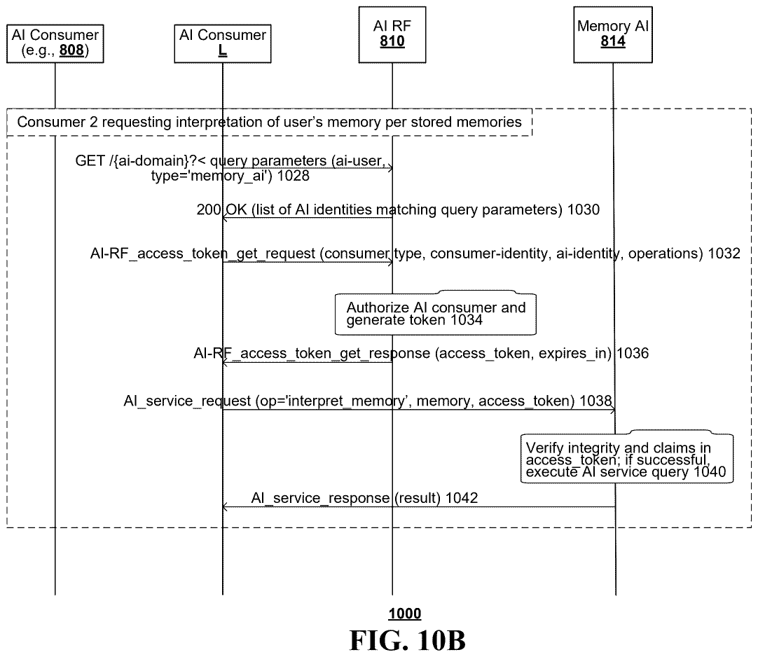

FIGS. 10A and 10B show an example call flow 1000 for registering a memory AI identity with the AI RF 810 and accessing of user memories associated therewith.

At 1002, the memory AI 814 may submit a request to the AI RF 810 to register a memory AI identity. In one or more embodiments, the memory AI 814 may be a compute node or storage system that the user has selected to store the user's AI memories, and may be associated with the memory AI identity. It is to be noted that different memory AI identities may be created for managing/storing memories associated with different types of the user's AI identities. For instance, a first memory AI identity associated with a cloud storage system may be selected by the user to store the user's AI memories relating to the user's personal AI identity(ies), and a second memory AI identity associated with a local device storage system may be selected by the user to store the user's AI memories relating to the user's work AI identity(ies).

In one or more embodiments, the AI RF 810 may, based on the submitted AI profile data for the memory AI identity, store the AI profile data in the appropriate data structure—e.g., by including, in a mapping 810p of the user's registered AI identities, a reference to the memory AI identity.

At 1004, the AI RF 810 may respond to the submission with a registration success message.

At 1006, an AI consumer (e.g., the AI consumer 808) may submit a query to the AI RF 810 for the user's registered memory AI identities. The query may include the user's AI identifier and the memory type of AI identity.

In one or more embodiments, the AI RF 810 may, based on the received query, retrieve a list of memory AI identities that are associated with the user. At 1008, the AI RF 810 may respond to the AI consumer with the retrieved list of memory AI identities.

At 1010, the AI consumer may send an access request to the AI RF 810 for a particular memory AI identity in the list. Assume that the particular memory AI identity is the one that corresponds to the memory AI 814.

At 1012, the AI RF 810 may authorize the AI consumer, and may generate an access token therefor that the AI consumer can utilize for authentication with the memory AI 814. In some embodiments, the AI RF 810 may authorize the AI consumer by triggering the user's device AI 802a to prompt the user for confirmation (e.g., via the user interface of the device AI 802a) that the AI consumer is permitted to access the user's AI memories.

At 1014, the AI RF 810 may respond to the AI consumer with the access token. For instance, continuing the prior example, in a case where the user confirms that the AI consumer is permitted to access the user's AI memories, the AI RF 810 may generate an access token that can be used by the AI consumer to access the memory AI 814, and may provide the access token to the AI consumer. The AI RF 810 and the memory AI 814 may utilize any suitable form of token verification, such as, for example, shared secret keys (for decrypting and verifying the token's contents), public key cryptography (where the AI RF 810 uses a private key to sign the token, and the memory AI 814 uses a corresponding public key to verify the signature), and/or the like. In certain embodiments, a unique public/private key pair may be used for each AI identity (or AI consumer), ensuring that access tokens are specific to individual AIs and enhancing security by preventing shared key usage across multiple AIs.

At 1016, the AI consumer may send a service request, that includes the access token, to the memory AI 814.

At 1018, the memory AI 814 may verify the integrity and claims in the access token. In a case where the verification is successful, the service request may be facilitated. For instance, the memory AI 814 may retrieve one or more (e.g., some or all of the) AI memories that are associated with the requested memory AI identity.

At 1020, the memory AI 814 may respond to the AI consumer with the one or more AI memories.

At 1022, the AI consumer may send a service request, that includes the access token as well as a (e.g., new) memory item that the AI consumer has derived or obtained for the user, to the memory AI 814 for storage. The service request may identify the particular memory AI identity that the memory item is to be associated with.

At 1024, the memory AI 814 may verify the integrity and claims in the access token, and if verification is successful (e.g., which again may involve user confirmation), may execute the service request—e.g., by storing the memory item and associating it with the corresponding AI identity type (e.g., personal AI identity, work AI identity, etc.).

At 1026, the memory AI server 814 may respond to the AI consumer with a storage success message.

Referring to FIG. 10B, at 1028, an AI consumer L, which may be the same AI consumer (e.g., the AI consumer 808) or another AI consumer, may submit a query to the AI RF 810 for the user's memory AI identities. The query may include the user's AI identifier and the memory type of AI identity.

In one or more embodiments, the AI RF 810 may, based on the received query, retrieve a list of memory AI identities that are associated with the user.

At 1030, the AI RF 810 may respond to the AI consumer L with the retrieved list of memory AI identities.

At 1032, the AI consumer L may send an access request to the AI RF 810 for a particular memory AI identity in the list. Assume that the particular memory AI identity is the one that corresponds to the memory AI 814.

At 1034, the AI RF 810 may authorize the AI consumer L, and may generate an access token therefor that the AI consumer can utilize for authentication with the memory AI 814.

At 1036, the AI RF 810 may respond to the AI consumer L with the access token.

At 1038, the AI consumer L may send a service request to the memory AI 814 that includes the access token and a request to interpret the AI memories.

At 1040, the memory AI 814 may verify the integrity and claims in the access token, and if verification is successful, may execute the service request. For instance, the memory AI 814 may interpret one or more of (e.g., some or all of) the AI memories. As an example, the memory AI 814 may utilize an LLM, such as that associated with the AI agent 806, to analyze the one or more memories, which may include information regarding the user's past AI-related interactions and preferences, to derive an interpretation that can be utilized by an external AI system to enhance response generation. For instance, if the user's memories include frequent requests for Italian cuisine and a preference for evening dining, the interpretation might be that the user enjoys Italian dinners. This interpretation may be provided to the AI consumer L, which can use it to tailor its recommendations or responses for the user.

At 1042, the memory AI 814 may respond to the AI consumer with the interpretation(s) of the one or more AI memories.

In this way, the AI RF 810 may function as a central repository that facilitates access to a user's memory AI identity(ies), enabling other network components or AI consumers to query for and obtain access data for reaching/accessing users'memory AI identity(ies) or AI-related memories wherever they may be managed or stored.

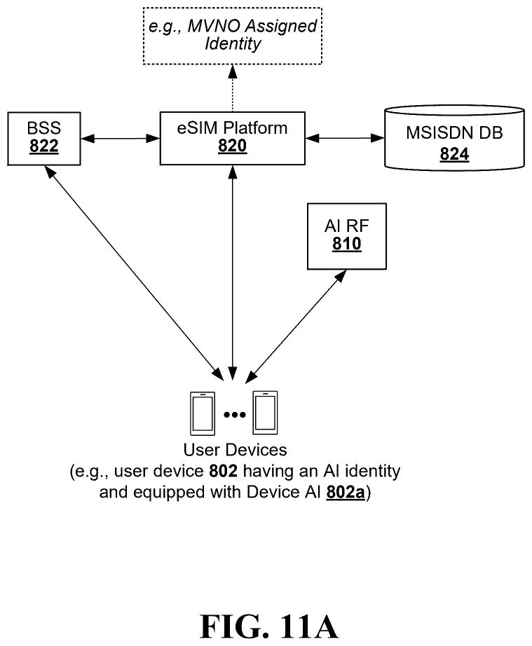

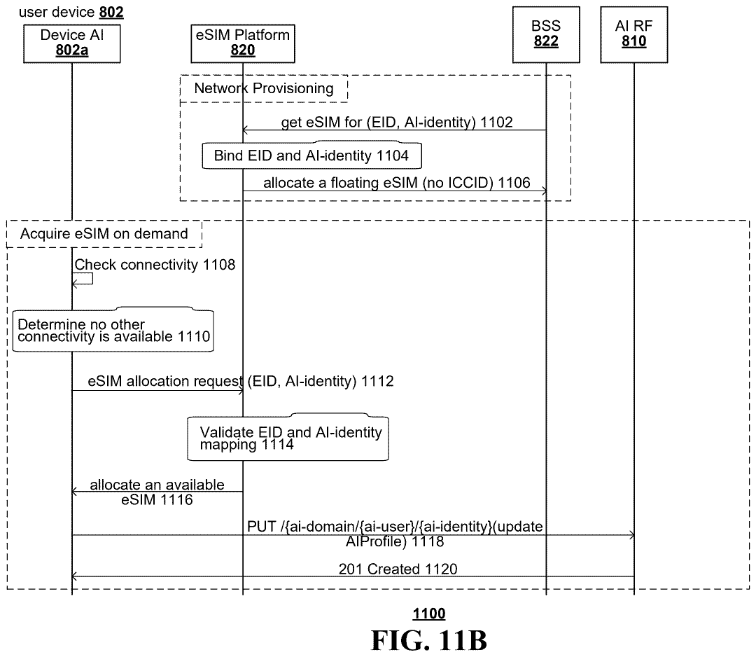

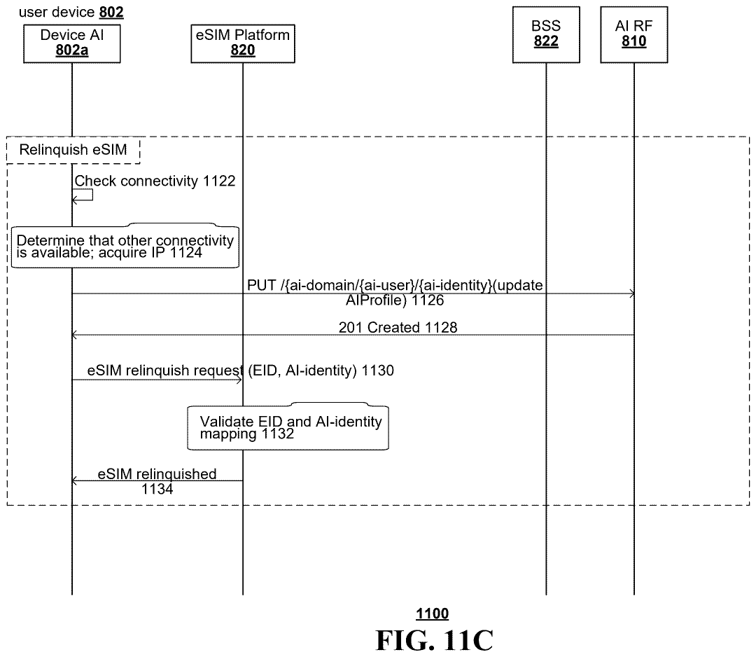

FIG. 11A is a high-level block diagram of an example system architecture for facilitating eSIM rotations in which temporary phone numbers can be assigned to user devices as needed.

In various embodiments, network provisioning and eSIM allocation/relinquishment procedures may involve a device AI, such as the device AI 802a of the user device 802, the AI RF 810, an eSIM platform 820, and a base station subsystem (BSS) 822 or the like. The process may result in a temporary MSISIDN/IMSI being allocated to a user device that can be used to route calls or messages for the device. The phone number that is associated with a given AI identity can thus change frequently, as the device AI requests, utilizes, and discards temporary phone numbers depending on connectivity needs. The underlying complexities of the provisioning and allocation/relinquishment procedures are advantageously abstracted away from the user, as calls/data communications for the user device can be addressed/routed using the AI identity that is associated with the user device. The provisioning and allocation/relinquishment procedures also enable the user device 802 to dynamically switch between carriers, networks, and/or access technologies to maintain connectivity, including switching backhauls or even connecting to satellite networks.

The eSIM platform 820 may be configured to manage the allocation and management of eSIMs within the network. The eSIM platform 820 may have access to a MSISDN database 824 that stores reusable MSISDNs. The eSIM platform 820 may be included in the network 804, and may be communicatively coupled to the BSS 822.

The BSS 822 may be configured to manage radio communications and facilitate the connection of devices to the network. For example, the BSS 822 may be part of an access network included in the network 804 of FIG. 8A and/or may be included in the access network 1203 of FIG. 12A (described in more detail below).

In certain embodiments, a mobile virtual network operator (MVNO) may be established or may operate as a third party that seeks to leverage the infrastructure of a larger network operator to serve its own subscribers. The MVNO may, for instance, utilize the existing network resources to provide services without owning the physical network infrastructure. In any case, the MVNO may be capable of assigning AI identities to users and/or digital agents, which can be used to facilitate the various functionalities described above. In one or more embodiments, the eSIM platform 820 may be capable of facilitating eSIM allocations even for MVNO assigned identities.

FIGS. 11B and 11C show an example call flow 1100 for dynamic eSIM allocation and relinquishment.

As context, assume that the user device 802 has attached to the BSS 822 for connectivity, and that the device AI 802a of the user device 802 has provided data regarding an AI identity that is associated with the user device 802 to the BSS 822 for verification. Assume also that the BSS 822 has forwarded this data to the AI RF 810 for verification of the AI identity. Verification may involve token verification, such as, for example, shared secret keys (for decrypting and verifying the token's contents), public key cryptography (where the user device 802 uses a private key to sign the token, and the AI RF 810 uses a corresponding public key to verify the signature), or the like. Assume further that, based on successful verification of the AI identity, the BSS 822 facilitates obtaining/assigning of a (e.g., public) IP address for the user device 802 to enable Internet access for the user device 802. For instance, the BSS 822 may coordinate with a core network to obtain/assign the IP address. Assume also that the device AI 802a of the user device 802 has caused this IP address to be provided to the AI RF 810 for updating of the registration details of the AI identity. Alternatively, the BSS 822 may provide the newly-assigned IP address to the AI RF 810 for updating of the AI identity information.

Referring to FIG. 11A, at 1102, the BSS 822 may submit a request to the eSIM platform 820 for an eSIM. The request may include an eSIM Identifier (EID) (e.g., for a blank or unassigned eSIM of the user device 802) and the AI identity that is associated with the user device 802.

At 1104, the eSIM platform 820 may bind the EID and the AI identity based on the request.

At 1106, the eSIM platform 1106 may allocate a floating eSIM to the BSS 822 in response. Unlike traditional eSIMs, this floating eSIM may not yet be associated with an Integrated Circuit Card Identifier (ICCID), and thus allows for flexible phone number assignment at a later time on an as-needed basis. In one or more embodiments, the BSS 822 may transmit the floating eSIM to the user device 802. In alternate embodiments, the eSIM platform 820 may, at 1106, simply provide a notification to the BSS 822 that the EID and the AI identity 1104 has been bound in the eSIM platform 820. In this case, the user device 802 may simply have an eSIM with the EID but that is blank/unassigned and not yet associated with an ICCID.

At 1108, the device AI 802a may identify the available connectivity options for the user device 802. At 1110, the device AI 802a may determine that no other connectivity options, such as Wi-Fi, are available.

Based on this determination, the device AI 802a may, at 1112, send an eSIM allocation request, including the EID and the AI identity, to the eSIM platform 820. For instance, the device AI 802a may communicate with the eSIM platform 820 via a secure communication protocol, such as Hypertext Transfer Protocol Secure (HTTPS) or a similar encrypted signaling method, to ensure the confidentiality and integrity of the request. This signaling may involve the use of standard network interfaces or APIs that are designed to facilitate secure interactions between the device AI 802a and the eSIM platform 820.

At 1114, the eSIM platform 820 may validate whether the EID and the AI identity received in the request matches a stored EID-AI identity mapping.

At 1116, the eSIM platform 820 may, based on a successful validation, allocate an available eSIM (or ICCID) to the device AI 802a. In one or more embodiments, the device AI 802a may cause the received eSIM (or ICCID) to be installed or otherwise stored in the user device 802.

At 1118, the device AI 802a may issue a command to the AI RF 810 to associate the eSIM (i.e., ICCID or phone number) with the AI identity of the user device 802. The AI RF 810 may, based on the command, associate the eSIM (e.g., temporary phone number) with the AI identity. In a case where a call is made by a third party to the user's AI identity, the AI RF 810 may be queried for the eSIM (or the ICCID) that has been linked to the AI identity, where the eSIM (or the ICCID) can then be used to reach the user device 802 over the cellular network. As the AI identity is also linked in the AI RF 810 to the aforementioned IP address, call routing relating to the assigned ICCID/phone number may, in at least some embodiments, be performed for the user device 802 using the IP address. For instance, IMS-based IP addressing or SIP addressing may leverage the IP address to route calls for the user device 802. In any case, it should thus be understood and appreciated that the user device 802 may facilitate the process of obtaining an eSIM by leveraging the AI identity that is associated with the user device 802.

At 1120, the AI RF 810 may respond to the command with an indication of the success of the association.

Referring to FIG. 11C, at 1122, the device AI 802a may identify the available connectivity options for the user device 802.

At 1124, the device AI 802a may determine that at least one other connectivity option, such as Wi-Fi, is available, and may obtain an IP address associated with that connectivity option, which may be different from the IP address that was earlier obtained based on the user device 802's attachment to the BSS 822.

At 1126, the device AI 802a may issue a command to the AI RF 810 to associate this newly-obtained IP address with the AI identity that is associated with the user device 802. In one or more embodiments, the AI RF 810 may, based on the command, associate the AI identity with the newly-obtained IP address. At 1128, the AI RF 810 may respond to the command with an indication of the success of the association.

At 1130, the device AI 802a may, based on the response from the AI RF 810, send an eSIM relinquish request, including the EID and the AI identity that is associated with the user device 802, to the eSIM platform 820. At 1132, the eSIM platform 820 may validate whether the EID and the AI identity received in the request matches a stored EID-AI identity mapping. In one or more embodiments, the eSIM platform 820 may, based on the validation, disassociate the eSIM (or the ICCID) from the AI identity, thereby relinquishing the eSIM. At 1134, the eSIM platform 820 may respond to the device AI 802a with an indication of the success of the relinquishment.

In this way, a network operator's infrastructure can dynamically assign/release virtual phone numbers for a given user device. In one or more embodiments, the network operator's infrastructure may even periodically assign/release such phone numbers, as desired. In some embodiments, an assigned phone number can be provided to the device AI 802a for presentation to the user, which the user may provide to others to use to call the user's device. In various embodiments, the phone number, while technically temporary, can be used as a phone number via which the user can call or text to access a network-hosted AI assistant that is associated with the user. Details of user call-ins to the user's AI are described in more detail below with respect to the high level architecture 1200 of FIG. 12A.

It will be understood and appreciated that other implementations of dynamic eSIM allocation are possible depending on the eSIM infrastructure. For instance, the communication scheme involving the device AI 802a, the AI RF 810, etc. may be adapted for systems in which SIMs/eSIMs are managed in a cloud environment.

FIG. 12A is a high-level block diagram of an example architecture 1200 in which AI can be invoked to assist with voice/media services. In one or more embodiments, the architecture 1200 may function within, or may be operatively overlaid upon, the communications network of FIG. 1 and/or the network system 800 of FIG. 8A. In some embodiments, the architecture 1200 or one or more components thereof may be communicatively coupled to or integrated with one or more components in the network system 800 of FIG. 8A, such as, for instance, the AI RF 810 and/or the memory AI 814. The integration of AI within this framework allows for the performance of various services for users. In various embodiments, the architecture 1200 may provide a platform that enables personal voice assistants to seamlessly join voice calls. The following describes examples of services that may be enabled by this platform.

In one scenario, the architecture 1200 may facilitate inbound call handling by allowing a personal AI agent to handle or process calls based on user preferences or to support other applications such as one or more of those discussed in the aforementioned co-pending U.S. patent application Ser. No. 18/974,970 filed on Dec. 10, 2024. Users may configure a set of policies that define the types of calls that they wish to receive. In this scenario, inbound calls may be directed to the AI agent before the user is notified. The AI agent may decide whether to forward the call to the user or discard it. According to user configuration, the AI agent may also take a message and share a summary or transcript of the call with the user via text message, a mobile app, or other methods.

In another scenario, the architecture 1200 may enable user-triggered AI agent actions, where the user may request to add the AI agent to an ongoing call—e.g., using dual-tone multi-frequency (DTMF) tones, voice commands, or an application on the user's device. The AI agent may summarize, transcribe, or record calls according to user instructions, and may provide outputs of these functions utilizing in-band or out-of-band signaling.

The architecture 1200 may also support scenarios where the AI agent is always available to handle call drops gracefully. For instance, if a user experiences an interruption in a voice call due to poor coverage, such as upon entering an elevator, the network may actively or passively monitor the call quality and add the AI agent to the ongoing call to terminate it gracefully.

The architecture 1200 may also enable direct interaction via a customer telephone number (CTN). In this scenario, a user may wish to receive a conversational report on inbound calls handled by their AI receptionist or inform the AI to expect a certain call. The user may call or text their own telephone number to converse directly with their AI “receptionist.” This approach reuses the user's telephone number as an address for voice-based and/or text-based access to their AI, and allows for interaction using native applications, such as dialers or messengers or even feature phones or VOIP landlines.

The architecture 1200 may support a variety of other services that are aimed at enhancing user interaction and security, including enterprise integration (allowing the Web of AIs to be incorporated into enterprise networks), fraud detection (enabling AI agents to prevent users from sharing sensitive information such as social security numbers or credit card details during a call), text communication with AI (where SMS messages sent to a user's MSISDN may be directed to the AI, such that users can communicate with their AI assistant via texting), voice call routing to AI agents instead of voicemail (allowing users to call their AI assistant directly), detection of AI-generated calls (in line with regulatory guidelines), and real-time translation services (enabling users to translate audio streams between various languages).

As will be apparent from the following description, the architecture 1200 advantageously enables a network operator or third parties to develop a variety of services to assist users with calls. AI agent(s), whether internal or external to the telecommunications network, can be embedded into an ongoing voice call for a user, support bi-directional media, and handle (e.g., generate, terminate, and/or transfer) voice calls on behalf of the user.

Referring to FIG. 12A, the architecture 1200 may include a communication framework that is implemented in a (e.g., Universal Service Platform (USP)) IMS core 1202 and a voice platform 1204.

The IMS core 1202 (or simply IMS 1202) may include a framework for delivering IP multimedia services, such as voice, video, and messaging, over IP networks. The IMS core 1202 may be communicatively coupled to an access network 1203 (e.g., one or more base stations) and/or a core network (not shown), which may correspond to or may be similar to the access/core networks described above with respect to FIG. 8A. The IMS core 1202 may include a session border controller (SBC) 1202s that manages and controls IP-based communication sessions. Although not shown, the SBC 1202s may include a Proxy-Call Session Control Function (P-CSCF) that handles SIP signaling for establishing and managing multimedia sessions, including the management of security, quality of service, and regulatory compliance relating to those sessions. The IMS core 1202 may also include a Telephony Application Server (TAS) 1202t that provides telephony services and features, such as call control, call forwarding, conferencing, and other supplementary services. The TAS 1202t may manage call features and services for a receiving end of a communication session, such as by executing the logic required to deliver telephony services to end-users. The IMS core 1202 may further include a message gateway 1202g that is configured to interact with Rich Communication Services (RCS)/SMS services 1212s of the service logic 1212 to facilitate RCS-/SMS-based communications between users and their AI assistants.

The voice platform 1204 may be configured to function as a logical SIP and Real-Time Protocol (RTP) endpoint that terminates user SIP, Session Description Protocol (SDP), and RTP signaling on southbound interface(s). In various embodiments, the voice platform 1204 may facilitate or complete signaling in such a way that the caller perceives the call as having been terminated. In some implementations, the voice platform 1204 may emulate multiple user devices—e.g., up to about 100,000 UEs. The voice platform 1204 may generate externally consumable events on northbound interface(s). Northbound interface(s) of the voice platform 1204 may allow its application layer, such as service logic, to subscribe to call events for a given SIP or telephone Uniform Resource Identifier (URI) and handle voice calls, including termination and forwarding, on behalf of users. The voice platform 1204 may be configured with application programming interfaces (APIs) that allow internal or third-party developers to embed AI agents into voice and multimedia services, which can continue to use enhanced IMS services, such as IP Multimedia Subsystem Data Channel (IMS-DC).

As shown, the voice platform 1204 may include a media resource function (MRF) 1204m, a SIP/RTP endpoint 1204s, and a load balancer 1204b. The MRF 1204m may be configured to handle media-related tasks, such as mixing, transcoding, and/or processing audio streams. For instance, the MRF 1204m may manage conference calls by mixing multiple audio streams into a single output. The SIP/RTP endpoint 1204s may facilitate the termination and initiation of SIP and RTP sessions, and may manage the signaling and media exchange needed for establishing and maintaining voice calls. For example, the SIP/RTP endpoint 1204s may handle the setup and teardown of calls. The load balancer 1204b may distribute network traffic (e.g., evenly) across the voice platform 1204 so as to balance the use of resources. As an example, the load balancer 1204b may prevent any single component from becoming a bottleneck by directing incoming calls to the least busy resources.

In one or more embodiments, the voice platform 1204 may collect media, such as voice, and key performance indicators (KPIs), such as packet arrival times, and may provide this information to the decision engine 1210. The decision engine 1210 may detect the loss of (or decrease in quality) of audio signals by comparing the KPIs to corresponding thresholds and by analyzing other data, such as that relating to user location, etc. If the thresholds are not met and the user is detected to be in location that is likely to result in signal loss, the decision engine 1210 may take action to adjust the behavior of the invoked AI. For example, if the callee enters a garage and connectivity is lost (e.g., signal strength falls below a threshold), the decision engine 1210 may detect this and trigger AI intervention.

In exemplary embodiments, the voice platform 1204 may facilitate a “Bring Your Own AI” approach that allows users to request that their incoming/outgoing calls be handled or processed via their own AI. In one or more embodiments, an enterprise AI may also be integrated into calls to prevent the inadvertent disclosure of sensitive information.

The architecture 1200 may include a processing layer that is implemented in various components/systems, including a decision engine 1210, a service logic component 1212, an AI agent 1214, an event logger 1216g, an event DB 1216e, a UE preferences database 1216p, and a customer service platform or dashboard 1216t. Other supporting components/systems may include mobile application gateway (MAG) 1220, a quality of service (QoS) database 1222q, and a caller profile database 1222c.

The decision engine 1210 may be an enhanced application server that is configured to determine whether AI services should be enabled or invoked for an inbound or ongoing voice call. For an inbound call, the decision engine 1210 may direct the TAS 1202t to forward the call to AI services for further, such as call processing by an AI agent or AI voice detection. During an ongoing call, the decision engine 1210 may direct the TAS 1202t to add the user's AI agent to the call to support fraud detection or handle scenarios involving loss of connectivity, for instance.

The decision engine 1210 may include or have access to decision rules 1210r, a network function module (NFM) for voice—i.e., an NFM-voice component 1210v, and a cache 1210c, some or all of which the decision engine 1210 can leverage to facilitate the AI invocation determinations. The NFM-voice component 1210v may provide voice-related functionalities, such as handling voice call quality, managing voice traffic, and/or ensuring that voice services meet required QoS requirements. The cache 1210c may store temporary data to facilitate or expedite data processing/decision-making by the decision engine 1210.

The QoS database 1222q may store network-related information, particularly QoS metrics, which may be collected from various components or elements of the network, such as base stations or the like of an access network, systems in a core network (including, for instance the IMS core 1202), etc. Some or all of this information may be accessible to the decision engine 1210 for use in AI invocation determinations. The QoS database 1222q may also store the last base station (e.g., eNB, gNB, etc.) that a user or the user's device was attached to, signal strength measurements (e.g., Reference Signal Received Power (RSRP)/Reference Signal Received Quality (RSRQ), Signal-to-Noise Ratio (SNR), etc.), or the like. This information may be used for monitoring voice call QoS, such as in step 1252a of FIG. 12I described in more detail below.

The UE preferences database 1216p may store information (e.g., static attributes) relating to user devices and/or user preferences. This information may include users'AI invocation-related preferences (e.g., whether the AI should use a male or female voice, the AI persona to use, call categories that must be allowed or blocked, etc.), days/times during which a user does not wish to receive/answer calls, contact lists (e.g., including identified contacts who should or should not be screened), and/or power levels of user devices. Some or all of this information may be accessible to the decision engine 1210 for use in AI invocation determinations. An entry in database 1216p may be created, for instance, when a user subscribes to receive AI services.

In certain embodiments, multiple key-value stores may be used to temporarily store data from the database 1216p. These key-value stores may be positioned proximate to (e.g., within threshold distance(s) from) network functions that utilize this data, which allows for faster data retrieval and processing of the information by the network functions. The MAG 1220 may mediate (e.g., all) communications between UEs and the database 1216p. In one or more embodiments, the MAG 1220 may be capable of managing and storing digital identifiers for users, devices, and/or other entities, and may authenticate users or devices.

The caller profile database 1222c may store caller and/or caller reports/feedback relating to ongoing/prior calls. Additionally, or alternatively, the caller profile database 1222c may store AI-generated outputs/feedback. Some or all this information may be accessible to the decision engine 1210 for use in AI invocation determinations or the personalization or customization of the AI's handling of one or more calls.

The decision engine 1210 may make AI invocation determinations in accordance with the decision rules 1210r. The decision rules 1210r may be network operator-defined and/or user-defined. The decision rules 1210r may be defined in accordance with various factors, such as user AI preferences, QoS metrics, user contact lists, social contact graphs, user device battery power, etc. Various of the decision rules 1210r may be based on information or data obtained from the databases 1222q, 1216p, and/or 1222c.

The decision rules 1210r may include rules for determining when and how AI services should be invoked during call handling for a given user. For example, the decision rules 1210r may specify conditions under which AI should screen calls, such as when a call is from an unknown number or when the user is determined to be in a meeting. As another example, the decision rules 1210r may include criteria related to the battery status of the user's device, such as invoking AI to answer the call if the battery level is critically low so as to conserve power. As a further example, the decision rules 1210r may accommodate custom preferences, such as allowing the user to answer their own calls directly without AI assistance during specified hours, while enabling AI support during other times.

The service logic 1212 may be configured to manage and coordinate the execution of AI-driven processes and interactions within the network. The service logic 1212 may integrate various AI services on a user's behalf by consuming signaling events and media that are generated on the voice platform 1204's northbound interfaces, and invoking AI/LLM-supported services, such as AI-based call screening and/or detection of AI-generated voices, on the media that is received from the voice platform 1204.

The service logic 1212 may include an AI orchestration layer 1212a that controls which AI is engaged for specific purposes during the pre-call stage. For example, the AI orchestration layer 1212a may evaluate the applications that the user is subscribed to as well as network metrics to determine which AI(s) need to be invoked for the call. This may include any AI, such as a network-hosted AI and/or a third-party AI for tasks like fraud detection or artificial voice detection. Once the call begins, the AI engaged in the phone call may make in-call decisions, such as whether to perform additional tasks like translation, fraud topic detection, or synthetic voice detection, based on the context of the ongoing call.

The network/UE interaction component 1212i may facilitate communications between the network and user devices. The network/UE interaction component 1212i may interact with a UE to share information about (e.g., a transcript of) an ongoing call that is being handled or processed by the AI. This interaction may enable the user to direct the behavior of their AI, such as forwarding or terminating the call or some other action per contextually relevant instructions. For example, the user may provide directional instructions such as “I don't recognize this person, take a message,” or fine-grained instructions such as “propose 11:00 for the meeting the caller is requesting.” These capabilities allow the user to dynamically influence the AI's actions based on the specific context of the call.

The AI agent 1214 may be configured to provide AI services for handling/processing calls. In one or more embodiments, the AI agent 1214 may be the same as, may be similar to, may correspond to, may include, or may be included in the AI agent 806 described above with respect to FIG. 8A. In various embodiments, the AI agent 1214 may be trained and configured to provide a variety of services for users, including, but not limited to monitoring an ongoing call, joining an ongoing call to assist the user during the call, facilitating graceful call drop handling, navigating IVR menus, and scheduling appointments.

In various embodiments, the AI agent 1214 may include an integrated system of AI models/systems 1214m, including one or more LLMs, one or more speech-to-text (STT) systems, and/or one or more text-to-speech (TTS) systems. The STT system(s) may be configured/trained to convert spoken language into written text, which enables the AI agent 1214 to process and respond to spoken commands. The TTS system(s) may be configured/trained to convert written text into spoken language, which may provide audio output for text-based information. By integrating these technologies, the AI agent 1214 may create a comprehensive system that is capable of understanding spoken input, processing and generating text-based responses, and delivering those responses visually or audibly. This integration may support both text and voice communication. In some embodiments, the AI agent 1214 may additionally, or alternatively, include audio-mode models that directly accept audio inputs and return audio outputs without requiring explicit STT and TTS steps. These audio-mode models may streamline the communication process by enabling end-to-end audio interactions.

The AI agent 1214 may further include an artificial voice detection component 1214v that is configured/trained to identify and differentiate between human and synthetic voices during voice calls. This capability can advantageously guide the behavior and posture of the AI assistant during the call. For instance, if a synthetic voice is detected, the AI assistant may adjust its interaction strategy to ensure security and trustworthiness, such as by asking additional verification questions or flagging the call for further review. Additionally, the AI assistant may provide feedback to the callee, such as a visual indication in the mobile app or an auditory indication during the call if the callee is on the line with a suspected AI voice.

The event database 1216e and event logger 1216g may facilitate event management, including by tracking and logging data regarding events (e.g., event triggers, call control events, etc.) that are associated with the decision engine 1210, the service logic 1212, the voice platform 1204, and/or the AI agent 1214. Call transcripts that are generated by the AI agent 1214, for instance, can be stored in the event database 1216e. In certain embodiments, call detail records (CDRs) of actions taken by the AI agent 1214 and/or AI preferences may be stored in the event database 1216e or another database. These records may include call information, callee information, timestamps, event names, etc., including, for instance, detailed information about the interactions and decisions that are made by the AI, such as call handling actions, user preferences applied during the call, and/or any modifications to AI settings. Storing this information in the event database 1216e allows for comprehensive tracking and analysis of AI activities, enabling better understanding and improvement/optimization of AI performance in handling user interactions. In one or more embodiments, the event database 1216e may facilitate dynamic overload control by monitoring system load and latency data. For example, call processing latency that exceeds a predetermined threshold can trigger a reduction in the number of calls that are handled or processed so as to prevent overload. The AI behavior may also be dynamically adjusted based on system load or latency data collected in the event database 1216e. For instance, the AI may shorten the duration of call screening or ask fewer questions if the system load is high (e.g., above a threshold load).

Users may be permitted to access call record information from the event database 1216e via communications with the MAG 1220. The customer service platform or dashboard 1216t may be a user interface and/or may be a customer care tool that provides support and assistance to users relating to their service. The customer service platform or dashboard 1216t may have access to the event database 1216e to facilitate issue resolutions or display/review of the information in the event database 1216e.

User devices, such as the user device 802, may be equipped with a user application that provides a user application interface 802f. The user application may allow a user to subscribe to AI services and personalize their AI agent(s). In one or more embodiments, the user application may be the same as, may correspond to, or may be similar to the user-friendly application described above with respect to the device AI 802a of FIG. 8A.

The user application may be configured to periodically upload the user's contact list or address book (and/or optionally device status, such as battery status) to the UE preferences database 1216p. During an inbound call that is being handled by the AI agent 1214, the user application may, in coordination with the service logic 1212, generate notifications using the device's native notification system. This coordination may allow users to view AI-generated transcript(s) and listen in to the ongoing call. The user application may be capable of communicating user-triggered actions, such as user “barge-in” during call handling or processing or “summon” an AI to assist with an ongoing call, to the service logic 1212, and may allow users to view call records and post-call transcripts.

The MAG 1220 may mediate (e.g., all) communications between the user application and various functional components in the architecture 1200, such as the service logic 1212. In certain embodiments, communications between the user application and the service logic 1212, including streaming audio and transcripts, may be conducted over a default data bearer, such as QCI 9 or QCI 8. Alternatively, to enhance Quality of Experience (QoE), a low latency slice may be designated for the user application. This may involve utilizing a User Equipment Route Selection Policy (URSP) to ensure that the user application operates on a low latency slice. In one or more embodiments, an IMS Data Channel (IMS-DC) (e.g., as described/defined in Global System for Mobile Communications Association (GSMA) NG.134 IMS Data Channel V4.0 and/or 3GPP TS 24.186, such as V18.3.1 thereof, each of which is incorporated by reference herein in its entirety) may be employed to tunnel multimodal data to the user application using IMS bearers.

In one or more embodiments, the IMS core 1202 may receive a call and determine if the callee has subscribed to AI services. The IMS core 1202 may make this determination by checking the callee's service profile or subscription records that may be stored in one or more databases, such as the UE preferences DB database, the caller profile database 1222c, and/or another database. If the IMS core 1202 determines that the callee has subscribed to AI services, the IMS core 1202 may route the call to or command the decision engine 1210 (e.g., via an API) to assess whether the AI agent 1214 should be invoked to provide assistance with the call. In various embodiments, the decision engine 1210 may evaluate various factors, such as user preferences, network conditions, etc. to make the assessment.

The AI agent 1214, assuming that it is invoked to handle a call, may perform automatic transcription of the call, and may stream the transcript to the callee's user device during call handling or processing. The user application interface 802f on the user device may interact with the AI agent 1214 (e.g., via the MAG 1220) to obtain the transcript and/or to facilitate the exchange of other information or communications. In some implementations, when a call comes in for a user, the user application interface 802f may be triggered to display or output a notification indicating that AI is handling or processing the call. In some embodiments, a real-time (or near real-time) stream of the transcript between the caller and the AI agent 1214 may be presented on the user application interface 802f. The user application interface 802f may provide a user-selectable option to take over a call that is undergoing call handling or processing. In certain embodiments, the user application interface 802f may present options for the callee to choose to handle or process an incoming call and/or to set preferences for handling or processing an incoming call, an ongoing call, a particular expected call, certain types of calls, or all calls.

In one or more embodiments, the user application interface 802f may provide options for the callee to request AI intervention or to have the AI join an ongoing call to assist or enhance the communication. Users may also configure preferences through the user application interface 802f to automatically add AI to calls with unknown contacts, such as to aid in preventing fraud or scams. As an example, if a caller requests sensitive information, such as a social security number, the user application interface 802f may output a warning (e.g., in the form of an audible alert and/or a haptic alert) from the AI advising the callee not to share such details. Additionally, the user application interface 802f may offer the option for users to delegate call handling to the AI so as to enable the AI to manage interactions based on predefined rules and preferences.

In certain embodiments, one or more of the functional components in the architecture 1200 may be configured to register with a Network Repository Function (NRF). The NRF may be a centralized database or service within the network architecture that stores information about available network functions and their capabilities. Registration with the NRF may enable other network functions to discover and interact with the registered components.

It will be understood and appreciated that the various functional components of the architecture 1200 may be positioned or located with respect to one another in any suitable manner and/or may be implemented in any suitable environment.

In one or more embodiments, the voice platform 1204 may be co-located with the TAS 1202t, and may be hosted within the core network 1202—e.g., with one instance of the voice platform 1204 per defined zone.

In one or more embodiments, the decision engine 1210 may be deployed in a cloud environment—e.g., in close proximity to (such as within a threshold distance from) the TAS 1202t to reduce latency during voice call signaling.

In certain embodiments, the decision engine 1210 may be configured to mediate communications between the service logic 1212 and call control APIs of the TAS 1202t.

In one or more embodiments, the service logic 1212 and the AI agent 1214 may have access to or run directly on graphics processing unit (GPU)-based clusters to facilitate or provide AI services, such as call screening, AI voice detection, automatic speech recognition (ASR), and so on. One or more of these components may be located in a cloud environment.

In one or more embodiments, one or more of the UE preferences database 1216p and/or a call transcripts database may be hosted in a cloud environment. The decision engine 1210 may utilize cloud-based key-value stores or caching solutions to access the stored data so as to meet performance requirements.

FIGS. 12B and 12C show an example call flow 1230 for invoking AI services for a call made by a caller to a callee.

The process may involve a caller, a callee (e.g., user device 802), the TAS 1202t, a signaling-based handler, the decision engine 1210, the UE preferences database 1216p, the voice platform 1204, the service logic 1212, the AI agent 1214, and one or more LLM(s) 1214m.

Referring to FIG. 12B, at 1230a, the caller may send an INVITE message to the TAS 1202t. The TAS 1202t may perform signaling-based handling or processing by sending (1230b) the INVITE to the signaling-based handler. The handler may evaluate the call and send (1230c) the call handling or processing results back to the TAS 1202t. If the handling or processing disposition indicates that the call should be forwarded to the user, the TAS 1202t may send an API request 1230d to the decision engine 1210 to determine how the call should be processed.

At 1230e, 1230f, the decision engine 1210 may retrieve user preferences from the UE preferences database 1216p. Based on these preferences, the decision engine 1210 may apply the appropriate policies to decide if the call should be sent to the user, rejected, or sent to the AI agent 1214 for handling. In this example, the decision engine 1210 directs the TAS 1202t to handle or process the call by sending a response message 1230g.

Upon receiving the response from the decision engine 1210, the TAS 1202t may forward the call via INVITE 1230h to the voice platform 1204 for AI handling or processing. The voice platform 1204 may receive the inbound call and may notify the service logic 1212 of the incoming call at 1230i. The service logic 1212 may check if AI resources are available to handle or process the call. If resources are available, the service logic 1212 may instruct (1230j) the voice platform 1204 to accept the call.

At 1230k, the voice platform 1204 may accept the call and send a 200 OK message to the caller. The TAS 1202t may also send a 200 OK message 1230l to the caller.

At 1230m, 1230n, the service logic 1212 may fetch user preferences from the UE preferences database 1216p. If user preferences require, the service logic 1212 may send an application-level notification 1230o to the callee to notify the callee of an incoming call that is being handled or processed by the AI agent 1214.

Referring to FIG. 12C, at 1232a, the caller may send RTP packets to the voice platform 1204, which may stream the RTP packets to the service logic 1212. The voice platform 1204 may send a media event 1232b to the service logic 1212, which may be triggered to send media metadata 1232c to the AI agent 1214.

At 1232d, the AI agent 1214 may perform ASR/STT, and may create and send a prompt 1232e to the LLM 1214m for output generation. The LLM 1214m may then provide a (e.g., textual) response to the prompt at 1232f.

At 1232g, the AI agent 1214 may provide the response to the service logic 1212, which may include or specify caller and AI utterances. At 1232h, the service logic 1212 may convert the response into audio using user-configured preferences, and, at 1232i, the service logic 1212 may send the media to the voice platform 1204, which may send RTP packets 1232j to the caller. If user preferences require, the service logic 1212 may send an application-level notification 1232k to the callee with a transcript of the caller and AI utterances. Steps 1232a to 1232k may be repeated in a loop throughout the call handling process.

In a case where the AI agent 1214 determines (e.g., based on screening results or based on one or more other criteria being satisfied) that the call should be sent to the user, the AI agent 1214 may notify the service logic 1212 at 1232l. The AI agent 1214 may determine that call handling or processing is complete by evaluating a combination of factors that ensure the call's legitimacy and relevance to the user, and whether the conversation with the caller has reached a logical conclusion. As an example, the AI agent may have handled or processed the call by facilitating appointment scheduling on behalf of the callee, received and taken down (or stored) a message from the caller for relay to the callee, addressed an inquiry from the caller regarding something of importance—e.g., a purchase order, a repair, etc.—and so on. As another example, the AI agent may screen the call by verifying the caller's identity using voice recognition or biometric data to ensure that it matches an expected profile; if the identity is confirmed, the AI agent 1214 may determine that call screening is complete and that the call should be forwarded to the callee; otherwise, the call may be rejected. The AI agent 1214 may additionally, or alternatively, analyze the conversation's content for keywords or phrases that indicate the call's purpose, and may, for instance, determine to reject the call if it is identified as spam or a sales pitch, or determine to connect the call to the callee for other matters. User preferences may also be taken into account—e.g., the AI agent 1214 may decide to forward calls from specific contacts or block unknown numbers as predefined by the callee. In certain embodiments, sentiment analysis of the caller's tone and language may further inform the posture of the AI. For instance, in a case where the AI agent 1214 determines that the caller's request is urgent or that the caller is angry and wishes to set up an appointment with the user as soon as possible, the AI agent 1215 may decide to choose an earlier date/time for the meeting rather than a later date/time. As another example, in the case of call screening, determined positive or neutral sentiments may trigger the AI agent 1214 to forward the call to the callee, while determined negative tones may trigger the AI agent 1214 to reject the call. Again, in a call screening example, contextual information, such as the caller's location or recent interactions may also provide additional insight, where calls determined to originate from expected locations may be forwarded by the AI agent 1214 to the callee, whereas calls determined to originate from unexpected locations may trigger rejection. In various embodiments, the AI agent 1214 may determine call handling or processing to be complete based on a command from the user (e.g., via the device AI 802a of the user device 802) to “barge-in” and accept the call. However, the AI agent 1214 may (e.g., at the option of the callee) remain on the call to provide in-call AI services for the user.

At 1232m, the service logic 1212 may inform the decision engine 1210 of the call handling/processing outcome—e.g., in the example case of call screening, connect the call to the user, and after the decision engine 1210 acknowledges receipt at 1232n, the service logic 1212 may invoke the voice platform 1204 to forward the call to the callee at 1232o.

The voice platform 1204 may perform the appropriate SIP signaling to indicate to the TAS 1202t that call handling or processing is complete by sending a REFER/BYE message at 1232p. At 1232q, the TAS 1202t may call the API of the decision engine 1210 to obtain the outcome of the AI handling or processing. At 1232r, the decision engine 1210 may modify parameters to include a call summary or an AI logo or any other information in the call.

At 1232s, the TAS 1202t may initiate the inbound call procedure by sending SIP signaling towards the callee with an INVITE at 1232s. The callee may respond with a 200 OK message at 1232t, and a QCI-1 bearer may be created for tunneling the media. Thereafter, media exchange (1232u) may occur between the caller and callee on the QCI-1 bearer.

FIG. 12D is a block diagram illustrating an example implementation 1235 that involves the use of multiple instances of various functional components of the architecture 1200 for redundancy. Instances 1204′ and 1204″ of the voice platform 1204 may correspond to various instances of service logic—e.g., instances 1212′ and 1212″ of the service logic 1212 (which may be internal instances of the network operator) as well as an external service logic instance 1212″′ (which may be provided for or by a 3^{rd} party). The service logic instance 1212′ may correspond to an instance 1214′ of the AI agent 1214, the service logic instance 1212″ may correspond to an instance 1214″ of the AI agent 1214 as well as to one or more 3^{rd}-party AI agent instances (1214″′, etc.), and the external service logic instance 1212″′ may correspond to one or more 3^{rd}-party AI agent instances (1214″″, etc.). Additional instances of one or more of the various functional components may be provided or instantiated as needed to service numerous users using internal or external AI agents as needed to handle production call volumes.

In one or more embodiments, the SIP/RTP endpoint 1204s may serve as southbound interfaces for the voice platform 1204. Here, instances 1204s′, 1204s″ of the SIP/RTP endpoint 1204s may serve as southbound interfaces for the instances 1204′ and 1204″ of the voice platform 1204. In general, the voice platform 1204 may act as an endpoint for inbound calls and messages, receiving SIP and RTP messages from the IMS core for inbound calls and handling SIP and RTP signaling. The voice platform 1204 may function as the SIP user agent server (UAS) for multiple endpoints simultaneously as shown, and may support the same SIP standards as the TAS 1202t, such as explicit call transfer, three-way calling, etc.

In certain embodiments, the voice platform 1204 may be configured to disable 180 ringing while accepting a call and/or may respond to an INVITE with a 200 OK instead of 180 ringing. The voice platform 1204 may be configured to reuse the same SIP call ID for a bot-to-callee call. The voice platform 1204 may be configured to facilitate handling of an explicit call transfer in the event of a QCI 1 failure. In various embodiments, the voice platform 1204 may be configured to address (e.g., non-recoverable) errors in the RAN or core network by facilitating the creation of a conference call and the disconnecting of the AI agent.

In one or more embodiments, the decision engine 1210 may facilitate or control the dynamic scale-out and scale-in of multiple instances of the voice platform 1204. In certain embodiments, a single endpoint may be exposed for forwarding SIP signaling for all inbound calls. The load balancer 1204b may distribute the load among the voice platform instances. The load balancer 1204b may ensure that the appropriate instance of the voice platform 1204 is selected according to the usage policy of the application. For example, calls for a range of SIP URIs may terminate at a specific voice platform instance.

In a case where the voice platform 1204 does not have adequate resources to handle an inbound call due to internal issues or issues with its upstream logic, the voice platform 1204 may reject the SIP INVITE message with an appropriate error code. In a case where the voice platform 1204 or the service logic 1212 or the AI (or the AI infrastructure in general) does not have adequate resources to handle an inbound call due to internal issues or issues with its upstream logic, a resource allocation API thereof may return with a failure message. In certain embodiments, the voice platform 1204 may check with an application (e.g., the above-described user application on the user device 802 or another application) to determine if it wants to handle the call before responding to the SIP INVITE. In various embodiments, resource allocation decisions may also take into account cost control measures or subscription tier limitations. For example, users on a lower subscription tier may have restricted access to certain features or limited call handling capacity, while higher-tier subscribers may be allocated additional resources to ensure uninterrupted service.

In one or more embodiments, the voice platform 1204 may provide northbound interfaces that allow applications to subscribe to various events, such as incoming calls, call terminations, and RTP packet receptions. Applications may be permitted to subscribe to events for individual MSISDNs, a group of MSISDNs, or using a wildcard approach. The voice platform 1204 may support the addition or removal of MSISDNs from an application's subscription list.

In certain embodiments, multiple applications may subscribe to events for a given MSISDN. In such cases, the bot platform may generate individual notification events for each subscription endpoint. Applications may specify which headers should be included in the notifications. For example, custom SIP headers may be defined to transfer metadata between the TAS 1202t and the voice platform 1204. The voice platform 1204 may extract headers from SIP messages, such as a call info header and/or the P-Access-Network-Info (P-ANI) header, and may include them in relevant events.

The voice platform 1204 may create a unique identifier for each ongoing call, and may notify applications of events such as incoming calls (INVITE), call terminations (BYE), participant additions (RE-INVITE), and call cancellations or drops (CANCEL). Applications may return events during the notification process for INVITE, such as by accepting a call with one-way or two-way audio (e.g., by sending 200 OK with SDP), rejecting a call (e.g., by sending SIP 4XX), or performing no operation for BYE or CANCEL events.

Applications may be provided with APIs to perform actions on ongoing calls, such as transferring calls (explicit call transfer), adding participants to calls (three-way conferences), hanging up calls, or removing participants from ongoing calls. Media, both inbound and outbound, may be transferred using remote procedure calls or buffers or other mechanisms so as to ensure efficient communication and interaction with the voice platform 1204.

As the voice platform 1204 may operate in multiple instances, the voice platform 1204 may have 1:1 or N:1 backup and redundancy to ensure reliability. The voice platform 1204 may support communications with multiple service logic 1212 and TAS 1202t instances simultaneously, which enhances the voice platform 1204's ability to manage distributed workloads and maintain service continuity.

In one or more embodiments, the voice platform 1204 may generate and monitor media QoS reports. These reports may be used to assess voice call quality and determine when a user AI should be summoned to handle a call in case of connectivity loss. By analyzing media QoS metrics, the voice platform 1204 may proactively address issues that could impact call quality.

In certain embodiments, the voice platform 1204 may implement overload and admission control mechanisms as triggered based on data collected in event database 1216e. These control mechanisms may be facilitated/enforced by the decision engine 1210. Network and hardware KPIs, such as CPU utilization, latency, RAM usage, and/or call processing speed (CPS) may be monitored, where the voice platform 1204 may, based on these metrics, be controlled to gradually throttle the number of INVITE messages that it handles so as to prevent overload.

In one or more embodiments, the voice platform 1204 may be configured to operate according to specific latency and performance requirements. For instance, the voice platform 1204 may be configured to provide timely responses to SIP signaling messages from the TAS 1202t. The voice platform 1204 may also ensure efficient media delivery to the northbound interfaces and maintain desired (e.g., optimal) performance for media handling on the southbound interfaces.

In certain embodiments, the voice platform 1204 may generate CDRs for calls, including information about call failures and their causes.

In one or more embodiments, the service logic 1212 may be responsible for event-driven call event and media handling. The service logic 1212 may register endpoints to receive call events and media, and may manage calls after the call events have been delivered by the voice platform 1204. The service logic 1212 may register endpoints to consume the northbound interfaces of the voice platform 1204, including endpoints to receive call events and media. The service logic 1212 may specify which headers from the SIP message need to be extracted by the voice platform 1204. These headers may be provided in the call event notification.

The service logic 1212 may be required to respond to the northbound call events within a predetermined time. Upon receiving an inbound call for the user, the service logic 1212 may indicate how the call must be processed, whether forwarded to the user, terminated, or handled by the voice platform 1204. For example, if the service logic 1212 is unable to process the call due to internal issues, loss of connectivity with the UE preference database 1216p, or due to overload, the service logic 1212 may indicate that the call cannot be handled by the service logic 1212 and needs to be managed by a different process. The response from the service logic 1212 may be used to generate appropriate SIP signaling using the voice platform 1204 southbound interfaces. After a call is accepted by the voice platform 1204, the call may be explicitly terminated by the service logic 1212 by invoking or posting an event to the voice platform 1204's northbound interface. The call may then continue until the caller hangs up, which ensures that the service logic 1212 maintains control over the call termination process. In one or more embodiments, the service logic 1212 may be configured to encode media packets and send the encoded packets to the voice platform 1204 for transmission to a corresponding UE.

The AI agent 1214 may invoke the appropriate AI models for call handling or processing, including, for instance, call screening, fraud detection, AI voice detection, appointment scheduling on behalf of the callee, message taking on behalf of the callee, and so on. The AI agent 1214 may invoke multiple models in parallel. In certain embodiments, the AI agent 1214 may check if incoming audio or a generated transcript matches known fraud or spam call signatures. The AI agent 1214 may use pre-collected samples to construct a database of known fraud or spam calls against which incoming calls may be validated. Either the AI agent 1214 or another system may construct such a database. In various embodiments, AI call handling or processing and database validation may occur in series or in parallel. In a case where an incoming call matches a known spam or fraud call signature, the AI agent 1214 may initiate termination of the call at the network. In certain embodiments, the AI agent 1214 may notify the callee if AI voice is detected in a call. The call may also be terminated depending on user preference. Again, AI voice detection may be executed in parallel with other operations involving other AI models. In one or more embodiments, the service logic 1212 may provide media to the AI agent 1214 to facilitate the AI services. The AI agent 1214 may identify sentence boundaries and utilize LLM(s) to generate responses. The AI agent 1214 may generate audible outputs in response to incoming audio (from the caller) and/or transcripts of the incoming audio and/or the generated audible outputs, which can be provided to the callee's device for callee review. In various embodiments, the AI agent 1214 may generate the audible outputs according to user preferences, such as male or female voice, premium voice, etc., and may send the incoming audio (from the caller), the audible outputs generated by the AI agent 1214, and/or any transcripts to the service logic 1212/voice platform 1204 for output to the callee's device. Upon completion of the call handling or processing by the AI agent 1214, the service logic 1212 may notify the voice platform 1204 of the outcome by invoking the interface or API to terminate or transfer the call. In certain alternate embodiments, some or all of the foregoing functions described with respect to the AI agent 1214 may be performed by the service logic 1212 or another component in the architecture 1200.

In one or more embodiments, the service logic 1212 may push notifications and stream transcripts to the above-described user application for calls that are being handled or processed by the AI agent 1214. The service logic 1212 may push a notification to the user application when a call handling or processing session begins, where the transcript of the call may be sent to the user application in real-time or near real-time. The service logic 1212 may notify the AI agent 1214 and the voice platform 1204 of actions that might be invoked by the user on the user application during the call. For instance, if the user chooses to “barge in” and accept the call during the handling or processing, the service logic 1212 may receive the notification from the user application, and may command the voice platform 1204 via an API to transfer the call to the user or add the user to a conference call with the AI agent 1214. The service logic 1212 may ensure that the media generated by the AI agent 1214 is appropriately handled while the AI agent 1214 is in a conference call. In another scenario, when a user commands to “summon” the AI agent 1214 to hand off the call, the service logic 1212 may receive this notification from the user application, and may invoke one of more APIs of the voice platform 1204 to add the AI agent 1214 to the call or to transfer the call to the AI agent 1214. In one or more embodiments, the service logic 1212 may allow users to view the call log of the calls that are handled by the AI agent 1214. The service logic 1212 may collect and maintain a list of calls that are directed to the user, and may categorize the calls appropriately. This list may be exposed to the user via the user application, and may identify calls that are handled by the AI agent 1214 and sent to the user, calls that are handled by the AI agent 1214 and dropped, calls that are handled by the AI agent 1214 and sent to voicemail, and/or calls that are rejected by the decision engine 1210. Example call types may include “telemarketer,” “survey,” “spam,” “recruitment,” “financial services,” “political,” “charity,” or the like. Calls may also be classified according to a call classification (which may be set by the AI assistant)—e.g., “important,” “uncategorized,” “blocked,” or the like. The service logic 1212 may therefore provide information that allows users to obtain a comprehensive view of their call history (e.g., via a mobile app, such as the user interface 802f of the device AI 802a), allowing them to ascertain the types of calls that they received and understand how their calls were managed by the AI agent 1214 and the decision engine 1210. This functionality enhances user experience by providing transparency and control over call handling processes. In certain alternate embodiments, some or all of the foregoing functions described with respect to the service logic 1212 may be performed by the AI agent 1214 or another component in the architecture 1200.

As the service logic 1212 may run in multiple instances, the service logic 1212 may have 1:1 or N:1 backup and redundancy to ensure reliability. The service logic 1212 may support communications with multiple voice platform 1204 and decision engine 1210 instances simultaneously, which enhances the service logic 1212's ability to manage distributed workloads and maintain service continuity.

In certain embodiments, the service logic 1212 may implement overload and admission control mechanisms. The service logic 1212 may monitor network and hardware KPIs, such as CPU utilization, latency, RAM usage, and CPS. Based on these metrics, the service logic 1212 may gradually throttle the number of incoming call events that it processes to prevent overload.

In certain embodiments, the service logic 1212 may generate CDRs for calls, including information about call failures and their causes.

In one or more embodiments, the decision engine 1210 may handle call events based on notifications of incoming calls to a user that are sent from the TAS 1202t—e.g., sent via Representational State Transfer (REST)-based interfaces. The decision engine 1210 may implement a set of policies, such as those described above, to decide whether the call should be forwarded to the AI agent 1214.

For call duration-based handling, after a call has been forwarded to the user by either the decision engine 1210 or the AI agent 1214, the decision engine 1210 may monitor the duration of the call. If the call duration is short (e.g., less than a threshold duration), the policies at the AI agent 1214 and/or the decision engine 1210 may be updated. For example, the update may involve adjusting the call forwarding criteria or thresholds to be more stringent or altering the user preferences for handling similar calls in the future, so as to improve future decisions of or decision-making by the decision engine 1210—i.e., where the decision engine 1210 avoids forwarding unwanted calls to the user where the user would hang up very quickly after answering the call.

FIGS. 12E and 12F show an example call flow 1240 relating to communications between the voice platform and the service logic of the architecture 1200.

The process may involve a caller, a callee (e.g., user device 802), a CSCF 1202c (which may be included in the IMS 1202), the TAS 1202t, the voice platform 1204, and the service logic 1212.

At 1240a, the caller may send an INVITE message to the CSCF 1202c. This CSCF 1202c may be configured to manage call setup and routing.

At 1240b, the CSCF 1202c may forward the INVITE to the TAS 1202t. The TAS 1202t may perform signaling-based handling, and may check with the decision engine 1210 to determine if the call should be forwarded to the voice platform 1204. If the decision is made to forward the call, the TAS 1202t may send the INVITE at 1240c to the voice platform 1204.

At 1240d, the voice platform 1204 may send a 180 Ringing response to the caller to indicate that the call is being processed. Alternatively, 180 Ringing may be disabled—e.g., as described earlier above.

At 1240e, the voice platform 1204 may send a call setup request command to the service logic 1212, which may initiate a bidirectional persistent streaming connection for the control channel (1240f).

The service logic 1212 may respond at 1240g with a response, indicating that the call is to be accepted with two-way audio.

At 1240h, once the call is accepted, the voice platform 1204 may send a 200 OK message with SDP to the caller so as to establish the media connection.

At 1240i, the voice platform 1204 may send an audio stream initiation message to the service logic 1212 as a notification that the media connection is set up and audio streaming is starting. This may initiate a bidirectional persistent streaming connection for the audio channel (1240j).

At 1240k, the caller may send RTP packets to the voice platform 1204, which may buffer (1240l) the RTP for a configured duration.

The service logic 1212 may establish a two-way audio stream channel with the AI agent 1214 (or AI processing layer). At 1240m, the voice platform 1204 may tunnel media to the service logic 1212 for AI services from the AI agent 1214, such as call handling or processing, including, for instance, fraud detection embedding, artificial voice detection, and/or the like.

At 1240n, the service logic 1212 may provide outputs from the AI agent 1214 to the voice platform 1204.

In some embodiments, the service logic 1212 may invoke a transfer API to notify the voice platform 1204 of the completion of call handling or processing or other events, such as “barge-in” by the user.

At 1240p, the voice platform 1204 may send a termination message to the caller. Thus, as with various other audio communications, the handling may be from the AI agent 1214 to the service logic 1212 and then to the voice platform 1204. In certain embodiments, the voice platform 1240 may also (e.g., optionally) send an audio stream stop message to the service logic 1212.

At 1240q, the service logic 1212 may send a confirmation of the stopping of the audio stream to the voice platform 1204, thereby ending the audio stream (1240r) and RTP may also end.

At 1240s, the voice platform 1204 may send a control message to the service logic 1212 with an indication to perform a transfer.

At 1240t, the voice platform 1204 may also send a BYE message to the TAS 1202t to terminate the call.

At 1240u, the service logic 1212 may send a control request event notification to the voice platform 1204 with a session completion indication. The bidirectional persistent streaming connection for the control channel may then end at 1240v.

While various embodiments of the web of AI architecture 1200 are described herein as including or involving TAS-based systems, it is to be understood and appreciated that the architecture 1200 can additionally, or alternatively, utilize other call-related frameworks or systems, such, for instance, as cloud-native platforms that leverage microservices for scalability and flexibility.

The portability of AI memories described herein may allow a network operator that operates the architecture 1200 to host voice/messaging AI services not only for its own subscribers but also for subscribers of other carriers. For instance, subscribers to a third-party carrier may be allowed to register AI Identities with the AI RF 810, which one or more components of the architecture 1200 may access or invoke to provide voice/messaging AI services for those subscribers. The network operator may host AI memories, user personas associated with the AI identities, etc. of the third-party's subscribers. In some implementations, the third-party carrier's telecommunications network may forward calls that are associated with its subscribers to the architecture 1200 (e.g., to the IMS 1202 or the voice platform 1204/redirected using a SIP REFER message) to leverage the AI services. The network operator may or may not host the actual AI agent for the third-party carrier's subscribers. In a case where the network operator does not host the actual AI agent for the third-party carrier's subscribers, the network operator may allow third-party AI agents (e.g., those operated by the third-party carrier) to access the AI memories, user personas associated with the AI identities, etc. of the third-party's subscribers with appropriate permissions.

In certain implementations, the architecture 1200 may enable users to call into the network using their user devices to interact with or control their AI assistants. Hosted on the network, a user's AI may be accessible via a phone number and may be agnostic to device hardware and ecosystems, allowing for AI-based call handling or processing (even before inbound calls reach the user's device) or continuation of a conversation with another party if the user's device is suddenly unavailable, such as due to lack of battery power, a call drop situation, network connectivity loss, etc. When a user-originated call is made to the user's AI, such as by dialing a phone number associated with the user, the call may be routed through the network via the IMS core 1202 and directed towards the service logic 1212 and/or the voice platform 1204 rather than to a voicemail system. Routing of the call may be mediated by the decision engine 1210, where the IMS core 1202 may request the decision engine 1210 for a routing decision. In a case where the decision engine 1210 decides to connect the call, the decision engine 1210 may direct the IMS core 1202 to route the call to the voice platform 1204 to facilitate voice-based interactions between the user and the AI agent 1214. As an example, the service logic 1212 may evaluate the user's service profile, determine the appropriate AI assistant to invoke, and actually invoke the AI assistant—e.g., here, an instance of the AI agent 1214—to provide AI services for the user. In some embodiments, the service logic 1212 may communicate with the AI RF 810, the device AI 802a, and/or the memory AI 814 to invoke an AI identity and to obtain AI assistant settings/preferences, user AI memories, etc. so as to tailor the AI assistant's services for the user. In any case, with the AI agent 1214 invoked, the IMS core 1202 may route the call to the voice platform 1204, which may handle the media processing and ensure that the call is connected to the AI agent 1214. The voice platform 1204 may convert the user's voice inputs into text using STT technology such that the AI agent 1214 can process the inputs and generate appropriate responses. These responses may be converted back into audio using TTS technology and sent to the user's device. (In various embodiments, the STT/TTS or ASR may reside at the AI agent; in alternate embodiments, the STT/TTS or ASR may alternatively reside at the service logic 1212 or the voice platform 1204.) Throughout the call, the AI agent 1214 may continue to process inputs, generate responses, and maintain real-time interactions, thereby allowing the user to converse with the AI assistant as if speaking to a human agent.

As discussed above, a user may interact with the user's AI agent or assistant to configure user/usage preferences. These preferences may include AI-related preferences (e.g., a type of voice used by the AI assistant, a tone of speech used by the AI assistant, etc.) and/or call handling/processing policies (e.g., a whitelist of phone numbers (or MSISDNs) or topics where calls involving the whitelisted item(s) do not require AI-based call screening, a blacklist of phone numbers (or MSISDNs) or topics where calls involving the blacklisted item(s) should be subjected to AI-based call screening or that should be rejected, one or more exceptions [e.g., allow calls from a particular department store between 9 AM and 6 PM for the next three days only], and/or the like). Additionally, the user may provide the AI assistant with conditional instructions for handling specific scenarios. For example, the user might instruct the AI assistant to approve a call from their car mechanic if the estimate is under $500, but to take a message with the amount and reason if the estimate exceeds $500. Such dynamic instructions allow the AI assistant to handle calls in a context-aware manner, aligning with the user's specific preferences and priorities.

Interactions between the AI assistant and the user may be facilitated over one or more channels. As an example, the interactions may be facilitated via a device-based application (e.g., the device AI 802a or the like), which may, for instance, communicate with the AI assistant via the MAG 1220. As another example, the interactions may be facilitated via voice calls, where either the user's own phone number can be dialed to on the user's device 802 to reach the AI assistant or where a preconfigured number can be set that all users may call into, but where the source number is used to identify the user using some form of authentication (e.g., biometric verification, such as voice fingerprinting, etc.). As a further example, the interactions may be facilitated via text messaging, where either the user's own phone number can be texted to on the user's device 802 to reach the AI assistant or where a preconfigured number can be set that all users may text to, but where the source number is used to identify the user.

In exemplary embodiments, certain protocols may be defined and utilized to mitigate attacks on the network-hosted AI infrastructure, particularly in relation to RCS-/SMS-based configurations of the AI agent. FIG. 12G shows an example call flow 1250 for integrating AI services with RCS/SMS messaging. This integration may be effected via a three-step configuration process involving the message gateway 1202g and the service logic 1212 (e.g., the RCS/SMS services 1212s thereof) in which communications between the message gateway 1202g and the user cannot be spoofed (i.e., are spoof-proof). Specifically, step Y in the call flow 1250 enables (or guarantees) a message from the AI assistant to reach the user or the actual MSISDN associated with the user, without being intercepted by a malicious actor.

At 1250a, the service logic 1212s may subscribe to RCS/SMS messages (e.g., for each user) with the message gateway 1202g.

At 1250b (step X), the user may send an AI configuration request to the message gateway 1202g—e.g., via a short code number. The AI configuration request may include one or more plain text, human readable strings.

At 1250c, the message gateway 1202g may communicate with (e.g., respective) RCS/SMS gateways to intercept messages that are destined towards the AI assistant or the AI short code number, where (e.g., only) such destined messages may be transmitted to the service logic 1212.

At 1250d, the message gateway 1202g may transmit the AI configuration request (e.g., including the originating and/or terminating MSISDN) to the service logic 1212. At 1250e, the service logic 1212 may transmit the AI configuration request to the AI agent 1214.

At 1250f, the AI agent 1214 may interpret the AI configuration request using one or more LLM models. The AI agent 1214 may generate one or more policies based on the interpretation. The one or more policies may be generated as one or more plain text, human readable strings.

At 1250g, the AI agent 1214 may send the one or more policies in a policy confirmation request to the service logic 1212.

At 1250h, the service logic 1212 may send the policy confirmation request to the message gateway 1202g, and at 1250i (step Y), the message gateway 1202g may send the policy confirmation request to the user. The policy confirmation request may include a prompt to the user to review the one or more policies and to confirm whether the user accepts the one or more policies. The user's response may be sent at 1250j (step Z) as a policy confirmation response (e.g., a plain text, human readable string or a selection of ‘yes’ or ‘no’).

At 1250k, the message gateway 1202g may send the policy confirmation response to the service logic 1212, and at 1250l, the service logic 1212 may send the policy confirmation response to the AI agent 1214. In a case where the user accepted the one or more policies (or perhaps suggested an adjustment to the one or more policies), the AI agent 1214 may implement the one or more policies (with any adjustments specified by the user) by interpreting the response and defining one or more policy rules. At 1250m, the AI agent 1214 may send the one or more policy rules to the service logic 1212. At 1250n, the service logic 1212 may send the one or more policy rules (including the originating MSISDN) to the decision engine 1210 for storage as one or more of the decision rules 1210r. At 1250n, the service 1212 may also send a confirmation to the user that the one or more policies have been applied.

In this way, the interactions between the message gateway 1202g, the service logic 1212, and the AI agent 1214 enable communications between the AI assistant and the user that are spoof-proof.

FIG. 12H is a block diagram illustrating an example AI agent service implementation. The AI agent service 1214 may operate through three stages, namely a pre-call stage, an in-call stage, and a post-call stage. In the pre-call stage, the AI agent service may retrieve user preferences and/or call history by communicating with a UE preferences service and/or a call session store of the service logic 1212. This step informs the AI agent service of the user's past interactions and preferences. Additionally, the AI agent service may access a persona catalog to obtain the appropriate persona or prompt for the call. The persona catalog may store information regarding various AI personas, such as professional or casual, which dictate the tone and style of interaction. For example, a business persona might prioritize formal language and efficiency.

Upon detecting an incoming call, the service logic 1212 may notify the AI agent service of an incoming call, and the AI agent service may acknowledge this notification and prepare to engage in the call.

During the in-call stage, the AI agent service may convert audio chunks to (e.g., complete) utterances by communicating with an ASR Service. This enables real-time understanding of the caller's speech. The transcribed utterances may be sent to the service logic 1212, allowing for processing as needed. The AI agent service may access an AI personalization store, which may store user-specific data, such as frequently discussed topics or preferences, that can be used to tailor AI responses. For instance, the AI personalization store may store a user's favorite topics for small talk. Additionally, or alternatively, the AI personalization store may maintain context that is specific to the AI agent. For example, if a user informs the AI agent, “I am expecting a call from a furniture store,” this information may be translated into a policy rule for the decision engine 1210 (see, e.g., FIG. 12G), while also being stored in the AI personalization store for future reference. The AI personalization store may further store runtime context, such as a list of all current policy rules. If the user calls or chats with the AI agent and requests the list of active rules, the service logic 1212 may retrieve this information from the AI personalization store and deliver it to the user. In one or more embodiments, the AI personalization store may enable the AI agent to recall specific call-related contexts. For instance, if the AI agent screens a call and forwards it to the user, but the user does not accept the call, the call may return to the AI agent. In such cases, the AI agent may utilize the AI personalization store to recognize that this is the same call and handle it accordingly. In any case, the AI agent service may communicate with an LLM service to generate responses based on the conversation with the caller. In some embodiments, the AI agent service may utilize a TTS service to convert text responses into spoken words. The TTS service may utilize different voice profiles to match the selected persona, such as a friendly or authoritative tone. After generating a response, the AI agent service may communicate with the LLM service to refine or adjust the output as needed as to ensure that the response aligns with the user's preferences or the conversation's context. The generated text may be sent to the service logic 1212, thus providing the verbal content for the AI agent's response, such as a summary of the caller's request or a suggested solution. The AI agent service may also send call control messages to the service logic 1212, which may include instructions for managing the call flow, such as transferring the call or placing it on hold. Additionally, the AI agent service may communicate the caller's identity to the service logic 1212, which may include information such as the caller's name or account details. The AI agent service may also send information regarding the call's intent and/or classification to the service logic 1212, which may categorize the call's purpose, such as a support request or a sales inquiry, to guide the interaction. The AI agent service may facilitate synthetic voice detection by sending audio/text to a synthetic voice detector for analysis. A synthetic voice score obtained based on the analysis may be sent to the service logic 1212, which the service logic 1212 may use to assess the authenticity of the caller's voice. This assessment can help determine whether the voice is generated by a synthetic source, which allows appropriate actions to be taken if needed, such as flagging the call for further review, adjusting the interaction strategy to ensure security and trustworthiness, or even rejecting or dropping the call altogether. Additionally, or alternatively, feedback may be provided to the callee, such as via a visual indication in a mobile app or an auditory indication during the call if the callee is present, to inform them of the detection.

In the post-call stage, the AI agent service may update the call session store of the service logic 1212 with a record of the details of the call, such as duration, topics discussed, etc. This aids in maintaining an accurate history for future reference and personalization. The AI agent service may also send call statistics, such as duration, token usage, etc. to an event audit log of the service logic 1212, which can be used to facilitate performance analyses and optimizations/improvements, billing processes, cost management, etc.

In certain embodiments, the connection between the AI agent service and the service logic (or any upstream system providing connectivity to the phone call) may be a persistent one, such as gRPC or WebSocket. This persistent connection may help maintain low latency that is need for natural and responsive interactions with the caller. Low roundtrip latency may be important to delivering a usable experience for the caller, as it reduces or minimizes delays and ensures that the system can respond promptly to user inputs. In one or more embodiments, the AI agent service may employ three separate steps, utilizing distinct models or services for ASR, text completion (LLM), and audio generation (TTS). In alternate embodiments, the AI agent service may support end-to-end voice models that do not require one or more of the three separate steps. The overall AI agent service platform may be designed in a modular fashion to accommodate either implementation so as to allow for flexibility and adaptability. In certain embodiments, the overall AI agent service platform may be constructed in a modular manner as to enable the swapping of different versions of the three services (ASR, LLM, TTS, or end-to-end voice) from various vendors with little to no refactoring.

As described above, in one or more embodiments, the architecture 1200 may support scenarios where the AI agent is available to handle call drops gracefully. When a user experiences an interruption in a voice call due to poor coverage, such as entering an elevator, the network can actively or passively monitor the call quality. Where the call quality drops below a threshold, the AI agent 1214 may be added to the ongoing call to facilitate a graceful termination, rather than abruptly dropping the call (e.g., after the typical 10-second disruption period). This approach allows the AI assistant to manage the call drop, thereby providing a smoother experience for the other user on the call. One of the challenges in implementing this solution is that the AI agent 1214 may need to actively listen to the call audio to determine if the caller is unable to communicate. However, the network does not typically monitor the QoS for voice calls between users, nor does it generally retrieve call media on demand. It might be possible to “anchor” the call during the setup procedure, whereby the voice platform 1204, for instance, joins the call and monitors media packets as they pass through its stack. This process is resource-intensive, however, and as a result, the network generally cannot anchor all calls. Additionally, there are privacy concerns associated with allowing AI agents to listen in on (e.g., all) user audio during (e.g., all) calls, which may not be preferred.

Embodiments of a voice call QoS-based algorithm address the foregoing issue of call drops by first analyzing static data to decide if a call should be “anchored” at the network, using metrics such as signal strength and historical call drop behavior. Once anchored, the voice platform 1204 may collect media KPIs and employ deep neural network (DNN) models or other type(s) of ML models to assess voice quality to determine if AI intervention is needed. If the neural network is unable to make a clear inference, the algorithm may proceed to extract media samples for analysis by a language model, which may utilize pattern matching to evaluate call quality and decide if AI intervention is required. FIG. 12I illustrates an example voice call QoS-based algorithm 1252 that facilitates graceful handling of call drops. Assume that an inbound call is received. This may trigger the decision engine 1210 to estimate the likelihood of call failure (1252a). The estimation may involve an analysis of static data relating to the user and/or the network environment. This analysis may help determine whether the call should be “anchored” at the network, which is generally a decision that should be made swiftly during the call setup phase. The decision engine 1210 may evaluate various metrics, including signal strength and/or RAN KPIs (e.g., accessibility and retainability, coverage maps, historical call drop behavior for both the user and the cell site, and/or the like). Additionally, the decision engine 1210 may consider the current outage status and/or network congestion levels. Essentially, the question to be answered at 1252a is whether the QoS for the call should be monitored. Where the decision engine 1210 answers in the affirmative (1252b, likelihood of failure>some threshold x %), the system may listen in to the call, which may be initiated during call setup to enable bidirectional media access.

After the call is anchored at the voice platform 1204, the voice platform 1204 may begin collecting media KPIs, such as inter-arrival packet rates and/or packet latency for the call. These KPIs may aid in assessing the quality of the call and may be delivered to a QoS monitor module. The QoS monitor module may be implemented in the decision engine 1210, in another component, or as a distinct component. The QoS monitor module may employ DNN model(s) or other type(s) of ML models to analyze these KPIs and infer whether the voice quality is deteriorating. If the media quality is found to be deteriorating, the system has two potential courses of action. First, if these model(s) determine that the media quality is sufficiently poor (e.g., some quality metric is below a threshold), the AI agent 1214 may be triggered to join the call. Alternatively, if the model(s) are unable to make a definitive inference regarding the need for AI intervention (e.g., some quality metric is above a threshold or cannot be obtained), the algorithm may proceed to step 1252d for further analysis. Essentially, the question to be answered by the QoS monitor module is whether the QoS is indeed deteriorating, which the machine learning model may assess using the collected media QoS data.

At step 1252d, the voice platform 1204 may extract samples of media from the ongoing voice call and deliver them to the LLM for further analysis. The LLM may employ pattern matching techniques to evaluate the call quality by identifying specific caller utterances, such as “hello, can you hear me?,” from the media samples. The utterances may serve as indicators of potential communication issues. The LLM may thus rely on actual media content to perform the pattern matching and determine whether the AI agent 1214 should take over the call. It is to be understood and appreciated that step 1252d may be performed for only a small number of users—e.g., only in instances where the DNN model(s) in the prior step are unable to make a definitive inference.

In this way, the algorithm 1252 may facilitate call handling for improved “in-call” experiences.

FIG. 12J is a high-level block diagram of another example architecture 1200′ in which AI can be invoked to assist with voice/media services. The architecture 1200′ is generally the same as the architecture 1200 of FIG. 12A, with the main difference being that the architecture 1200's lacks a standalone decision engine and thus lacks API-based connectivity thereof with an IMS 1202t′. Instead, the functionalities of the decision engine 1210—i.e., the decision rules 1210r, the NFM-voice function 1210v, and the cache 1210c—may be implemented in an AI orchestrator 1212′ that is similar to the service logic 1212. This implementation advantageously allows AI services to be provided in an over the top (OTT) manner and thus enables more flexible deployment independent of the underlying network infrastructure. Here, the network may send calls to the voice platform 1204 for anchoring, and the AI agent 1214 may remain (e.g., continuously) engaged in the call path. This is in contrast to the architecture 1200 of FIG. 12A in which the AI agent 1214 therein is engaged (e.g., only) when needed. Of course, continuously engaging the AI agent 1214 may lead to inefficiencies since AI resources would be used for every call regardless of whether intervention is necessary. In any case, calls may be tunneled to the AI agent 1214 using any alternate infrastructure.

Although examples described below generally focus on user calls into their AI, in various embodiments, the architecture 1200 (or 1200′) may be equipped/adapted to enable a user to text their AI and generally interact with it via messaging rather than calling. In these embodiments, the user's texts to a phone number associated with the user's AI agent (such as a short code) may be routed through an RCS or SMS/Multimedia Messaging Service (MMS) server/center, which may, based on recognizing that the text is from and for a phone number associated with the user, engage with the service logic 1212 to invoke the AI agent 1214.

While typical authentication measures, such as passwords (including, e.g., One-Time Passwords (OTP)), user fingerprints, user voice recognition, and signaling-based methods (e.g., using device fingerprints like specific packet capture file headers), can be used to verify the identity of a caller that is trying to reach a user's AI, these measures might not be sufficient due to vulnerabilities such as spoofing. The following describes various authentication measures that can be singly or in combination integrated in a telecommunications network, such as the architecture 1200 (or 1200′), to secure user-to-AI calls against spoofing attempts and thus ensure that (e.g., only) the legitimate user can access and interact with their AI agent.

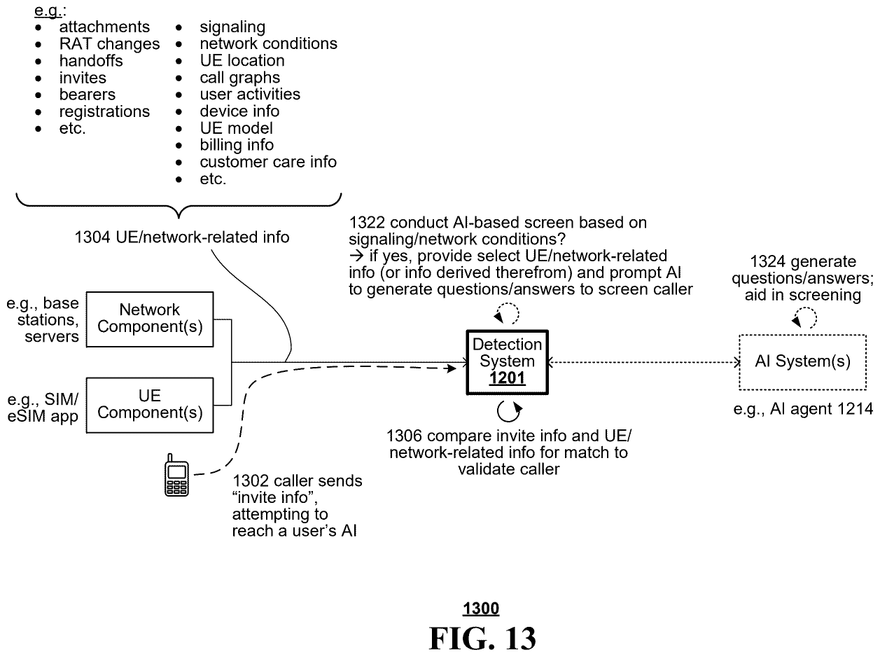

In exemplary embodiments, the architecture 1200 (or 1200′) may be configured with a detection system that is capable of facilitating one or more types of authentication. FIG. 13 illustrates an example authentication implementation 1300 in which a detection system 1201 is integrated with or communicatively coupled to telecommunications network components, user device systems, and/or AI system(s) to facilitate the authentication(s).

The detection system 1201 may be integrated with or communicatively coupled to RAN-/core network-related entities (e.g., base stations, authorization/authentication servers, etc.), entities in the IMS core 1202, UE SIM components, LLMs, and/or the like. In certain embodiments, the detection system 1201 may be implemented in one or more systems/devices described above with respect to FIG. 8A, such as, for instance, the AI RF 810 and/or the memory AI 814, which may be communicatively coupled to RAN-/core network-related entities (e.g., base stations, authorization/authentication servers, etc.), entities in the IMS core 1202, UE SIM components, and/or the like. In various embodiments, the detection system 1201 may be called upon or triggered by the service logic 1212, the decision engine 1210, the IMS core 1202, or another component in the architecture 1200 of FIG. 12A (or the architecture 1200′ of FIG. 12J) that is involved in handling inbound calls to a user's AI, to facilitate authentication of the call.

In one or more embodiments, the detection system 1201 may be capable of obtaining and utilizing various information regarding a caller or caller UE to verify that it is indeed the user who is calling the user's AI assistant. The information may identify, for instance, the caller's current location, a last call location associated with the caller's device, registration status associated with the caller's device, any signaling bearers that have been established for the caller's device, and/or the like. Using some or all of the information, the detection system 1201 may assess whether it is in fact the legitimate user who is calling into their AI.

In various embodiments, the detection system 1201 may be configured to obtain UE/network-related information (e.g., 1304). For instance, the detection system 1201 may be configured to subscribe to events from one or more network-based entities.

As one example, the detection system 1201 may be configured to subscribe to one or more of the following EPC events (which may be reported in a format such as <timestamp, event-id, event-result, cell-id> or the like):
E1: Attach (triggered when the UE successfully attaches/detaches to the network)
E2: QCI-5 (triggered when the UE creates/terminates a QCI-5 bearer, which is used to tunnel IMS signaling)
E3: QCI-1 (triggered when the UE creates/terminates a QCI-1 bearer, which is used to tunnel voice packets)
E4: Handoff (triggered when the UE is handed off between cells)

As another example, the detection system 1201 may additionally, or alternatively, be configured to subscribe to one or more of the following IMS events (which may be reported in a format such as <timestamp, event-id, event-result, network function (NF)-instance>):
I1: REGISTER (triggered when the UE successfully completes a SIP registration, or when a REGISTER timeout occurs)
I2: INVITE (triggered when an inbound or outbound INVITE/BYE is received for the UE)

As yet another example, the detection system 1201 may additionally, or alternatively, be configured to subscribe to one or more of the following Authentication, Authorization, and Accounting (AAA) events (which may be reported in a format such as <timestamp, event-id, event-result, cell-ID>):
A1: AAA attach (triggered when the UE successfully authenticates to a Wi-Fi network)
A2: AAA handoff (triggered when the UE is handed off between Wi-Fi cells or back to a cellular network, such as LTE/NR)

In certain embodiments, the detection system 1201 may additionally, or alternatively, be configured to receive notifications of events from one or more device-based entities. In these embodiments, a USIM app may subscribe to various events on the UE, including, for instance, one or more of the following:
U1: UE attach (triggered when the UE successfully attaches to the network)
U2: UE registration (triggered when the UE successfully completes a SIP registration)
U3: UE Invite (triggered when the UE sends/receives an INVITE)
U4: UE RAT change (triggered when the UE switches from cellular to Wi-Fi or vice versa)
U5: UE Handoff (triggered when the UE is handed off or if a cell selection is made)

The USIM app may report such events in a format such as <timestamp, event-id, event-result, cell-ID, rat-type>.

In various embodiments, the detection system 1201 may perform passive authentication based upon a detection of an outbound call INVITE from a caller UE (e.g., 1302). The passive authentication may involve validating if the caller UE has performed or engaged in one or more of E1, E2, E3, E4, I1, and I2 (e.g., 1306).

In certain embodiments, the passive authentication may additionally, or alternatively, involve validating if the call is being received from an expected base station node (e.g., eNB, gNB, etc.) or Wi-Fi AP. This validation may include extracting the latest <cell-Id> from E1, E2, and/or E4 and/or A1 and/or A2, and determining if the geolocation information in the call INVITE matches some or all of the extracted information. The validation may additionally, or alternatively, include extracting the <NF-instance> from I1 and determining if the CSCF that received the call INVITE matches the extracted value.

In a case where SIM app-assistance is available, the passive authentication may additionally, or alternatively, involve validating if the caller UE has performed or engaged in one or more of U1, U2, U3, U4, and U5. Furthermore, in certain embodiments, the passive authentication may additionally, or alternatively, involve extracting the latest <cell-id> and <rat-type> from one or more of U1 through U5, and determining if the some or all of the values match that included in the call INVITE.

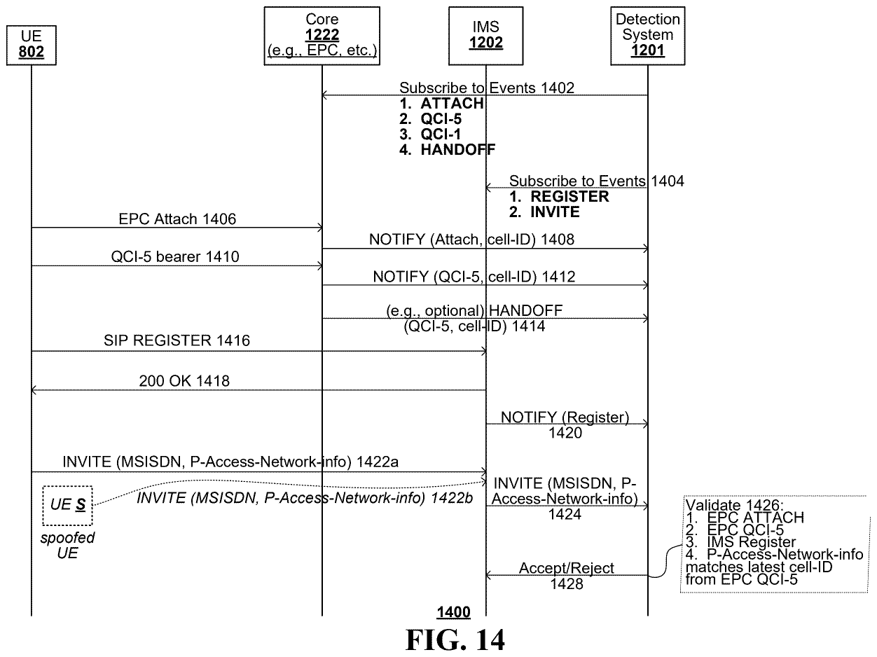

FIG. 14 shows an example call flow 1400 for network-assisted caller-ID spoofing detection.

Here, the detection system 1201 may perform passive authentication in response to detecting an inbound call to a user's AI, by utilizing event data obtained from a core network 1222 and the IMS 1202. The core network 1222 may, for instance, correspond to the core network(s) described above with respect to the architecture 1200 of FIG. 12A and/or the network 804 of FIG. 8A.

At 1402, the detection system 1201 may subscribe to events that are associated with the core network 1222. These events may include, for instance, UE-related attachment events, UE-related QCI bearer creation/termination events, UE-related handoff events, and/or the like.

At 1404, the detection system 1201 may subscribe to events that are associated with the IMS 1202. These events may include, for instance, UE-related registration events, UE-related inbound call initiation/termination events, and/or the like. In certain embodiments, the events may additionally, or alternatively, include registration events, such as those defined in Section 7.5.21 of the above-mentioned 3GPP TS 31.111.

At 1406, the user device (or UE) 802 may attach to the core network 1222. At 1408, the core network 1222 may, responsive to the attachment, send a notification of the attachment to the detection system 1201. At 1410, the UE 802 may create a QCI-5 bearer. At 1412, the core network 1222 may, responsive to the creation, send a notification of the creation to the detection system 1201. In a case where the core network 1222 effects a handover for the UE 802, the core network may, at 1414, send a notification of the handoff to the detection system 1201. At 1416, the UE 802 may send a registration message to the IMS 1202. At 1418, the IMS 1202 may, responsive to the registration message, reply to the UE 802 with an acknowledgement. At 1420, the IMS 1202 may additionally send a notification of the registration to the detection system 1201. By virtue of one or more of the notifications 1408, 1412, 1414, and 1420, the detection system 1201 will have obtained network-related information for the UE 802, which the detection system 1201 can utilize to validate inbound calls to the user's AI.

At 1422a, the UE 802 may make such an inbound call, in which case, the IMS 1202 may send a notification 1424 of the inbound call to the detection system 1201. The inbound call message may include network-related information, such as information regarding one or more of the events 1406, 1410, 1416, etc. In this case, the detection system 1201 may compare this information with the information previously obtained via the notifications 1408, 1412, 1414, and/or 1420. For instance, the detection system 1201 may perform one or more comparisons, such as a comparison of the attachment information from the notification 1408 with the attachment information identified in the inbound call message, a comparison of the bearer information from the notification 1412 with the bearer information identified in the inbound call message, and so on. If the detection system 1201 determines (1426) that the comparisons warrant accepting the inbound call, such as when there is a match in the attachment information, when there is a match in the attachment information and also a match in the IMS registration information, when a cell ID in the inbound call message matches a cell ID in the latest bearer-related notification from the core network 1222, or when there is any other combination of matching information, then the detection system 1201 may, at 1428, command the IMS 1202 to accept the inbound call.

In a different scenario, a spoofed UE S may instead make an inbound call to the user's AI (1422b). Here, the inbound call message will likely include network-related information that is different from the information in the notifications 1408, 1412, 1414, and/or 1420. As a result, the detection system 1201 may not find sufficient matching of these two sets of information. For instance, one or more pieces of information may not match—e.g., the attachment information identified in the inbound call message may not match the attachment information in the notification 1408, the bearer information identified in the inbound call message may not match the bearer information in the notification 1412, the registration information identified in the inbound call message may not match the registration information in the notification 1420, and/or a cell ID in the inbound call message does not match a cell ID in the latest bearer-related notification from the core network 1222. In such case, the detection system 1201 may determine that the mismatches warrant rejection of the inbound call, and may, at 1428, command the IMS 1202 to reject the inbound call. However, the detection system 1201 may allow for some flexibility in certain cases. For example, the detection system 1201 may accept the inbound call if the cell site (e.g., eNB or Wi-Fi access point) associated with the inbound call is within a predefined geographic range (e.g., 100 miles) of the last known location identified in the notifications 1408, 1412, or 1414. Or, if the mismatches exceed acceptable thresholds, the detection system 1201 may determine that the inbound call warrants rejection and may, at 1428, command the IMS 1202 to reject the inbound call.

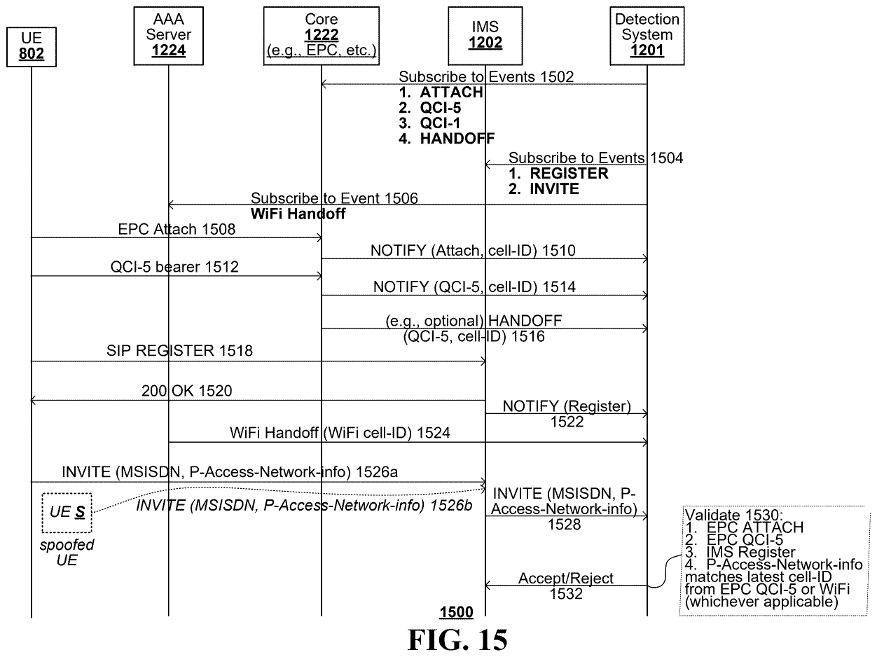

FIG. 15 shows an example call flow 1500 for network-assisted caller-ID spoofing detection with Voice Over Wi-Fi (VoWi-Fi).

The general process in the call flow 1500 may be similar to that of the call flow 1400 in that the detection system 1201 may subscribe to events from various network elements, and utilize that information to evaluate whether to accept/reject an inbound call to a user's AI. For the sake of brevity, therefore, the steps in the call flow 1500 are described concisely, with the understanding that they follow the same or similar principles/logic as those outlined for the call flow 1400.

Here, the detection system 1201 may perform passive authentication in response to detecting an inbound call to a user's AI by utilizing event data obtained from the core network 1222, the IMS 1202, and an AAA server 1224. Although not shown, in certain embodiments, the AAA server 1224 may be included in the architecture 1200 (or 1200′)—e.g., it may be communicatively coupled to one or more components of the IMS 1202, one or more components of the core network 1222, or one or more access network elements.

At 1502, the detection system 1201 may subscribe to events that are associated with the core network 1222. These events may include, for instance, UE-related attachment events, UE-related QCI bearer creation/termination events, UE-related handoff events, and/or the like.

At 1504, the detection system 1201 may subscribe to events that are associated with the IMS 1202. These events may include, for instance, UE-related registration events, UE-related inbound call initiation/termination events, and/or the like.

At 1506, the detection system 1201 may subscribe to one or more events that are associated with the AAA server 1224. These events may include, for instance, UE-related Wi-Fi handoff events. A Wi-Fi handoff event may indicate a transition of a UE from one Wi-Fi access point to another or from a Wi-Fi network to a cellular network.

At 1508, the UE 802 may attach to the core network 1222. At 1510, the core network 1222 may, responsive to the attachment, send a notification of the attachment to the detection system 1201. At 1512, the UE 802 may create a QCI-5 bearer. At 1514, the core network 1222 may, responsive to the creation, send a notification of the creation to the detection system 1201. In a case where the core network 1222 effects a handover for the UE 802 (e.g., from one RAN cell to another), the core network may, at 1516, send a notification of the handoff to the detection system 1201. At 1518, the UE 802 may send a registration message to the IMS 1202. At 1520, the IMS 1202 may, responsive to the registration message, reply to the UE 802 with an acknowledgement. At 1522, the IMS 1202 may additionally send a notification of the registration to the detection system 1201. At 1524, the AAA server 1224 may send, to the detection system 1201, a notification of a Wi-Fi handoff relating to the UE 802. For instance, the handoff may be due to the UE 802 having traveled to a location that has suitable network connectivity over Wi-Fi. By virtue of one or more of the notifications 1510, 1514, 1516, 1522, and 1524, the detection system 1201 will have obtained network-related information for the UE 802, which the detection system 1201 can utilize to validate inbound calls to the user's AI.

At 1526a, the UE 802 may make such an inbound call, in which case, the IMS 1202 may send a notification 1528 of the inbound call to the detection system 1201. The inbound call message may include network-related information, such as information regarding one or more of the events 1508, 1512, 1518, etc. In this case, the detection system 1201 may compare (1530) this information with the information previously obtained via the notifications 1510, 1514, 1516, 1522, and/or 1524, and determine to accept the inbound call if there is a sufficient number of matches (e.g., one set of information has a match, two sets of information have matches, etc.). Accordingly, the detection system 1201 may, at 1532, command the IMS 1202 to accept the inbound call.

In a different scenario, the spoofed UE S may instead make an inbound call to the user's AI (1526b). Here, the inbound call message will likely include network-related information that is different from the information in the notifications 1510, 1514, 1516, 1522, and/or 1524. As a result, the detection system 1201 may not find sufficient information matches. In such a case, the detection system 1201 may determine that the mismatches warrant rejection of the inbound call, and may, at 1532, command the IMS 1202 to reject the inbound call.

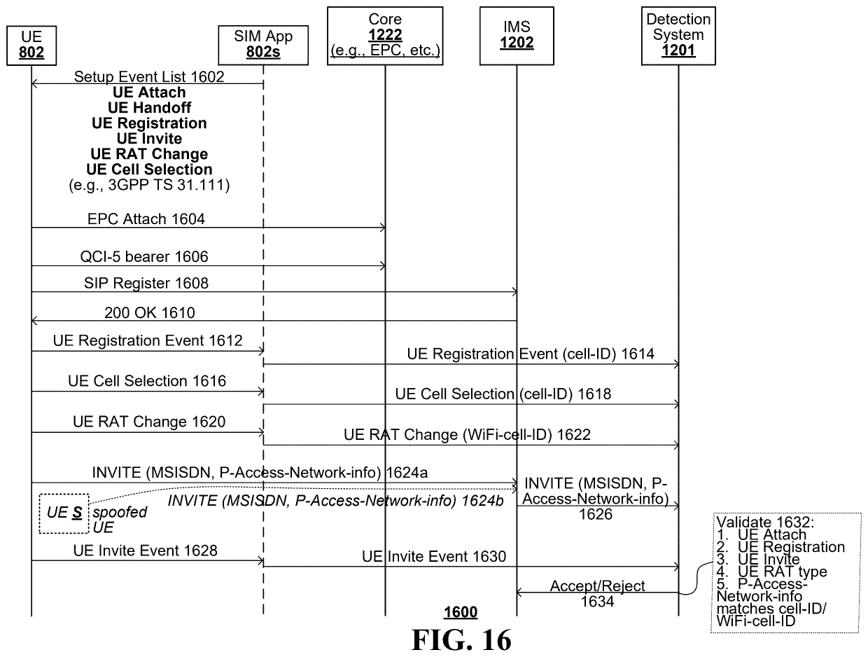

FIG. 16 shows an example call flow 1600 for SIM app-assisted caller-ID spoofing detection.

In this context, a SIM app 802s may reside on a SIM card or may be associated with an eSIM on a user device (e.g., the UE 802), and may be capable of performing certain 3GPP tasks, such as subscribing to specific connection-related events. In various embodiments, this SIM app functionality may correspond to some or all of those described in the above-mentioned 3GPP TS 31.111. Since number spoofing does not typically occur on the user device itself, the detection system 1201 can leverage records or events stored in the SIM app 802s to verify whether the user device actually initiated an outbound call to the network to reach the user's AI assistant. This approach enables active validation using SIM apps. By accessing a user device's SIM app, the detection system 1201 can determine if an outbound call event was recorded. If the records or events obtained from the SIM app 802s confirm such an outbound call, the detection system 1201 can determine that it is likely the user who initiated the call to the AI. Otherwise, the detection system 1201 can reject the call.

The general process in the call flow 1600 may be similar to that of the call flows 1400 and 1500 in that the detection system 1201 may receive event notifications from various systems, and utilize that information to evaluate whether to accept/reject an inbound call to a user's AI. For the sake of brevity, therefore, the steps in the call flow 1600 are described concisely, with the understanding that they follow the same or similar principles/logic as those outlined for the call flows 1400 and 1500.

At 1602, the SIM app 802s may configure or set up an event list that enables the SIM app 802s to be notified of certain events that are associated with the UE 802. These events may include, for instance, UE-related attachment events, UE-related handoff events, UE-related registration events, UE-related call initiation/termination (e.g., invite) events, UE-related RAT change events, UE-related cell selection events, and/or the like.

At 1604, the UE 802 may attach to the core network 1222. At 1606, the UE 802 may create a QCI-5 bearer. At 1608, the UE 802 may send a registration message to the IMS 1202. At 1610, the IMS 1202 may, responsive to the registration message, reply to the UE 802 with an acknowledgement. At 1612, the UE 802 may send a notification of a UE registration event to the SIM app 802s. This notification may be sent after the sending of the registration message 1608. At 1614, the SIM app 802s may, in turn, send a notification of the UE registration event to the detection system 1201. At 1616, the UE 802 may send a cell selection notification to the SIM app 802s. This may be sent in response to the UE 802 performing an action to choose a particular cell to connect to. At 1618, the SIM app 802s may, in turn, send a notification of the cell selection event to the detection system 1201. At 1620, the UE 802 may send a RAT change notification to the SIM app 802s. This may be sent in response to the UE 802 performing an action to change the RAT used for connectivity. At 1622, the SIM app 802s may, in turn, send a notification of the RAT change event to the detection system 1201. By virtue of one or more of the notifications 1614, 1618, and 1622, the detection system 1201 will have obtained at least some network-related information for the UE 802, which the detection system 1201 can utilize to validate inbound calls to the user's AI.

At 1624a, the UE 802 may make such an inbound call, in which case, the IMS 1202 may send a notification 1626 of the inbound call to the detection system 1201. The inbound call message may include network-related information, such as information regarding one or more of the events 1612, 1616, 1620, etc. Additionally, at 1628, the UE 802 may, responsive to the initiation of the call, send a call initiation notification to the SIM app 802s. At 1630, the SIM app 802s may, in turn, send a notification of the call initiation to the detection system 1201. As such, the detection system 1201 will have obtained additional information for the UE 802. Here the detection system 1201 may compare (1632) some or all of the pieces of network-related information in the inbound call message with corresponding pieces of information obtained via the notifications 1614, 1618, 1622, and/or 1630, and may determine to accept the inbound call if there is a sufficient number of matches (e.g., one set of information has a match, two sets of information have matches, etc.). Accordingly, the detection system 1201 may, at 1634, command the IMS 1202 to accept the inbound call.

In a different scenario, the spoofed UE S may instead make an inbound call to the user's AI (1624b). Here, the inbound call message will likely include network-related information that is different from the information in the notifications 1614, 1618, and/or 1622. In fact, given that the UE S is a spoofed UE, no corresponding call initiation would have occurred at the UE 802, and hence, the UE 802 would not send a UE invite event notification to the SIM app 802s, and the SIM app 802s would not forward such a UE invite event notification to the detection system 1201. As a result, the detection system 1201 may, based on the lack of a corresponding UE invite event notification from the SIM app 802s, determine that the inbound call is to be rejected. Additionally, or alternatively, the detection system 1201 may not find sufficient information matches in relation to the notifications 1614, 1618, and/or 1622. In any case, the detection system 1201 may determine that the validation results warrant rejection of the inbound call, and may, at 1634, command the IMS 1202 to reject the inbound call.

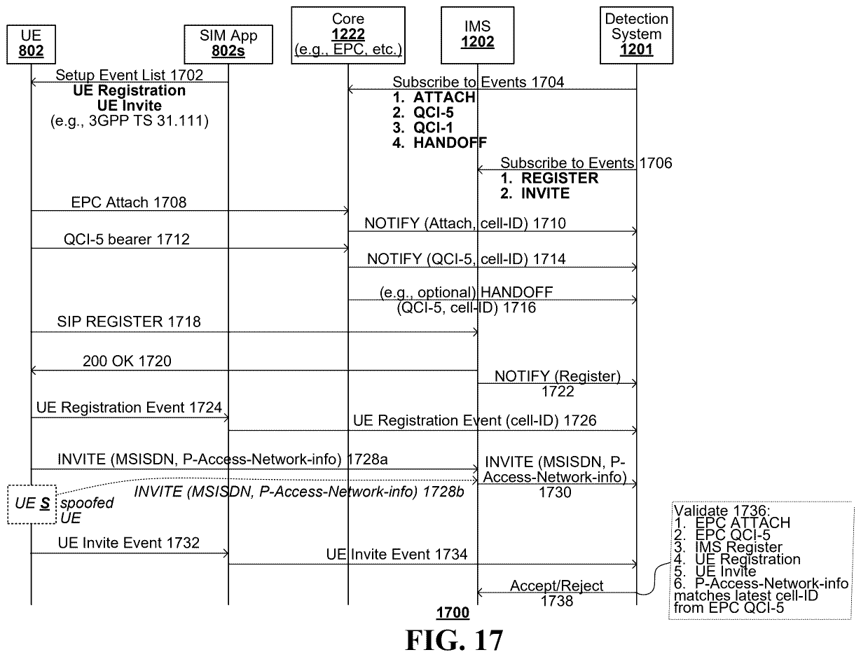

FIG. 17 shows an example call flow 1700 for network and SIM app assisted caller-ID spoofing detection.

The general process in the call flow 1700 may be similar to that of the call flows 1400, 1500, and 1600 in that the detection system 1201 may receive event notifications from various systems, and utilize that information to evaluate whether to accept/reject an inbound call to a user's AI. For the sake of brevity, therefore, the steps in the call flow 1700 are described concisely, with the understanding that they follow the same or similar principles/logic as those outlined for the call flows 1400, 1500, and 1600.

At 1702, the SIM app 802s may configure or set up an event list that enables the SIM app 802s to be notified of certain events that are associated with the UE 802. These events may include, for instance, UE-related attachment events, UE-related handoff events, UE-related registration events, UE-related call initiation/termination (e.g., invite) events, UE-related RAT change events, UE-related cell selection events, and/or the like.

At 1704, the detection system 1201 may subscribe to events that are associated with the core network 1222. These events may include, for instance, UE-related attachment events, UE-related QCI bearer creation/termination events, UE-related handoff events, and/or the like.

At 1706, the detection system 1201 may subscribe to events that are associated with the IMS 1202. These events may include, for instance, UE-related registration events, UE-related inbound call initiation/termination events, and/or the like. In certain embodiments, the events may additionally, or alternatively, include registration events, such as those defined in Section 7.5.21 of the above-mentioned 3GPP TS 31.111.

At 1708, the UE 802 may attach to the core network 1222. At 1710, the core network 1222 may, responsive to the attachment, send a notification of the attachment to the detection system 1201. At 1712, the UE 802 may create a QCI-5 bearer. At 1714, the core network 1222 may, responsive to the creation, send a notification of the creation to the detection system 1201. In a case where the core network 1222 effects a handover for the UE 802, the core network may, at 1716, send a notification of the handoff to the detection system 1201. At 1718, the UE 802 may send a registration message to the IMS 1202. At 1720, the IMS 1202 may, responsive to the registration message, reply to the UE 802 with an acknowledgement. Additionally, at 1722, the IMS 1202 may, responsive to the registration message, send a registration notification to the detection system 1201. At 1724, the UE 802 may send a notification of the UE registration event to the SIM app 802s. This notification may be sent after the sending of the registration message 1718. At 1726, the SIM app 802s may, in turn, send a notification of the UE registration event to the detection system 1201. By virtue of one or more of the notifications 1710, 1714, 1716, 1722, and 1726, the detection system 1201 will have obtained at least some network-related information for the UE 802, which the detection system 1201 can utilize to validate inbound calls to the user's AI.

At 1728a, the UE 802 may make such an inbound call, in which case, the IMS 1202 may send a notification 1730 of the inbound call to the detection system 1201. The inbound call message may include network-related information, such as information regarding one or more of the events 1708, 1712, 1718, etc. Additionally, at 1732, the UE 802 may, responsive to the initiation of the call, send a call initiation notification to the SIM app 802s. At 1734, the SIM app 802s may, in turn, send a notification of the call initiation to the detection system 1201. As such, the detection system 1201 will have obtained additional information for the UE 802. Here the detection system 1201 may compare (1736) some or all of the pieces of network-related information in the inbound call message with corresponding pieces of information obtained via the notifications 1710, 1714, 1716, 1722, 1726, and/or 1734, and may determine to accept the inbound call if there is a sufficient number of matches (e.g., one set of information has a match, two sets of information have matches, etc.). Accordingly, the detection system 1201 may, at 1738, command the IMS 1202 to accept the inbound call.

In a different scenario, the spoofed UE S may instead make an inbound call to the user's AI (1728b). Here, the inbound call message will likely include network-related information that is different from the information in the notifications 1710, 1714, 1716, 1722, and/or 1726. In fact, given that the UE S is a spoofed UE, no corresponding call initiation would have occurred at the UE 802, and hence, the UE 802 would not send a UE invite event notification to the SIM app 802s, and the SIM app 802s would not forward such a UE invite event notification to the detection system 1201. As a result, the detection system 1201 may, based on the lack of a corresponding UE invite event notification from the SIM app 802s, determine that the inbound call is to be rejected. Additionally, or alternatively, the detection system 1201 may not find sufficient information matches in relation to the notifications 1710, 1714, 1716, 1722, and/or 1726. In any case, the detection system 1201 may determine that the validation results warrant rejection of the inbound call, and may, at 1738, command the IMS 1202 to reject the inbound call.

While aspects of the various call flows shown in FIGS. 14 to 17 are described in relation to particular network technologies, such as that associated with an EPC or an IMS, it will be understood and appreciated that this is merely for the sake of brevity and that similar steps may be performed in implementations that utilize other network technologies. In various embodiments, another example of data that may be utilized in the authentication implementation 1300 is UE model. For instance, if the UE is a specific model (e.g., a particular brand and model of smartphone), the SIP INVITE message might include a header, such as “user-agent,” indicating that the SIP user agent generating the INVITE corresponds to the version used by that particular UE model. The detection system 1201 can ascertain the UE model from the International Mobile Equipment Identity (IMEI) number, which may be retrieved by the SIM app or obtained from existing network functions, such as the MME or the like. During the attach procedure described in step 1406, for instance, the UE 802 may provide its IMEI, which enables the network as well as the detection system 1201 to identify the UE model. As part of validating the INVITE (e.g., 1426), the detection system 1201 may determine whether the SIP user-agent that generated the INVITE has a version that matches the SIP user agent used by the UE 802, where a mismatch might suggest potential malicious activity. It is to be appreciated that use of the UE model in this way for validation purposes may be applicable to any of the call flows 1400, 1500, 1600, and 1700.

It will be understood and appreciated that the various event notifications described with respect to the call flows shown in FIGS. 14 to 17 may be obtained by the detection system 1201 on a push basis (e.g., responsive to detections of corresponding events) or alternatively on a pull basis—i.e., upon request from the detection system 1201.

Although each of the call flows shown in FIGS. 14 to 17 is described as involving a call rejection if the detection system 1201 determines that there are discrepancies in network/device element collected data relative to the data provided by a caller UE in a call invite, in certain embodiments, the detection system 1201 may alternatively choose to fallback to one or more active authentication methods rather than immediately rejecting the call. This approach provides multiple levels and types of authentication, allowing for fallback to traditional methods if one or more checks fail.

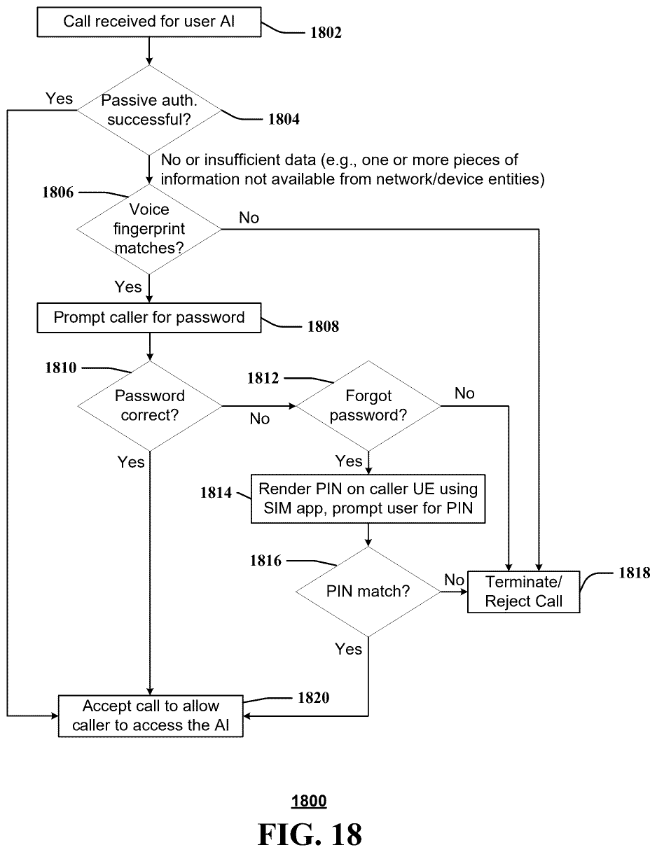

FIG. 18 shows an example flow 1800 that illustrates a fallback to active authentication methods in a case where passive authentication fails or is insufficient. In various embodiments, the detection system 1201 may perform the steps in the flow 1800 in coordination with one or more other systems.

The process may begin at step 1802, where a call is received for the user's AI. At step 1804, the detection system 1201 may determine whether passive authentication is successful—e.g., by engaging in one or more of the call flows described above with respect to FIGS. 14 to 17. If passive authentication is successful (YES), the process may proceed to step 1820, where the call is accepted, allowing the caller to access the AI.

If passive authentication is not successful or if there is insufficient data (e.g., one or more pieces of information are not available from network or device entities) (NO), the process may proceed to step 1806 to determine if a voice fingerprint matches. For instance, the caller may speak and the detection system 1201 may capture the speech and provide it to a voice authentication system/database for verification. If the voice fingerprint matches (YES), the process may continue to step 1808, where the caller is prompted for a password. If the voice fingerprint does not match (NO), the process may proceed to step 1818, where the call is terminated or rejected.

At step 1810, the detection system 1201 may verify if the password provided by the caller is correct. For instance, the detection system 1201 may provide the inputted password to a password authentication system/database for verification. If the password is correct (YES), the process may proceed to step 1820, where the call is accepted, allowing the caller to access the AI. If the password is incorrect (NO), the process may proceed to step 1812 to determine if the caller has forgotten the password.

If the caller indicates that they have not forgotten the password (NO), the process may proceed to step 1818, where the call is terminated or rejected. If the caller indicates that they have forgotten the password (YES), the process may proceed to step 1814, where the detection system 1201 may trigger a Personal Identification Number (PIN) input interface to be rendered on the caller's UE using a SIM application, and the caller may be prompted to enter a PIN.

At step 1816, the detection system 1201 may verify if the PIN entered by the caller matches the rendered PIN. This may involve coordination with a PIN authentication system/database. If the PIN matches (YES), the process may proceed to step 1820, where the call is accepted, allowing the caller to access the AI. If the PIN does not match (NO), the process may proceed to step 1818, where the call is terminated or rejected.

In this way, the system may employ both passive and active authentication methods to ensure secure access to the user AI. It is to be understood and appreciated that, while various types of active authentication steps are shown in the call flow 1800, and in a particular order, not all of them may be needed to authenticate the call. For instance, a voice fingerprint match alone may be sufficient to authenticate the caller. As another example, a password or PIN match, without performing voice fingerprinting, may be sufficient to authenticate the call.

In certain embodiments, in addition to or as an alternative to facilitating the passive and/or active authentications described above for validating a call that is made to a user's AI, the detection system 1201 may facilitate a different type of (e.g., active authentication) that leverages AI—i.e., AI-based screening.

In exemplary embodiments, the detection system 1201 may be configured to perform trigger-based AI screening (e.g., for voice and/or messaging). Traditionally, determining call spoofing relied on signaling data to make inferences. A significant advantage of using AI prescreening techniques described herein is that AI can utilize network-provided information to modify how a user-to-AI call is screened.

In one or more embodiments, the detection system 1201 may actively screen calls as part of another function of the AI agent service (e.g., the ASR/LLM/TTS configuration described above with respect to the AI personal assistant may be utilized here). The screening agent here may, for instance, ask specific questions to the caller based on observed signaling conditions or network states (e.g., 1322, 1324 of FIG. 13).

In some embodiments, AI screening conditions may be provided or inserted via a control plane of the network. For example, the control plane may include components such as the IMS core 1202 or other network entities that manage signaling and data flow. By leveraging the control plane, the detection system 1201 can ensure that the AI screening process is informed by real-time (or near real-time) network data, which enhances the accuracy and effectiveness of call screening and thus improves user-to-AI access security. In certain embodiments, the detection system 1201 may leverage, or cause to be performed, some or all of the AI screening steps described above with respect to FIG. 12C.

In exemplary embodiments, the detection system 1201 may be configured to facilitate AI-based screening by leveraging network-derived indicators. For instance, in a case where the detection system 1201 determines that a call does not comply with STIR/SHAKEN standards, the detection system 1201 may prompt the AI system(s) to initiate AI-based screening. This screening may involve generating specific questions to verify the caller's identity. In another scenario, if the detection system 1201 identifies that the caller does not provide cell site information, the AI system(s) may be prompted to request additional location details from the caller. Or, in a case where the detection system 1201 determines that the caller is not located at an expected location (e.g., a known recent location of the user device that is associated with the called AI) or is not registered on the network, the AI system(s) may be similarly engaged to authenticate the caller.

The detection system 1201 may utilize various network-derived indicators, such as call graphs, imported contacts, user feedback, UE data, SIM swap information, connection status, and/or the like to construct a comprehensive questionnaire that is aimed at detecting potential spoofing. Additionally, the detection system 1201 may leverage external data services, such as public records or third-party databases, to generate question-and-answer pairs for enhanced authentication. “Out-of-wallet” questions, such as ‘Which of the following cars did you own?’ or ‘What is the approximate amount of your last mortgage payment?’, can be used to verify the caller's identity as these are questions that are difficult for a fraudster to answer but relatively easy for the legitimate user.

The network-derived indicators may encompass a wide range of data points. For example, location information may include the last known location, historical location, and/or recent travel patterns, where the AI system(s) may generate questions such as “I see you are in a location that is unusual based on your past history. Are you traveling for work or vacation?” or “Can you tell me the top two most frequent locations you've visited in the last 48 hours?” As another example, device information may cover the type of device, activation date, and/or network status, prompting inquiries such as “I see you're using a different device today. Did you recently purchase this device?” or “What model device is this?” As yet another example, call graph data may reveal the last call made or frequently dialed numbers, leading to questions such as “Tell me the last number you dialed from this device” or “Which of the following numbers do you frequently call.” As a further example, billing data may include billing dates and account details, where questions such as “How long have you been a customer with us?” or “What was the approximate amount of your last bill?” may be asked. As another example, care data may involve the last care date and care details, resulting in questions such as “I see you made a call to customer care on March 3rd. Can you tell me what that call was about?” As some other examples, the network-derived indicators may include social media activity, usage data, and/or messaging patterns, such as SMS/RCS. These indicators may facilitate the AI system(s) in generating questions such as, “Have you recently posted on any social media platforms?” or “How often do you use messaging services like SMS or RCS?”

Of course, the AI agent service may evaluate the caller-provided responses by generating corresponding answers based on UE/network-related information. The evaluation may be facilitated using techniques such as vector embeddings or processing through an LLM to perform similarity checks and ensure alignment between the generated answers and the caller's responses.

In this way, the detection system 1201 may facilitate trigger-based AI screening of user-to-AI calls, which enhances security by proactively identifying and mitigating potential spoofing attempts. By leveraging network-derived indicators and AI-driven inquiries, the detection system 1201 can accurately verify caller identities and detect anomalies that may indicate fraudulent activity. This approach not only safeguards sensitive user data, but also ensures that interactions with AI services are conducted in a secure and trustworthy manner, thereby fostering user confidence and trust in the telecommunications network.

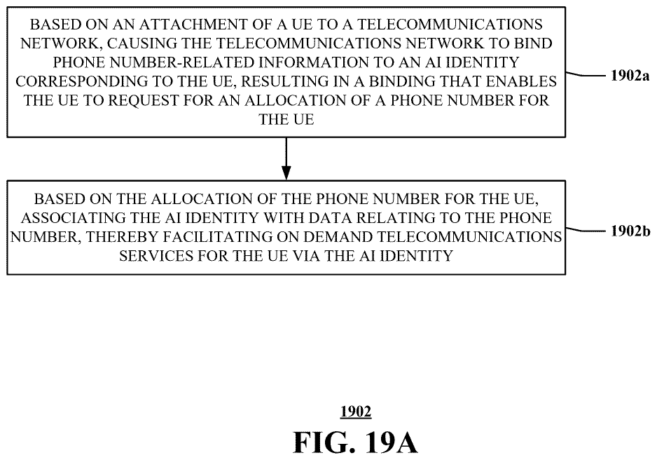

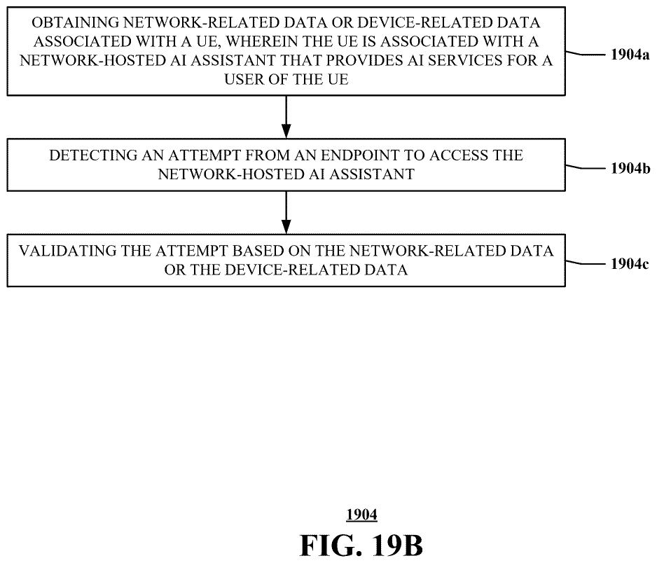

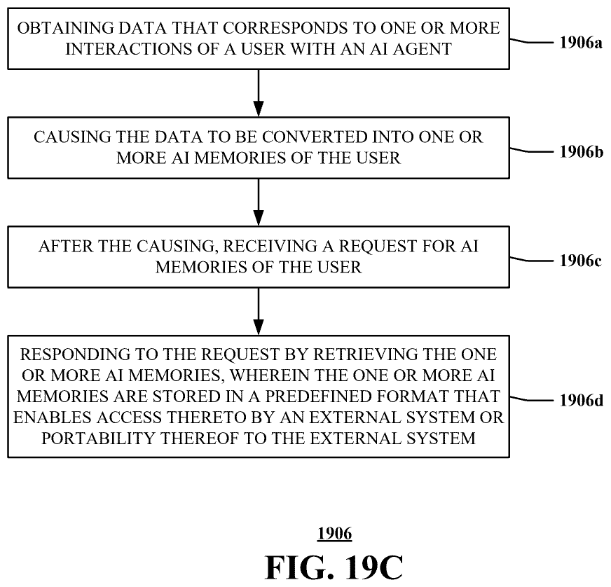

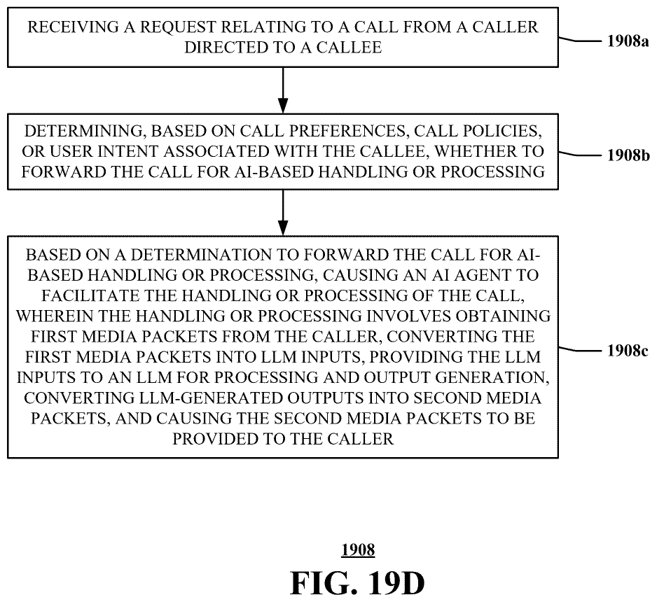

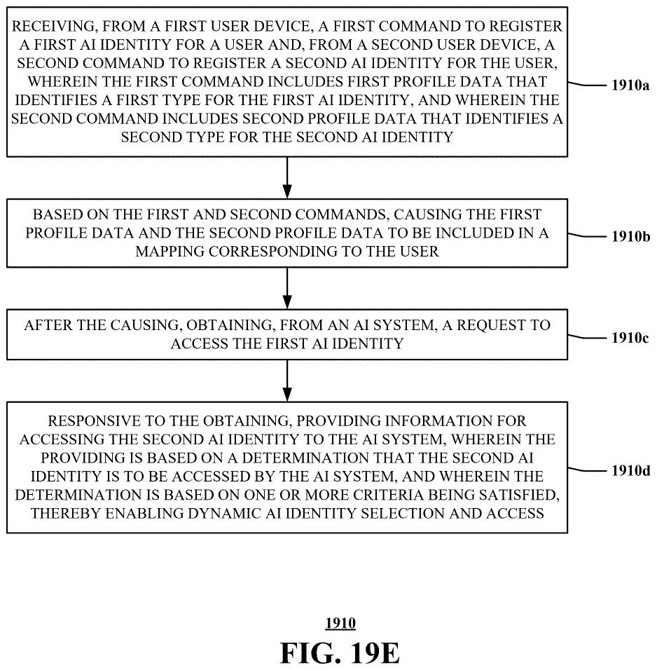

FIG. 19A depicts an illustrative embodiment of a method 1902 in accordance with various aspects described herein.

At 1902a, the method can include based on an attachment of a UE to a telecommunications network, causing the telecommunications network to bind phone number related information to an AI identity corresponding to the UE, resulting in a binding that enables the UE to request for an allocation of a phone number for the UE. For example, the AI RF 810 can, similar to that described elsewhere herein, perform one or more operations that include based on an attachment of a UE to a telecommunications network, causing the telecommunications network to bind phone number related information to an AI identity corresponding to the UE, resulting in a binding that enables the UE to request for an allocation of a phone number for the UE.

At 1902b, the method can include based on the allocation of the phone number for the UE, associating the AI identity with data relating to the phone number, thereby facilitating on demand telecommunications services for the UE via the AI identity. For example, the AI RF 810 can, similar to that described elsewhere herein, perform one or more operations that include based on the allocation of the phone number for the UE, associating the AI identity with data relating to the phone number, thereby facilitating on demand telecommunications services for the UE via the AI identity.

FIG. 19B depicts an illustrative embodiment of a method 1904 in accordance with various aspects described herein.

At 1904a, the method can include obtaining network-related data or device-related data associated with a UE, wherein the UE is associated with a network-hosted AI assistant that provides AI services for a user of the UE. For example, the detection system 1201 can, similar to that described elsewhere herein, perform one or more operations that include obtaining network-related data or device-related data associated with a UE, wherein the UE is associated with a network-hosted AI assistant that provides AI services for a user of the UE.

At 1904b, the method can include detecting an attempt from an endpoint to access the network-hosted AI assistant. For example, the detection system 1201 can, similar to that described elsewhere herein, perform one or more operations that include detecting an attempt from an endpoint to access the network-hosted AI assistant.

At 1904c, the method can include validating the attempt based on the network-related data or the device-related data. For example, the detection system 1201 can, similar to that described elsewhere herein, perform one or more operations that include validating the attempt based on the network-related data or the device-related data.

FIG. 19C depicts an illustrative embodiment of a method 1906 in accordance with various aspects described herein.

At 1906a, the method can include obtaining data that corresponds to one or more interactions of a user with an AI agent. For example, the memory AI 814 can, similar to that described elsewhere herein, perform one or more operations that include obtaining data that corresponds to one or more interactions of a user with an AI agent.

At 1906b, the method can include causing the data to be converted into one or more AI memories of the user. For example, the memory AI 814 can, similar to that described elsewhere herein, perform one or more operations that include causing the data to be converted into one or more AI memories of the user.

At 1906c, the method can include after the causing, receiving a request for AI memories of the user. For example, the memory AI 814 can, similar to that described elsewhere herein, perform one or more operations that include after the causing, receiving a request for AI memories of the user.

At 1906d, the method can include responding to the request by retrieving the one or more AI memories, wherein the one or more AI memories are stored in a predefined format that enables access thereto by an external system or portability thereof to the external system. For example, the memory AI 814 can, similar to that described elsewhere herein, perform one or more operations that include responding to the request by retrieving the one or more AI memories, wherein the one or more AI memories are stored in a predefined format that enables access thereto by an external system or portability thereof to the external system.

FIG. 19D depicts an illustrative embodiment of a method 1908 in accordance with various aspects described herein.

At 1908a, the method can include receiving a request relating to a call from a caller directed to a callee. For example, the decision engine 1210 can, similar to that described elsewhere herein, perform one or more operations that include receiving a request relating to a call from a caller directed to a callee.

At 1908b, the method can include determining, based on call preferences, call policies, or user intent associated with the callee, whether to forward the call for AI-based handling or processing. For example, the decision engine 1210 can, similar to that described elsewhere herein, perform one or more operations that include determining, based on call preferences, call policies, or user intent associated with the callee, whether to forward the call for AI-based handling or processing.

At 1908c, the method can include based on a determination to forward the call for AI-based handling or processing, causing an AI agent to facilitate the handling or processing of the call, wherein the handling or processing involves obtaining first media packets from the caller, converting the first media packets into LLM inputs, providing the LLM inputs to an LLM for processing and output generation, converting LLM-generated outputs into second media packets, and causing the second media packets to be provided to the caller. For example, the decision engine 1210 can, similar to that described elsewhere herein, perform one or more operations that include based on a determination to forward the call for AI-based handling or processing, causing an AI agent to facilitate the handling or processing of the call, wherein the handling or processing involves obtaining first media packets from the caller, converting the first media packets into LLM inputs, providing the LLM inputs to an LLM for processing and output generation, converting LLM-generated outputs into second media packets, and causing the second media packets to be provided to the caller.

FIG. 19E depicts an illustrative embodiment of a method 1910 in accordance with various aspects described herein.

At 1910a, the method can include receiving, from a first user device, a first command to register a first AI identity for a user and, from a second user device, a second command to register a second AI identity for the user, wherein the first command includes first profile data that identifies a first type for the first AI identity, and wherein the second command includes second profile data that identifies a second type for the second AI identity. For example, the AI RF 810 can, similar to that described elsewhere herein, perform one or more operations that include receiving, from a first user device, a first command to register a first AI identity for a user and, from a second user device, a second command to register a second AI identity for the user, wherein the first command includes first profile data that identifies a first type for the first AI identity, and wherein the second command includes second profile data that identifies a second type for the second AI identity. In various embodiments, the first AI identity or the second AI identity may be associated with multiple AI personas that are selectable by the AI identity to use when providing AI services.

At 1910b, the method can include based on the first and second commands, causing the first profile data and the second profile data to be included in a mapping corresponding to the user. For example, the AI RF 810 can, similar to that described elsewhere herein, perform one or more operations that include based on the first and second commands, causing the first profile data and the second profile data to be included in a mapping corresponding to the user.

At 1910c, the method can include after the causing, obtaining, from an AI system, a request to access the first AI identity. For example, the AI RF 810 can, similar to that described elsewhere herein, perform one or more operations that include after the causing, obtaining, from an AI system, a request to access the first AI identity.

At 1910d, the method can include responsive to the obtaining, providing information for accessing the second AI identity to the AI system, wherein the providing is based on a determination that the second AI identity is to be accessed by the AI system, and wherein the determination is based on one or more criteria being satisfied, thereby enabling dynamic AI identity selection and access. For example, the AI RF 810 can, similar to that described elsewhere herein, perform one or more operations that include responsive to the obtaining, providing information for accessing the second AI identity to the AI system, wherein the providing is based on a determination that the second AI identity is to be accessed by the AI system, and wherein the determination is based on one or more criteria being satisfied, thereby enabling dynamic AI identity selection and access.

It is to be understood and appreciated that, although one or more of the drawing figures might be described above as pertaining to various processes and/or actions that are performed in a particular order, some of these processes and/or actions may occur in different orders and/or concurrently with other processes and/or actions from what is depicted and described above. Moreover, not all of these processes and/or actions may be required to implement the systems and/or methods described herein. Furthermore, while various components, devices, systems, modules, networks, etc. may have been illustrated in one or more of the drawing figures as separate components, devices, systems, modules, networks, etc., it will be appreciated that multiple components, devices, systems, modules, networks, etc. can be implemented as a single component, device, system, module, network, etc., or a single component, device, system, module, network, etc. can be implemented as multiple components, devices, systems, modules, networks, etc. Additionally, functions described as being performed by one component, device, system, module, network, etc. may be performed by multiple components, devices, systems, modules, networks, etc., or functions described as being performed by multiple components, devices, systems, modules, networks, etc. may be performed by a single component, device, system, module, network, etc.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x) =confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized. It is also to be understood and appreciated that the subject matter in one or more dependent claims may be combined with that in one or more other dependent claims.

What is claimed is:

1. A device, comprising:
a processing system including a processor; and
a memory that stores executable instructions that, when executed by the processing system, facilitate performance of operations, the operations comprising:
obtaining data that corresponds to one or more interactions of a user with an artificial intelligence (AI) agent;
causing the data to be converted into one or more AI memories of the user;
after the causing, receiving a request for AI memories of the user; and
responding to the request by retrieving the one or more AI memories, wherein the one or more AI memories are stored in a predefined format that enables access thereto by an external system or portability thereof to the external system.

2. The device of claim 1, wherein the one or more AI memories comprise one or more contextual memories, and wherein the predefined format includes a context category, a sensitivity setting, an expiration date, or a combination thereof.

3. The device of claim 1, wherein the one or more AI memories comprise one or more intent-outcome memories, and wherein the predefined format identifies an intent relating to a user communication and a desired outcome relating to the user communication.

4. The device of claim 1, wherein the external system comprises the AI agent or another AI system.

5. The device of claim 1, wherein the AI memories are associated with a memory AI identity.

6. The device of claim 5, wherein the operations further comprise registering the memory AI identity with an AI repository function that manages authorization data generation for accessing the AI memories.

7. The device of claim 6, wherein the request originates from the external system and includes authorization data that has been generated by the AI repository function based on an authentication of the external system by the AI repository function.

8. The device of claim 7, wherein the operations further comprise verifying the authorization data prior to the responding to the request.

9. The device of claim 1, wherein the request comprises a request to access or interpret the AI memories of the user.

10. The device of claim 1, wherein the request comprises a request to port the AI memories of the user to the external system for hosting by the external system.

11. The device of claim 1, wherein the one or more AI memories are associated with at least one AI identity that corresponds to at least one user equipment (UE) of the user.

12. The device of claim 1, wherein the user is associated with a network-hosted AI assistant, and wherein the operations further comprise:
obtaining network-related data or device-related data associated with a UE of the user;
detecting an attempt from an endpoint to access the network-hosted AI assistant; and
causing the attempt to be validated based on the network-related data or the device-related data.

13. The device of claim 12, wherein the user is associated with a network-hosted AI assistant for providing AI-based services for the user.

14. The device of claim 1, wherein the user is associated with a plurality of AI identities that are dynamically selectable for external system access based on one or more criteria.

15. A non-transitory machine-readable medium, comprising executable instructions that, when executed by a processing system including a processor, facilitate performance of operations, the operations comprising:
causing a memory artificial intelligence (AI) identity for a user to be registered with an AI repository function, resulting in a registration, wherein the memory AI identity corresponds to a memory AI system that stores or facilitates storage of AI memories of the user;
after the registration, obtaining, from an AI agent, a request to access the memory AI identity for purposes of storing data that corresponds to one or more AI-related actions associated with the user; and
based on the request, causing information for accessing the memory AI identity to be provided to the AI agent, thereby enabling the AI agent to provide the data for storage in the memory AI system as one or more AI memories of the user.

16. The non-transitory machine-readable medium of claim 15, wherein the one or more AI memories are stored in a predefined syntax.

17. The non-transitory machine-readable medium of claim 16, wherein the one or more AI memories comprise one or more contextual memories, and wherein the predefined syntax includes a context category, a sensitivity setting, an expiration date, or a combination thereof.

18. The non-transitory machine-readable medium of claim 16, wherein the one or more AI memories comprise one or more intent-outcome memories, and wherein the predefined syntax identifies an intent relating to a user communication and a desired outcome relating to the user communication.

19. The non-transitory machine-readable medium of claim 15, wherein the information for accessing the memory AI identity comprises an access token.

20. A method, comprising:
causing, by a processing system including a processor, a memory artificial intelligence (AI) identity for a user to be registered with an AI repository function, resulting in a registration, wherein the memory AI identity corresponds to a memory AI system that stores or facilitates storage of AI memories of the user;
after the registration, obtaining, by the processing system and from an AI agent, a request to access the memory AI identity for purposes of retrieving one or more of the AI memories of the user; and
based on the request, causing information for accessing the memory AI identity to be provided to the AI agent, thereby enabling the AI agent to request retrieval of the one or more of the AI memories of the user.
